(19) United States
(12) Patent Application Publication
(10) Pub. No.: US 2005/0118310 A1
(43) Pub. Date: Jun. 2, 2005

(54) Formulations of compounds derived from natural sources and their use with irradiation for food preservation

(76) Inventor: Monique Lacroix, Quebec (CA)

Correspondence Address: STERNE, KESSLER, GOLDSTEIN & FOX PLLC, 1100 NEW YORK AVENUE, N.W., WASHINGTON, DC, 20005, US

(21) Appl. No.: 10/485,400

(22) PCT Filed: Jul. 31, 2002
(86) PCT No.: PCT/CA02/01194

(30) Foreign Application Priority Data
Jul. 31, 2001 (CA) 2,354,398
Nov. 5, 2001 (CA) 2,361,200

(51) Int. Cl. A23L 3/00

(52) U.S. Cl. 426/240

(57) ABSTRACT

The present invention provides formulations comprising one or more compounds derived from natural sources that act to reduce the dose of irradiation required to inhibit the growth of micro-organisms in food. The present invention further provides for the use of the formulations in conjunction with low doses of irradiation to increase the safety and prolong the shelf life of food without adversely affecting its organoleptic qualities. The present invention also provides methods of applying the formulations to food products.

### FIELD OF THE INVENTION

The present invention pertains to the field of food safety and preservation, in particular to the use of compounds derived from natural sources and irradiation to extend the shelf life of foods.

### BACKGROUND

The ability of ionising energy to preserve foods by eliminating microbial contamination is well known and documented in the literature. The use of this technology is becoming standard in the food industry due to the increasing number of incidents of food-borne sickness and death caused by food-bone pathogens. Irradiation of meats, for example, is the only current commercially viable technology that can destroy all harmful bacteria on or in a raw product [Thayer, D. W., J. Food Protection, 56: 831-833 (1993)].

During irradiation treatment, energy is transferred into the food product resulting in the formation of high-energy oxidants and reductants. The most important of these in foods that have relatively high water content (such as meats) are the hydroxyl radical and the hydrogen atom, which result from the dissociation of water. Other active species formed in the radiolysis of water include hydrated electrons, hydrogen peroxide, and hydronium ions. These active species are responsible for the anti-microbial action of irradiation, but can also cause adverse chemical effects in the irradiated foods, including organoleptic changes (such as the generation of off-flavours and/or aromas) and a decrease in oxidative stability of the food on subsequent storage.

Several methods for reducing objectionable off-odours and flavours associated with irradiated foods have been developed. For example, at an early stage in the development of irradiation as a food preservation technique, freezing and irradiating meat at very low temperatures were determined to reduce radiation-induced off-flavour and odours. Similarly, irradiation in the absence of oxygen, under vacuum or in the presence of an inert atmosphere is known to help decrease undesirable organoleptic changes [Huber, et al., Food Tech. pp. 109-115 1954)]. Addition of a protective substance such as ascorbic acid or its derivatives, which act as free radical acceptors, to decrease the development of radiation-induced off-flavour is also known [U.S. Pat. No. 2,832,689; Hannan, Food Sci. Abs. pp. 121-125 (1954)].

Other compounds reported in the literature as exhibiting flavour protection qualities in irradiated food include certain herbs and spices such as pepper, mace, allspice, turmeric, celery, dill, caraway, thyme, onion and sage or extracts derived therefrom [Huber, et al., Food Tech. pp. 109-115 (1954)]. The anti-oxidant effects of herbs, spices and their extracts are well known [for example, see “Spices: Flavor Chemistry and Antioxidait Properties,” S. J. Risch and C -T. Ho, eds., ACS Symposium Series 660, American Chemical Society, Washington, D.C. (1996)] and are generally believed to be responsible for their ability to preserve the flavours in irradiated foods. Mixing ground thyme or ground rosemary with selected commercially available fatty acids (arachidonic, linoleic, myristic, and stearic acids), for example, followed by exposure to gamma-irradiation (3 kGy and 9 kGy doses) significantly reduced the amount of lipidolysis that normally results from the irradiation process [Lacroix, M. et al., Food Res. Int. 30:457-462 (1997)].

There is an increasing demand for natural food additives, for example, from plants and plant extracts to improve the quality of food products. Essential oils isolated from herbs, spices and other plants, in particular from thyme and rosemary, have been found to have antimicrobial activity in addition to their anti-oxidant properties. For example, essential oils have been used effectively against many food-bome bacteria including Escherichia coli [Eloff, J. N., J. Ethnopharmacol., 67:355-360 (1999)], Salmonella typhimurium and Staphylococcus aureus [Juven, et al., J. Appl. Bacteriol., 76:626-631 (1994)], Listeria monocytogenes [Aureli, et al., J. Food Prot., 55:344-348 (1992)] and Vibrio spp. [Koga et al., Microbiol. Res., 154:267-273 (1999)]. Unfortunately, the concentration of essential oils needed to prevent bacterial growth is generally found to be much higher than the concentrations currently being used in the industry (ICMSF, 1980). Furthermore, essential oils tend to lose their inhibitory activity after a certain period of incubation [Ouattara et al., Int. J. Food Microbiol., 37:155-162 (1997)], which can limit their application in the food industry.

Some of the active constituents responsible for the anti-microbial activity of essential oils and plant extracts have also been identified, for example thymol [Aktug & Karapinar, Int. J. Food Microbiol., 4:161-166 (1989); Beuchal & Golden, Food Technol., 1:134-142 (1989); Juven, et al., J. Appl. Bacteriol., 76:626-631 (1994)], eugenol, menthol, anethole [Aktug & Karapinar, ibid], carnasol, ursolic acid, rosmanol [Collins & Charles, Food Miciobiol., 4:311-315 (1987)] and proanthocyanidins [Canadian Patent Application No. 2,302,743].

Both the anti-oxidative and anti-microbial properties of essential oils and plant extracts have been investigated with respect to irradiation of foods, particularly meat and meat products. For example, U.S. Pat. No 6,099,879 describes a method for treating meat and meat products with a rosemary extract prior to irradiation. The patent describes the use of rosemary extracts to prevent or reduce lipid peroxidation and oxidation in the meat products. The breakdown of lipids is responsible for the development of the “wet dog, burnt or metallic” off-flavours in meat products which often result fiom the use of gamma-irradiation. U.S. Pat. No 6,099,879 also describes the use of the active anti-oxidant ingredients of rosemary, i.e. carnosic acid, carnosol, and rosmarinic acid, as a replacement for rosemary extract, as well as the use of these ingredients or a rosemary extract together with other anti-oxidant compounds (such as tocopherols, ascorbic acid, citric acid or sodium tripolyphosphate, niacin, mannitol, sodium benzoate, chloride ion, sodium fumarate, monosodium glutamate, ascorbic acid, pepper, mace, turmeric, celery, dill, caraway, thyme, onion, and sage or extracts). Although the rosemary extract and the active anti-oxidant ingredients thereof are described as decreasing,the amount of off-flavour and aroma associated with irradiated meats, the irradiation method described by this patent, however, still relies on doses of irradiation of between 3 and 7 kGy.

Mahrour et al. describe the use of thyme and rosemary with lower doses of irradiation (as low as 3 kGy) and the ability of these compounds to decrease fatty acid oxidation and the survival of Salmonella bacteria in irradiated chicken [Mahrour et al., Radiat. Phys. Chem., 52:77-80 (1998); Mahrour et al., Radiat. Phys. Chem., 52:81-84 (1998)]. Chicken legs were marinated in a mixture of lemon juice, thyme and rosemary prior to irradiation at a dose of either 3 kGy or 5 kGy. In comparison to non-marinated controls, a significant decrease in the amount of fatty acid oxidation and the number of Salmonella surviving treatment was observed in the marinated chicken.

International Patent Application No. WO01/37683 describes the use of protein and polysaccharide-based food covering materials as a method of food preservation. This patent application also describes the use of these food coverings in conjunction with irradiation (3 kGy). The food covering materials are described as optionally including additives, such as flavourings and anti-bacterial agents (for example, thyme oil and trans-cinnamaldehyde). The use of the food coverings both with and without added anti-bacterial agents in combination with irradiation resulted in a decrease in the number of bacteria surviving treatment when compared to the effects of irradiation alone.

Radiation-induced effects on the quality of food (i.e. undesirable changes to the organoleptic qualities) are a major drawback inherent in the use of irradiation as a food preservation technique. Many of these detrimental effects could be eliminated if lower doses of radiation could be used, however, the use of lower doses may compromise the safety of the food. For example, it has been postulated that irradiation doses higher than 2.5 kGy may be required to eliminate Salmonella spp. from chicken [Katta et al., J. Food Sci, 56:371-372 (1991)]. This level of irradiation has been shown to result in off-flavours and odours in poultry [Hanis et al., J. Food Protection, 52:26-29 (1989)]. A need remains, therefore, for improved methods of food preservation that provide safe food, but which also allow the desirable organoleptic qualities of the food product to be maintained.

### SUMMARY OF THE INVENTION

An object of the present invention is to provide formulations of compounds derived from natural sources and their use with irradiation for food preservation. In accordance with an aspect of the present invention, there is provided a formulation comprising one or more compounds derived from natural sources and substantially purified, wherein application of said formulation to a food product and irradiation of said food product at less than 3 kGy inhibits the growth of a population of micro-organisms in said food product by at least one log order.

In accordance with another aspect of the present invention, there is provided a use of a formulation comprising one or more compounds in combination with a radiation dose of less than 3 kGy to inhibit the growth of a population of micro-organisms in a food product, wherein said compounds are derived from natural sources and are substantially purified.

In accordance with another aspect of the present invention, there is provided a method of food preservation comprising the steps of: (a) contacting a food product with a formulation comprising one or more compounds, wherein said compounds are derived from natural sources and are substantially purified, and (b) exposing said food product to a radiation dose of less than 3 kGy.

In accordance with still another aspect of the present invention, there is provided a method of decreasing the radiation dose required to inhibit the growth of a population of micro-organisms in a food product by at least one log order comprising contacting said food product with a formulation comprising one or more compounds prior to irradiation, wherein said compounds are derived from natural sources and are substantially purified.

In accordance with still another aspect of the present invention, there is provided a method of increasing the shelf life of a food product comprising the steps of: (a) contacting the food product with a formulation comprising one or more compounds, wherein said compounds are derived from natural sources and are substantially purified, and (b) exposing said food product to a radiation dose of less than 3 kGy.

### BRIEF DESCRIPTION OF THE FIGURES

FIG. 1 demonstrates the effect of concentration of active compounds on the bacterial population of E. coli in ground beef.

FIG. 2 demonstrates the effect of concentration of active compounds on the bacterial population of S. typhi in ground beef.

FIG. 3 demonstrates the effect of different types of commercial Herbalox® and Duralox® on E. coli in ground beef.

FIG. 4 demonstrates the effect of different types of commercial Herbalox® and Duralox® on S. typhi in ground beef.

FIG. 5 shows the irradiation sensitivity of E. coli in ground beef in the presence of various active compounds.

FIG. 6 shows the irradiation sensitivity of S. typhi in ground beef in the presence of various active compounds.

FIG. 7 shows the influence of various concentrations of carvacrol (0 to 1.4 %) on the survival level of E. coil in ground beef after irradiation at 0.25 kGy.

FIG. 8 shows the effect of various concentrations of carvacrol (0 to 2.0%) on the survival level of S. typhi in ground beef after irradiation at 0.5 kGy.

FIG. 9 shows the irradiation sensitivity of E. coli in ground beef treated with various combinations of active compounds.

FIG. 10 shows the irradiation sensitivity of S. typhi in ground beef treated with various combinations of active compounds.

FIG. 11 shows the irradiation sensitivity (D₁₀) of E. coli in ground beef under various packaging atmospheres (air, CO₂, modified atmosphere packaging [MAP] and vacuum).

FIG. 12 shows the irradiation sensitivity (D₁₀) of S. typhi in ground beef under various packaging atmospheres (air, CO₂, modified atmosphere packaging [MAP] and vacuum).

FIG. 13 shows the irradiation sensitivity (D₁₀) of E. coli in ground beef treated with a mixture of carvacrol and tetrasodium pyrophosphate, packed under air and stored under refrigerated (4° C.) or frozen (−80° C.) conditions.

FIG. 14 shows the irradiation sensitivity (D₁₀) of S. typhi in ground beef treated with a mixture of carvacrol and tetrasodium pyrophosphate, packed under air and stored under refrigerated (4° C.) or frozen (−80° C.) conditions.

FIG. 15 shows the irradiation sensitivity of E. coli in chicken breast treated with a mixture carvacrol (0.029%), tetrasodium pyrophosphate (0.003%), thymol (0.050%) and trans-cinnamaldehyde (0.050%).

FIG. 16 shows the irradiation sensitivity of S. typhi in chicken breast treated with a mixture of carvacrol (0.038%), tetrasodium pyrophosphate (0.003%), thymol (0.053%) and trans-cinnamaldehyde (0.030%).

FIG. 17 shows the irradiation sensitivity of E. coli in chicken breast treated with a mixture of trans-cinnamaldehyde (0.013%) and tetrasodium pyrophosphate (0.003%) under air or modified atmosphere packaging (MAP) conditions,

FIG. 18 shows the irradiation sensitivity of S. Typhi in chicken breast treated with a mixture of trans-cinnamaldehyde (0.013%) and tetrasodium pyrophosphate (0.003%) under air or modified atmosphere packaging (MAP) conditions.

FIG. 19 demonstrates the effect of trans-cinnamaldehyde (0.025% or 1.5%) on the irradiation sensitivity of E. coli in ground beef packed under air or modified atmosphere packaging (MAP) conditions.

FIG. 20 demonstrates the effect of trans-cinnamaldehyde (0.025% or 0.89%) on the irradiation sensitivity of S. typhi in ground beef packed under air or modified. atmosphere packaging (MAP) conditions.

FIG. 21 depicts the irradiation sensitivity of E. coli in ground beef in the presence of trans-cinnamaldehyde (0.25%), ascorbic acid (0.5%), carvacrol (0.125%), rosemary (0.5%), thymol (0.1%) or thyme (0.2%).

FIG. 22 depicts the irradiation sensitivity of S. typhi in ground beef in the presence of carvacrol (1.15%) and thymol (1.60%).

FIG. 23 depicts the irradiation sensitivity of the mixture of indigenous micro-organisms in the presence of thymol (1.5%) and trans-cinnamaldehyde (1.5%).

FIG. 24 shows E. coli survival in ground beef irradiated at 0.30 kGy, in the presence of trans-cinnamaldehyde (1.5%), thymol (1.15%), carnacrol (0.75%) or thyme (1.5% or 3.0%) and subsequently stored at 4° C.

FIG. 25 shows S. typhi survival in ground beef irradiated at 0.85 kGy, in the presence of carvacrol (1.15%) or thymol (1.60%) and subsequently stored at 4° C.

FIG. 26 demonstrates the shelf life of ground beef contaminated with a mixture of indigenous micro-organisms after irradiation at 1.75 kGy in the presence of thymol (1.5%) or trans-ciruainaldehyde (1.5%) and subsequently stored at 4° C.

### DETAILED DESCRIPTION OF THE INVENTION

The present invention provides formulations comprising one or more compounds derived from natural sources that enhance the anti-microbial effects of irradiation such that the safety, shelf life and/or organoleptic qualities of food products are substantially improved. The formulations also allow for the use of much lower doses of radiation than are typically used in food preservation techniques. Use of the formulations of the present invention in conjunction with low doses of radiation (less than 3 kGy) provides for food that is safe and which retains its desirable organoleptic qualities. Thus, the present invention also provides a method of food preservation that results in safe, high quality food, which is more economical than current methods due to the use of lower doses of radiation. The formulations of the present invention further allow for the use of low levels of radiation on food products where previously the use of irradiation would not have been appropriate. For example, with food products for which a reduction in micro-organism content to a safe level would require irradiation doses above acceptable standard levels (for example, greater than 2.5-3.0 kGy) or for food products in which the required dose causes unacceptable organoleptic changes.

Definitions

Unless defined otherwise, all technical and scientific terms used herein have the same meaning as commonly understood by one of ordinary skill in the art to which this invention pertains.

The term “irradiation” as used herein refers to the treatment of a food product with ionising radiation. Suitable types of ionising radiation for food irradiation include high-energy gamma rays, x-rays, and accelerated electrons. The process of irradiation involves exposing the food product to controlled amounts of lonising radiation. In accordance with the present invention, the dose of radiation employed is less than 3 kGy.

The term “food product” as used herein refers to a food that is susceptible to spoilage and/or contamination as a result of the growth and proliferation of one or more micro-organisms on or within the food. The term encompasses both animal-derived and plant-derived foodstuffs including, but not limited to, meat and meat products, milk and dairy products (such as semi-soft and hard cheeses and processed cheese), egg products (such as dried egg and egg replacers), fruits, vegetables and vegetable products (such as tofu and soybean-derived meat substitutes), and grains. Food products also include processed or prepared foods wherein one or more of meat, dairy, egg, fruit, vegetable and grain products are combined, for example, in pies, processed dishes and meals, finger foods and desserts.

The term “meat” as used herein refers to tissue or flesh of animal origin, which is suitable for consumption by humans or animals. The term “meat”, therefore, includes carcass, primal and retail cuts of animal flesh as well as ground and processed forms thereof. The meat may be derived from, for example, bovine, ovine, porcine, game or poultry. The tenn also encompasses seafood (i. e. meat from fish or shellfish sources) as well as meat from other sources such as venison, ostrich meat, alligator meat and frog's legs. In addition, the term encompasses animalorgan products derived from, for example, liver, kidney, heart, tongue and brain. The term “meat product” as used herein encompasses processed meats (such as sausages, hamburgers, luncheon meats and cold cuts) as well as pre-prepared meat dishes such as meat pies, fish pies, game pies, stews, lasagnes and other meat-containing pasta dishes, chicken kiev, chicken cordon-bleu, chicken-à-la-king, meat rolls, meatloafs, pâtés, sushi, sashimi, salmon mousses, fishcakes, stir-fries etc.

The term “safe” as used herein with reference to food refers to a state wherein the food is sufficiently free of pathogenic micro-organisms or the toxic products of microbial growth to be fit for human or animal consumption.

As used herein the term “shelf life” refers to the period of time that a food product remains saleable to retail customers. For example, in traditional meat processing, the shelf life of fresh meat and meat by-products is about 30 to 40 days after an animal has been slaughtered. Refrigeration of meat during this period of time largely arrests and/or retards the growth of micro-organisms. After about 30 to 40 days, however, refrigeration can no longer effectively control the proliferation of micro-organisms. Micro-organisms present on meat products after this time period may have proliferated to a great extent and/or have generated unacceptable levels of undesirable by-products. Spoilage micro-organisms may also act to discolour meat, making such meat unappealing and undesirable for human consumption. Pathogenic micro-organisms may have proliferated in this time period to a level wherein they are capable of causing disease in a animal that consumes the food product.

“Food spoilage”, as used herein, refers to organoleptic changes in the food, i.e. alterations in the condition of food which makes it less palatable, for example, changes in taste, smell, texture or appearance which are related to contamination of the food with one or more spoilage micro-organisms. Spoiled food may or may not be safe for consumption.

“Food preservation”, as used herein, refers to methods which maintain or enhance food safety, for example, by controlling the growth and proliferation of pathogenic and spoilage micro-organisms, thus guarding against food poisoning and delaying or preventing food spoilage. Food preservation helps food remain safe for consumption for longer periods of time (i.e. improves the shelf life) and inhibits or prevents nutrient deterioration and/or organoleptic changes which cause food to become less palatable.

The term “micro-organism” as used herein, includes bacteria, fungi and parasites. Non-limiting examples of micro-organisms that may be controlled using the formulations and methods of the present invention include bacteria from the genus Aeromonas (e.g. A. hydrophilia), Arcobacter, Bacillus (e.g. B. cereus), Brochothrix (e.g. B. thermosphacta), Campylobacter (e.g. C. jejuni), Carnobacterium (e.g. C. piscicola), Chlostridium (e.g. C. perfringens, C. botulinum), Enterobacteriacae, Escherichia (e.g. E. coli O157:H7), Listeria (e.g. L. monocytogenes), Pseudomonas (e.g. P. putida, P. fluorescens), Salmonella (e.g. S. typhimurium), Serratia (e.g. S. liquefacienis), Shigella, Staphylococcus (e.g. S. aureus), Vibrio (e.g. V. parahaemolyticus, V. cholerae) and Yersina (e.g. Y. enterocolitica); fungi such as Aspergillus flavum and Penicillium chrysogenum; parasites such as Amoebiasis (Emoebiasis histolytica), Balantidiosis (Balantidiosis coli), Entamoeba histolytica, Cryptosporidiosis (e.g. Cryptosporidium parvum), Cyclosporidiosis (e.g. Cyclospora cayetanensis), Giardiasis (e.g. Giardia lamblia, Giardia intestinalis), Isosporiasis (Isosporiasis belli), Microsporidiosis (Enterocytozoon bieneusi, S. intestinalis), Trichinella spiralis and Toxoplasmia gondii. The term micro-organism also refers to vegetative or dormant forms of bacteria and fungi, such as spores wherein activation of the growth cycle may be controlled using the formulations of the present invention in conjunction with low doses of irradiation.

The term “spoilage rnicro-organism” as used herein refers to a micro-organism that acts to spoil food. Spoilage micro-organisms may grow and proliferate to such a degree that a food product is made unsuitable or undesirable for human or animal consumption. For example, the production of undesirable by-products by the micro-organism, such as carbon dioxide, methane, nitrogenous compounds, butyric acid, propionic acid, lactic acid, formic acid, sulphur compounds, and other gases and acids can result in detrimental effects on the foodstuff, for example, alteration of the colour of meat surfaces to a brown, grey or green colour, or creation of an undesirable odour. The colour and odour alterations of food products due to the growth of spoilage micro-organisms frequently result in the product becoming unsaleable.

The term “pathogenic micro-organism” as used herein refers to a micro-organism that is capable of causing disease or illness in an animal or a human, for example, by the production of endotoxins, or by the presence of a threshold level of micro-organisms so as to cause food poisoning, or other undesirable physiological reactions in humans or animals.

### 1. FORMULATIONS

1.1 Candidate Compounds

The compounds for use as ingredients in the formulations of the present invention can be broadly classified as naturally-derived compounds, ie. compounds derived from a mineral, plant, animal or microbial source. For example, the compounds may be extracted from a plant, such as an herb, or they may be isolated from bacteria or fungi, or they may be isolated from a raw product derived from a plant source, such as an essential oil. In one embodiment of the present invention, the candidate compounds are isolated from a plant source. In a related embodiment, they are derived from an essential oil. In another embodiment of the present invention, the candidate compounds are derived from a bacterial source.

In accordance with the present invention, the compounds for use as ingredients in the formulations are substantially purified and may be in a solid or liquid form, such as an oil phase, or as part of a mixture or solution that contains relatively low levels of other compounds. One skilled in the art will understand that while these compounds or molecules originate from a natural source and can be extracted therefrom, they may also be synthesised by conventional synthetic techniques in order to produce sufficient quantities for commercial applications.

The candidate compounds may be known to have anti-microbial activity, or they may have no anti-microbial effects when used alone. For example, the candidate compounds may be known anti-bacterial, anti-fungal or anti-parasitic agents when used alone. In one embodiment of the present invention, the candidate compounds are known to exert anti-microbial effects.

The candidate compounds may also be known to exert one or more other desirable effects when applied to food. For example, the compounds may have anti-oxidant properties or desirable taste attributes (for example, they may be known flavourings or flavour enhancers), or they may be food tenderisers or preservatives. In one embodiment of the present invention, the candidate compounds are naturally-derived compounds selected from known food additives that are “generally recognised as safe” (GRAS) substances. GRAS substances are those whose use is generally recognised by experts as being safe, based on their extensive use in food prior to 1958 or on published scientific evidence. GRAS substances are approved for use in the food industry. In a related embodiment of the present invention, the candidate compounds are known anti-oxidants.

The candidate compounds may be organic or inorganic. In one embodiment of the present invention, the compounds for use as ingredients in the formulations are organic compounds.

Examples of suitable organic candidate compounds derived from natural sources include, but are not limited to, allicin, ascorbic acid, bacteriocins (such as nisin and pediocin), benzoic acid, caniphene, camphor, carnosic acid, carnosine, carnosol, carvacrol, carvone, chalcone, chlorogenic acid, cinnamic acid, citric acid, ellagic acid, enzymes (such as lactoperoxidase and lysozyme), eugenol, fatty acid esters (such as glyceryl monolaurate), ferulic acid, flavanoids (such as, flavone, flavanol, flavanone), gallic acid, glucosinolate, hydroquinone, hydroxybenzoic acids, hydroxycinnamic (or p-coumaric) acids, isoeugenol, isothiocyanates (such as those derived from crucifera including, for example, mustard, cabbage, Brussell sprouts, cauliflower, broccoli, rutabaga), lactic acid, linalool, oleuropein, polyphenol, proanthocyanidins, proprionic acid, proteins (such as avidin), pycnogenol, quinic acid, rosmarinic acid, sorbic acid, tannic acid, terpenes, terpeneol, terpinene, thymol, tocopherol, trans-cinnamaldehyde, ursolic acid and vanillin.

Examples of suitable inorganic candidate compounds derived from natural sources include, but are not limited to, chlorides (such as sodium chloride), sulphides, phosphates and nitrites.

1.2 Identification of Compounds Suitable for Use as Formulation Ingredients

A suitable candidate compound for inclusion as an ingredient in the formulations of the present invention is defined as one that is capable of enhancing the anti-microbial effect of low doses of radiation (i.e. below 3 kOGy). A number of assays are known in the art for evaluation of the anti-microbial effects of radiation and can be used to determine the ability of a candidate compound to enhance the anti-microbial effect of low doses of radiation. One skilled in the art will appreciate that the assay selected will depend upon the micro-organism being investigated as well as the food product to be treated. Typically assays are conducted in situ usingthe food product to be treated, however, in vitro assays using pure cultures of a micro-organism, or a combination of these assays, may be employed to evaluate a candidate compound. Typically the total viable count for the micro-organism is determined before and after treatment and compared to appropriate controls. Appropriate controls include samples that are untreated, samples treated with radiation alone and samples treated with the candidate compound alone.

In order to be selected as an ingredient for inclusion in the formulations of the present invention, a candidate compound decreases the dose of radiation required to decrease by at least one log order the number of micro-organisms surviving treatment (i.e. the D₁₀ value) when compared to a control treated with radiation alone. In accordance with the present invention, a suitable candidate compound is defined as one that decreases the D₁₀ value by at least 10% when compared to a control treated with radiation alone. In one embodiment of the present invention, the compound decreases the D₁₀ value by at least 20% when compared to a control treated with radiation alone. In a related embodiment, the compound decreases the D₁₀ value by at least 30%. In other related embodiments, the compound decreases the D₁₀ value by at least 40% and by at least 50%.

Appropriate assays for testing the candidate compounds can be readily selected by one skilled in the art. The following are non-limiting, representative examples of assays that may be used to evaluate the effectiveness of the candidate compounds in decreasing the D₁₀ value in vitro and in situ (i.e. in the food product).

If desired, the ability of the candidate compound to exert an anti-microbial effect alone (i.e. in the absence of irradiation) can also be determined inl vitro or ili situ using standard techniques. If the candidate compound is known or determined to exert an anti-microbial effect alone, the minimum inhibitory concentration of the compound may then be used as a convenient starting concentration in subsequent tests (such as those described below) to determine its effect in combination with irradiation.

1.2.1 In vitro Testing

The candidate compounds may first be tested in vitro using standard techniques. For example, one readily performed assay involves taking a selected known or readily available viable bacterial strains, such as Escherichia coli, Staphylococcus spp., Streptococcus spp., Pseudomonas spp., or Salmonella spp., at a pre-determined bacterial concentration (i.e. CFU/ml) in an appropriate culture medium at an appropriate temperature. Appropriate media and temperature for the culture of a variety of bacteria are known in the art and can be readily selected by a worker skilled in the art.

The bacterial culture is divided into test and control samples. The test sample is exposed to the candidate compound and irradiated at a low dose (i.e. less than 3 kGy). Control samples may be non-irradiated samples, samples treated with irradiation alone, or samples treated with the candidate compound alone, or a combination thereof. An aliquot of each of the test and control samples is then collected, diluted, and plated out onto an appropriate medium. The plated bacteria are incubated for between 24 and 48 hours at the appropriate temperature and the number of viable bacterial colonies growing on the plate is counted. Once colonies have been counted, the reduction in the number of bacteria in the sample treated with the candidate compound in combination with irradiation can be detenrined by comparison to the controls. Other in vitro assay methods are known to those skilled in the art.

1. 2.2 In situ Testing

One skilled in the art will understand that the assay adopted for testing the candidate compound is situ will depend both on the food product being protected and on the type of micro-organism. Typically the food product will be contacted with the candidate compound either alone or admixed with a suitable carrier, such as, for example, water, buffer, alcohol or oil, and then irradiated. Depending on the type of food product being used, the candidate compound may be mixed throughout the foodstuff (for example, with ground meat, powdered products, or liquids) or coated on the surface of the product (for examnple, on fruit, vegetables or primal or retail cuts of meat).

The food product is typically first treated to reduce pre-existing microbial contamination to below detectable levels by known methods (for example, with a high dose of irradiation under frozen condition at −80° C., which helps minimise off-flavour production during irradiation). The food product is subsequently inoculated with a known amount of one or more microbial cultures prior to treatment, such that the effect of the compound on the growvth and/or proliferation of the micro-organism(s) can be determined. Alternatively, the food product is not pre-treated and the effect of the compound on the natural contamination of a food product with micro-organisms over time can be evaluated.

Appropriate concentrations of the candidate compound for use with the food may be known from the prior use of the compound in the art or from preliminary MIC determinations using standard techniques. Alternatively, the concentration can be readily determined in a preliminary assay. Typically a low dose of radiation appropriate for the micro-organism being employed is first selected, then samples of the food product are treated with varying concentrations of the candidate compound and irradiated at the selected dose. Determination of the amount of micro-organisms surviving treatment permits selection of an appropriate range of concentrations for the candidate compound to be tested subsequently with varying doses of radiation in order to determine the D₁₀ value.

In one embodiment of the present invention, the candidate compounds are tested in meat samples contaminated with set concentrations of E. coli or S. typhi. Prior to inoculation with the bacteria, the meat samples are treated to remove pre-existing microbial contamination by known methods, such as with a high dose of irradiation, for example 25-30 kGy at −80° C. After treatment with the candidate compound and irradiation, the meat samples are immediately homogenised and serial dilutions are plated onto an appropriate medium. After incubation for an appropriate amount of time at 35-37° C., colonies of E. coli and S. typhi are counted.

In another embodiment of the present invention, meat samples are contacted with the candidate compound and then irradiated. The meat samples are refrigerated and duplicate test samples removed after appropriate periods of time. The test samples are homogenised and serial dilutions are plated onto an appropriate. medium. After incubation for an appropriate amount of time at 35-37° C., colonies of micro-organisms that have grown on the medium are counted.

1.3 Additives

The formulations of the present invention may contain one or more additives that provide beneficial properties to the formulation, such as added stability, additional anti-microbial or anti-oxidant effects, texture or colour preservation or enhanced dispersibility of the formulations over the surface or throughout the food product. Food additives are well known in the art and are routinely used on food products. Selection of appropriate additives and determination of the concentration to be included in the formulations is considered to be within the ordinary skills of the worker in the art. Representative, non-limiting examples of additives that may be used in the formulations of the present invention are provided below.

1.3.1 Chelating Agents

The term “chelating agent” as used herein refers to an organic or inorganic compound capable of forming co-ordination complexes with metals.

Appropriate chelating agents for use in food processing are non-toxic to mammals and are known in the art [see, for example, T. E. Furia (Ed.), CRC Handbook of Food Additives, 2nd Ed., pp. 271-294 (1972, Chemical Rubber Co.); M. S. Peterson and A. M. Johnson (Eds.), Encyclopaedia of Food Science, pp. 694-699 (1978, AVI Publishing Company, Inc.)]. In general suitable chelating agents include carboxylic acids, polycarboxylic acids, amino acids and phosphates, such as, acetic acid; adenine; adipic acid; ADP; alanine; B-alanine; albumin; arginine; ascorbic acid; asparagine; aspartic acid; ATP; benzoic acid; n-butyric acid; casein; citraconic acid; citric acid; cysteine; dehydracetic acid; desferri-ferrichrysin; desferri-fertichrome; desferri-ferrioxamin E; 3,4-dihydroxybenzoic acid; diethylenetriaminepentaacetic acid (DTPA); dimethylglyoxime; O,O-dimethylpurpurogallin; EDTA; formic acid; fumaric acid; globulin; gluconic acid; glutamic acid; glutaric acid; glycine; glycolic acid; glycylglycine; glycylsarcosine; guanosine; histamine; histidine; 3-hydroxyflavone; inosine; ino sine triphosphate; iron-free ferrichrome; isovaleric acid; itaconic acid; kojic acid; lactic acid; leucine; lysine; maleic acid; malic acid; methionine; methylsalicylate; nitrilotriacetic acid (NTA); ornithine; orthophosphate; oxalic acid; oxystearin; B-phenylalanine; phosphoric acid; phytate; pimelic acid; pivalic acid; polyphosphate; proline; propionic acid; purine; pyrophosphate; pyruvic acid; riboflavin; salicylaldehyde; salicyclic acid; sarcosine; serine; sorbitol; succinic acid; tartaric acid; tetrametaphosphate; thiosulphate; threonine; trimetaphosphate; triphosphate; tiyptophani; uridine diphosphate; uridine triphosphate; n-valeric acid; valine; xanthosine.

Many of the above chelating agents are used in their salt forms which are commonly alkali metal or alkaline earth salts such as sodium, potassium or calcium or quaternary ammonium salts. Chelating compounds with multiple valencies may be beneficially utilised to adjust pH or selectively introduce or abstract metal ions.

Suitable chelating agents also include mnolecularencapsulating compounds such as cyclodextrin. Cyclodextrins are cyclic carbohydrate molecules having six, seven, or eight glucose monomers arranged in a donut shaped ring, which are denoted alpha, beta or gamma cyclodextrin, respectively. As used herein, “cyclodextrin” refers to both unmodified and modified cyclodextrin monomers and polymers. Cyclodextrin molecular encapsulators are commercially available from, for example, American Maize-Products (Hammond, Ind.). Cyclodextrins are described in Inclusion Compounds, Vol. III, Chapter 11, pp 331-390 (Academic Press, 1984).

1.3.2 Surfactants

Surfactants can be classified as anionic, zwitterionic or non-ionic, depending on the overall charge that the molecule carries.

Anionic surfactants useful in the formulations of the present invention include alkyl sulphates, alkyl or alkane sulphonates, linear alkyl benzene or naphthalene sulphonates, secondary alkane sulphonates, alkyl ether sulphates or sulphonates, alkyl phosphates or phosphonates, dialkyl sulphosuccinic acid esters, sugar esters (e.g., sorbitan esters), C₈₋₁₀ alkyl glucosides, alkyl carboxylates, paraffin sulphonates sulphosuccinate esters and sulphated linear alcohols.

Zwitterionic or amphoteric surfactants useful with the formulations include β-N-alkylaminopropionic acids, n-alkyl-β-iminodipropionic acids, imidazoline carboxylates, n-alky-betaines, amine oxides, sulphobetaines and sultaines.

Non-ionic surfactants useful with the formulations include polyether (also known as polyalkylene oxide, polyoxyalkylene or polyalkylene glycol) compounds.

1.3.3 Plant Derived Additives

Plant derived additives are a broad group of known food additives of plant origin and include, for example, natural extracts, herbs, spices and essential oils.

A “natural extract” in the context of the present invention is a concentrated preparation, typically containing a mixture of compounds, extracted from a natural source, such as from a plant or animal. The identities and proportions of the compounds that make up a natural extract are usually not known. A natural extract may also comprise an essential oil. Examples of natural extracts useful in the present invention include, but are not limited to, those from capsicum, celery, chicory root, fennel, garlic, ginger, ginkgo biloba, panax ginseng root, hop vine resin, liquorice root, marigold, mustard, onion, orris root, peppermint, red wine extract, sesame, Siberian ginseng, spearmint, vanilla and yucca schidigera.

Examples of herbs and spices useful in the present invention include, but are not limited to, allspice, anise, basil, bay leaf, black pepper, caraway, cardamom, cayenne pepper, celery seed, chilli powder, cinnamon, coriander, cumin, curry powder, dill, fenugreek, ginger, mace, marjoram, mint, nutmeg, oregano, paprika, parsley, sage, rosemary, tarragon, thyme and white pepper, or extracts thereof.

Essential oils are known in the art and are generally defined as a volatile liquid obtained from plants, nuts or seeds. Examples of essential oils that may be added to the formulations of the present invention include, but are not limited to, almond oil, anise oil, basil oil, camphor oil, castor oil, cedar oil, cinnamon oil, citronella oil, clove oil, corn oil, cotton seed oil, eucalyptus oil, fennel oil, geranium oil, ginger oil, grapefruit oil, juniper oil, lemon oil, lemongrass oil, linseed oil, marjoram oil, mandarin oil, mint oil, orange oil, origanum oil, pepper oil, pine needle oil, rose oil, rosemary oil, savory oil, sesame oil, soybean oil, tangerine oil, tea tree and tea seed oil, thyme oil and walnut oil.

1.3.4 Thickeners

Generally, thickeners suitable for use in the formulations of the present invention include natural gums such as xanthan gum, as well as cellulosic polymers, such as carboxymethyl cellulose, hydroxypropyl methyl cellulose and methyl cellulose. Other examples of suitable thickeners include, but are not limited to, agar, agarose, alginate, carragenan, cellulose acetate, cellulose xanthate, chitosan, gellan gum, pectin and starch. The concentration of thickener used in the present invention will be dictated by the desired viscosity within the final composition and can readily be determined by one skilled in the art.

1.3.5 Other Additives

Other additives useful in the formulations of the present invention include, for example, antioxidants (such as, butylated hydroxyanisole [BHA] and butylated hydroxytoluene [BHT]), emulsifiers (such as lecithins, mono- and diglycerides, diacetyltartaric acid esters of mono- and diglycerides or sorbitan esters), sequestering agents (such as, tetrasodium pyrophosphate), natural or synthetic colourings, dyes, seasonings and flavourings (such as gaseous or liquid smoke), vitamins, minerals, nutrients, and enzymes.

1.4 Composition of the Formulations

The formulations of the present invention comprise as ingredients one or more naturally-derived compounds identified from among the candidate compounds as described above. The selected candidate ingredients may further impart on the food product other desirable effects, for example, enhanced flavour, anti-oxidant properties, tenderisation. The formulations can further optionally include one or more other additives. In one embodiment of the present invention, the formulation comprises one or more selected candidate ingredients and an herb extract. In another embodiment, the formulation comprises one or more selected candidate ingredients and a sequestering agent. In a. related embodiment the formulation comprises one or more selected candidate ingredients, a sequestering agent and an herb extract.

The present invention contemplates a variety of formulation formats known in the art. For example, the formulations can be in liquid or dry form, or they can be formulated in an intermediate format such as a paste, powder, jelly or granular format, or they can be in the form of biofilms such as those disclosed in International Patent Application WO 01/37683.

The formulations may contain a carrier that functions to solubilise or disperse the selected candidate ingredient and allow it to be delivered to the food product. The choice of carrier will be dependent on the method of applying the formulation to the food product. Selection of an appropriate carrier is considered to be within the ordinary skills of a worker in the art. Suitable carriers comprise one or more liquid components, examples of which include, but are not limited to, water, oils (such as a vegetable oil or mineral oil), and organic solvents (for example, simple alkyl alcohols such as ethanol, isopropanol, n-propanol and the like; polyols such as propylene glycol, polyethyleneglycol, glycerol, sorbitol, and the like). Typically, when used, the carrier makes up a large portion of the formulation. One skilled in the art will understand that selection of the carrier and the concentration at which it is used should be such that it does not substantially reduce the efficacy of the formulation of the present invention.

The present invention provides formulations in which the concentration range for each selected candidate ingredient has been optimised such that the formulation will enhance the anti-microbial effect of low doses of radiation and thus maintain or enhance the safety of the food product to which it is applied while retaining the organoleptic properties of the food product. One skilled in the art will appreciate that the formulations will typically be prepared in concentrated solutions to be added to a food product in an appropriate amount to provide a given final concentration in the food product. The amount of the formulation to be applied to the food product to provide the desired final concentration will thus be dependent on the weight of the food product. For example, starting with a formulation containing 1.0% of selected candidate ingredient and using 5 ml of this formulation to treat a 100 g piece of meat will provide a final concentration of ingredient on the meat of 0.05% v/w. The concentration ranges provided herein describe the final concentration of the ingredient in the food product.

The formulations of the present invention provide for final concentrations of the selected candidate ingredients in the food product to which they are applied of between about 0.001% and 10.0% (weight/volumne or volume/volume). In one embodiment of the present invention, the formulations provide for final concentrations of the ingredients in the food product of between about 0.005% and 5.0%. In a related embodiment, the formulations provide for final concentrations of the ingredients in the food product of between about 0.01% and 2.5%.

Appropriate concentrations of each selected candidate ingredient to be included in the formulations are those that decrease the D₁₀ value for the food product by at least 10% compared to treatment with irradiation alone as described above. When a combination of ingredients is used in the formulations, the combination can be tested to determine the effect on the D₁₀ value in a particular food product as outlined above. The combination may decrease the D₁₀ value to a greater extent than each ingredient individually, or it may decrease the D₁₀ value to a similar extent or less than each ingredient individually.

In accordance with the present invention, the formulation decreases the D₁₀ value for the food product by at least 10% compared to treatment with irradiation alone. In one embodiment the formulation decreases the D₁₀ value by at least 20% compared to treatment with irradiation alone. In a related embodiment, the formulation decreases the D₁₀ value by at least 30%. In other related embodiments, the formulation decreases the D₁₀ value by at least 40% or at least 50%.

One skilled in the art will understand that the amount of each selected candidate ingredient included in the formulation should not adversely affect the organoleptic qualities of the food. Methods of sensory evaluation of food products are well known in the art and include those described herein and elsewhere. When the ingredient is already known in the art as a food additive, such as a GRAS compound, the final concentration of the ingredient included in the formulation is within the range known to be safe for use in the food industry.

In one embodiment of the present invention, the formulation comprises, as a selected candidate ingredient, trans-cinnamaldehyde (to provide a final concentration in the food product of about 0.025% -1.5%), thymol (final concentration of about 0.038% -1.6%), carvacrol (final concentration of about 0.029% -1.15%), tannic acid (final concentration of about 0.38%) or nisin (final concentration of about 625 UI/g), or a combination thereof. In another related embodiment, the formulation further comprises tetrasodium pyrophosphate (to provide a final concentration in the food product of about 0.003%-0.1%). In a related embodiment, the formulation comprises trans-cinnamaldehyde (final concentration of about 0.025%) as the active ingredient. In another related embodiment, the formulation comprises carvacrol (final concentration of about 1.0%) and tetrasodium pyrophosphate (final concentration of about 0.1%). In another related embodiment, the formulation comprises trans-cinnamaldehyde (final concentration of about 0.013%) and tetrasodium pyrophosphate (final concentration of about 0.003%).

1.5 Testing the Formulations

The formulations of the present invention can be tested by standard techniques, such as those described above, to determine their effect in enhancing the anti-microbial effects of low doses of radiation. One skilled in the art will appreciate that a particular formulation will not necessarily work uniformly well on all food types due, in part, to differences in the chemical constitution of various foods. The formulation should, therefore, be tested on the food product(s) for which its application is ultimately intended.

The formulations can be fuirther tested to ensure that they do not adversely affect the organoleptic qualities of the food product to which they are applied using standard sensory evaluation tests. In addition, it is important that the components of the formulations do not interact, or react with the applied radiation to produce toxic or potentially toxic by-products. Food products treated with the formulations of the present invention, therefore, may also be subjected to standard toxicity testing.

1.5.1 Sensory Evaluation

It is well known in the art that irradiation can adversely affect the organoleptic properties of food. The irradiated food may develop off-odours or flavours due, for example, to the oxidation of polyunsaturated fatty acids and sulphuric amino acids present in the food product. Irradiated, cooked meat products often develop a characteristic off-flavour upon reheating, which is known as waimed-over-flavour (WOF) or meat flavour deterioration. Such adverse effects are typically associated with the dose of radiation applied to the food. The present invention provides formulations that allow for the use of lower doses of irradiation than are conventionally used in food preservation, while achieving the same end effect in terms of food safety. These lower doses of radiation are less likely to affect the organoleptic properties of the food product.

Sensory evaluation of the food product treated with the formulations of the present invention and irradiation can be conducted to confirm that the quality of the treated food is not affected. Such evaluation will also confirm that the selected concentratiois for the ingredients of the formulation do. not themselves adversely affect the quality of the food (i.e. the taste, smell, texture and/or appearance).

Methods of evaluating the organoleptic properties of foods are well-known in the art. Typically, sensory evaluations are performed using individuals who are spatially separated from each other, for example, in individual partitioned booths, as testers and use a hedonic nine-point scale that ranges from 1 (most disliked) to 9 (most liked), with 5 indicating no preference [Larmond, Laboratory methods for Sensory Evaluation of Foods, Research branch of Agriculture Canada (1977)]. Odour and taste are generally evaluated under a red light, which masks any differences in the colour of the food. Another nine-point hedonic scale test can then be carried out under normal light to evaluate the acceptability of the appearance of the food product. Both samples treated with the formulations and irradiation and appropriate controls are evaluated and the results are compared. The controls may be irradiated or non-irtadiated. Samples are usually presented in groups comprising treated and control samples, with each sample being assigned a random number. Foods are considered to be acceptable when the average value awarded to them by the consumers is between 5 and 9.

1.5.2 Toxicity Testing

Once a food product has been contacted with a formulation of the present invention and irradiated, it can be subjected to standard toxicity tests to ensure that the combination of the ingredients of the formulation, or the combination of the formulation with irradiation, does not result in the generation of undesirable by-products. Methods of conducting toxicity tests are well-known in the art [see, for example, Current Protocols in Toxicology Maines, Costa, Hodgson and Reed (Eds.), J. Wiley & Sons, NY]. It is understood that many of the formulations may not require toxicity testing as they contain active ingredients, additives and/or carriers that are GRAS substances at concentrations known to be safe for human or animal consunption.

### 2. METHODS OF APPLYING THE FORMULATIONS TO FOOD PRODUCTS

One skilled in the art will understand that the method of applying the formulation to the food product will depend to a large extent upon the physical nature of the food, for example, whether it is liquid, solid, ground or powdered.

Methods of applying the formulation to solid food products include, but are not limited to, injection, vacuum tumbling, spraying, painting or dipping. Alternatively, the formulations can be applied to solid food products as a marinade, breading, seasoning rub, glaze, colourant mixture, and the like. In the case of ground or powdered food products, the compound or formulation may be mixed directly into the ground or powdered material. Alternatively, when the food product is ground and does not have to be kept dry, the formulation can be prepared in a liquid suspension and then mixed into the ground material. The important criterion to be met when applying the formulations is that the formulation is available to the surface subject to microbial degradation.

The present invention also contemplates that the formulation may be indirectly placed into contact with the food surface by applying the formulation to food packaging and thereafter applying the packaging to the food surface. The packaged food can then be irradiated.

In one embodiment of the present invention, the formulation is applied to the surface of the food product by dipping the food into a liquid preparation of the formulation. In another embodiment, the formulation is applied to a ground food product by mixing a liquid preparation of the formulation into the food product.

The optimum amount of the formulation to be used will depend on the composition of the particular food product to be treated and the method used to apply the formulation to the food product, and can be determined without undue experimentation by one skilled in the art.

### 3. IRRADIATION

3.1 Types of Radiation

Suitable types of ionising radiation for food irradiation are high-energy gamma rays, x-rays, and accelerated electrons. As is known in the art, only certain radiation sources are suitable for food irradiation. These include the radionuclides cobalt-60 (⁶⁰Co) and caesium-137 (¹³⁷Ce), which emit gamma rays; x-ray machines having a maximum energy of approximately five million electron volts (5 MeV), and electron accelerators having a maximum energy of approximately 10 MeV.

As the field of food irradiation technology continues to expand, it is expected that other sources of ionising radiation suitable for food irradiation may be developed in the future. The use of the formulations of the present invention with these future sources is also considered to be within the scope of the present invention.

3.2 Radiation Dose

Radiation dose is the quantity of radiation absorbed by the food as it.passes through a radiation field. Radiation dose is measured in Grays (Gy). Doses of up to 10,000 Gy (10 kGy) have been approved for use in food irradiation.

The dose of radiation used on a food product is dependent on its application. For example, doses below 1 kGy are sufficient too delay ripening and to inactivate certain parasites, whereas doses over 10 kGy are required to reduce numbers of micro-organisms to the point of sterility. Typical doses currently used for food preservation that lead to an acceptable reduction in the number of spoilage and pathogenic micro-organisms are in the range of 1 to 10 kGy. The use of irradiation to preserve foods has been described as “cold pasteurisation” and typically utilises radiation doses of 1.5-3.0 kGy. Cold pasteurisation differs from sterilisation in that it does not completely destroy micro-organisms but inactivates and thus reduces them to acceptable levels. Cold pasteurisation techniques can also eliminate bacteria in vegetative cell fonn. In contrast to sterilisation, cold pasteurisation does not inactivate enzymes and thus can be used to provide to consumers fresh foods that are pathogen-free and free from substantial changes in quality.

In accordance with the present invention, the use of the formulations disclosed herein with low doses of radiation are intended as a cold pasteurisation technique that provides a safe food product with extended shelf life by inactivation of food-borne micro-organisms. The present invention thus provides formulations that can be used in conjunction with irradiation of food products in order to allow lower doses of radiation to be used and still provide a food preservation effect. In accordance with the present invention, the dose of radiation applied to the food product in conjunction with the formulation is less than about 3.0 kGy. Irradiation doses greater than 3.0 kGy tend to result in the production of off-flavours and aromas in the treated food product. The present invention, therefore, provides for safe food in which the generation of off-flavours and aromas has been minimised. In general, the dose of radiation used with the formulations of the present invention is between about 0.005 kGy and about 2.75 kGy.

In one embodiment of the present invention, the dose of radiation is between about is between about 0.005 kGy and about 2.5 kGy. In a related embodiment, the dose is between about 0.01 kGy and about 2.5 kGy. In anotherrelated embodiment, the dose is between about 0.01 kGy and about 2.25 kGy. In still another related embodiment, the dose is between about 0.05 kGy and about 2.25 kGy.

In another embodiment of the present invention, the dose of radiation applied to the food product in conjunction with the formulation is less than about 2.0 kGy. In a related embodiment, the dose is between about 0.05 kGy and about 2.0 kGy. In another related embodiment, the dose is between about 0.1 kGy and about 2.0 kGy. In other related embodiments, the dose is between about 0.15 kGy and about 2.0 kGy; between about 0.2 kGy and about 2.0 kGy; between about 0.25 kGy and about 2.0 kGy and between about 0.5 kGy and about 2.0 kGy.

In still another embodiment of the present invention, the dose of radiation applied to the food product in conjunction with the formulation is less than about 1.0 kGy. In a related embodiment, the dose is between about 0.01 kGy and about 1.0 kGy. In another related embodiment, the dose is between about 0.01 kGy and about 0.9 kGy. In other related embodiments, the dose is between about 0.05 kGy and about 0.9 kGy; between about 0.05 kGy and about 0.8 kGy; between about 0.1 kGy and about 0.8 kGy; between about 0.1 kGy and about 0.7 kGy; between about 0.1 kGy and about 0.6 kGy and between about 0.1 kGy and about 0.5 kGy.

In one embodiment of the present invention, treatment of a food product with the formulations in conjunction with low doses of irradiation (i.e. less than 3 kGy) decreases the number of micro-organisms in the food product by at least 1 log order when compared to a control treated with irradiation alone. In a related embodiment, the formulations and irradiation decrease the number of micro-organisms by at least 2 log orders when compared to a control treated with irradiation alone. In another related embodiment, the formulations and irradiation decrease the number of micro-organisms by at least 3 log orders when compared to a control treated with irradiation alone. In another related embodiment, the formulations and irradiation decrease the number of micro-organisms by at least 4 log orders when compared to a control treated with irradiation alone.

In another embodiment of the present invention, treatment of a food product with the formulations in conjunction with row doses of irradiation (i.e. less than 3 kGy) decreases the number of micro-organisms in the food product over time and thus increases the shelf life of a food product. In accordance with this embodiment of the invention, the use of formulations in conjunction with low doses of irradiation decreases the number of micro-organisms surviving in a food product after 15 days at 4° C. by at least 1.5 log orders when compared to a control treated with irradiation alone. In a related embodiment, the formulations and irradiation decrease the number of micro-organisms surviving in a food product after 15 days at 4° C. by at least 2.0 log orders when compared to a control treated with irradiation alone. In another related embodiment, the formulations and irradiation decrease the number of micro-organisms surviving in a food product after 15 days at 4° C. by at least 3.0 log orders when compared to a control treated with irradiation alone. In a related embodiment, the formulations and irradiation decrease the number of micro-organisms surviving in a food product after 15 days at 4° C. by at least 4.0 log orders when compared to a control treated with irradiation alone.

In another embodiment of the present invention, treatment of a food product with the formulations in conjunction with low doses of irradiation (i.e. less than 3 kGy) decreases the number of micro-organisms surviving in the food product to below detectable levels after at least 25 days storage at 4° C. In a related embodiment, the use of formulations and irradiation decreases the number of micro-organisms surviving in a food product to below detectable levels after at least 15 days storage at 4° C. In a related embodiment, the use of formulations and irradiation decreases the number of micro-organisms surviving in a food product to below detectable levels after at least 5 days storage at 4° C.

In another embodiment of the present invention, the use of the formulations in conjunction with low doses of irradiation improve the organoleptic qualities of a food product when compared to a control treated with irradiation alone. In this embodiment, the formulation may or may not also decrease the number of micro-organisms in the food product compared to the control. In a related embodiment, the formulations improve the taste of the food product. In another related embodiment, the formulations improve the aroma of the food product.

3.3 Methods of Irradiation

Suitable sources of ionising radiation which may be used with the formulations of the present invention include, but are not limited to, electron beam accelerators, gamma sources (such as from a cobalt-60 or caesium-137 source), or X-ray tubes. Commercial plants using cobalt-60 sources to administer gamma radiation are presently available sources of ionising radiation for treating food products (see, for example, Combination Processes in Food Irradiation, International Atomic Energy Agency, Vienna, 1981, at 413420).

Thin packages of food, flowing streams of grain and liquids can best be treated with electron beams, which provide high throughput rates and low unit costs. However, food packages which are too thick for electron penetration are treated with high-energy photons. In such applications, gamma rays from ⁶⁰Co sources are usually applied. High-energy x-rays are another kind of penetrating radiation that can be used for these applications. The technology has recently been developed for generating x-rays with enough intensity and penetration to process a variety of foods on a commercial scale, for example, the Palletron™ (MDS-Nordion, Ottawa, Canada) is an x-ray irradiator for processing intact pallets.

Irradiation of food products is widely used as a form of preservation in the food industry. Methods of irradiating foods are, therefore, well-known in the art. In accordance with the present invention, the food products treated with the formulations may be pre-packaged prior to irradiation or they may be irradiated prior to packaging.

3.4 Factors Affecting Radiation Dose

3.4.1 Temperature

Fresh food products are typically stored under refrigerated or frozen conditions (i.e. at about 4° C. or about −80° C., respectively), whereas dried produce may be stored at room temperature. The present invention contemplates the use of the formulations to decrease the radiation dose required to achieve a food preservation effect at a variety of temperatures. One skilled in the art will understand that the dose of radiation required to effect food preservation can vary according to the temperature of the food product to which the irradiation is being applied. Variations in the dose of radiation required for use with the formulations depending on the temperature at which the radiation is being applied may therefore occur. These variations may result in a lower dose being required and may, therefore, enhance the effectiveness of the formulations, or a higher dose may be iequired. In either case, however, in accordance with the present invention, the dose of irradiation required with the use of the formulations is less than that required to achieve the same end effect in the absence of the formulations.

3.4.2 Packaging Atmospere

As is known in the art, various packaging systems exist that can increase the shelf life of most food products by manipulating the atmosphere around the produce. Controlled atmosphere packaging (CAP) and modified atmosphere packaging (MAP) refer to the addition or removal of gases from retail food packages to reduce the respiration of the packaged product. The levels of oxygen, carbon dioxide, nitrogen, water vapour and ethylene are manipulated to provide an altered atmosphere around the food. CAP refers to the intentional modification of the internal gaseous atmosphere of packaging to a specified condition and the maintenance of that atmosphere throughout the cycle, regardless of temperature or other environmental variations. MAP, on the other hand, refers to a packaging system whereby the composition of the atmosphere is not closely controlled, with only the initial internal conditions of the package being established. The atmosphere around food products packaged under MAP subsequently changes through respiration by the produce and permeation of gases and vapours through the packaging film.

The formulations of the present invention are suitable for use with irradiation for the preservation of food packaged under a variety of atmospheres. For example, the food may be packaged under ambient conditions, under CO₂, under vacuum or under MAP conditions. One skilled in the art will understand that the dose of radiation required to effect food preservation may vary according to the atmosphere surrounding of the food product at the time of irradiation. Variations in the dose of radiation required for use with the formulations depending on the atmosphere surrounding the product at the time of irradiation may therefore occur. These variations may result in a lower dose being required and may, therefore, enhance the effectiveness of the formulations, or they may result in a higher dose may be required. In either case, however, in accordance with the present nvention, the dose of irradiation required with the use of the formulations is less than that required to achieve the same end effect in the absence of the formulations.

### 4. USE OF THE FORMULATIONS

The present invention contemplates the use of the formulations described herein with irradiation for the preservation of fresh, processed, refrigerated, frozen and dried food products. The food products treated with the formulations may be irradiated loose or they may be pre-packaged. Alternatively, individual food components may be irradiated prior to further processing or combining with other food components. The formulations of the present invention can be used in combination with irradiation to increase the safety of food irradiated at a certain dose (for example, to eliminate resistant micro-organisms), or they can be used to decrease the dose of radiation required to obtain a food preservation effect and thereby prevent a deterioration in the organoleptic qualities of the food.

The use of the formulations in combination with low doses of irradiation can also increase the shelf life of a food product. In accordance with the present invention, treatment with the combination of the formulation and irradiation will extend the shelf life of a food product by at least 2-fold when compared to treatment with irradiation alone. In one embodiment of the present invention, the shelf life of the food product will be extended at least 3-fold relative to the use of irradiation alone. In a related embodiment, the shelf life will be extended by at least 4-fold. In other related embodiments, the shelf life will be extended by at least 5-fold and at least 6-fold.

As is known in the art, shelf life can be evaluated by determining the length of time a food product can be stored before the content of micro-organisms reaches a certain threshold. For example, the appropriate threshold for certain bacteria is when the bacterial count in the food product reaches 6 log. In one embodiment of the present invention, meat treated with irradiation alone can be stored for about 8 days before a bacterial count of approximately 6 log is reached, whereas meat treated with a formulation comprising thymol in conjunction with irradiation can be stored for 15 days and meat treated with a formulation comprising trans-cinnamaldehyde in conjunction with irradiation can be stored for more than 35 days.

To gain a better understanding of the invention described herein, the following examples are set forth. It should be understood that these examples are for illustrative purposes only. Therefore, they should not limit the scope of this invention in any way.

### EXAMPLES

Materials and Methods

Handling of the Meat

Chicken breasts and ground beef were purchased at a local supermarket (IGA, Laval, Canada) and transported to the Canadian Irradiation Centre (CIC) under refrigerated conditions (4±2° C.). The chicken breast were vacuum-packed in 0.5 mil metalized polyester/2 mil EVA copolymer bag (205×355 mm, WINPACK, St-Léonard, Quëbec) and sterilised by irradiation using a IR-147, Carrier Type Irradiator (Overlapping source design, MDS Nordion, Kanata, ON, Canada) at 30 kGy under frozen conditions (−80° C.). The ground beef was vacuum-packed in portions of 450 g by the supermarket and sterilised by irradiation using a UC-15A at 25 kGy under frozen conditions (−80° C.). An underwater calibrator (MDS Nordion, Kanata, UN, Canada) equipped with a ⁶⁰Cobalt source at a dose rate of 28.615 kGy/h was used for this irradiation treatment. The irradiation treatments were carried out at the Canadian Irradiation Centre (Laval, QC, Canada). The chicken breast and the ground beef were stored at −80° C. until needed.

Preparation of Bacterial Cultures

Escherichia coli (ATCC 25922) and Salmonella typhi (ATCC 19430) were obtained from the American Type Culture Collection (Rockville, Md., USA) and maintained at −80° C. in Tryptic Soy Broth (TSB; Difco Laboratory, Detroit, Mich.) containing glycerol (10%; v/v). Before each experiment, stock cultures were subcultured through two consecutive 24 h growth cycles in TSB at 35° C. to obtain working cultures containing approximately 10⁹ UCF/ml for E. coli and S. typhi.

Active Compounds

Carnosine, carvacrol and trans-cinnamaldehyde were purchased from Aldrich (Milwaukee, Wis., USA). Ascorbic acid, butylated hydroxyanisole (BHA), butylated hydroxytoluene (BHT), nisin, EDTA and tetrasodium pyrophosphate were purchased from Sigma (St Louis, Mo., USA), tannic acid was purchased from ICN Biochemicals Inc (Aurora, Ohio, USA) and thymol was purchased from American Chemicals LTD (Montreal, QC, Canada). Essential oils from thyme (Thymus satureioide) and rosemary (Rosmarinus officinalis cineoliferum CT2) extract were obtained from Robert & Fils (Montreal, QC, Canada).

Irradiation

The irradiation treatments of ground beef samples for D₁₀ determination was done using UC-15B irradiator (MDS-Nordion International Inc., Kanata, ON, Canada) equipped with a ⁶⁰Co source at a dose rate of 14.42 kGy/h). Irradiation doses used for D₁₀ determination were ranged from 0.1 to 0.6 kGy for E. coli and from 0.50 to 2.0 kGy for S. typhi. Under frozen condition, the irradiation doses ranged from 0.1 to 0.7 kGy for E. coli and from 0.5 to 3.0 kGy for S. typhi. For the determination of the effect of various concentrations of carvacrol on the irradiation sensitivity, samples were irradiated at 0.25 kGy for E. coli and at 0.5 kGy for S. typhi. Irradiation doses used for D₁₀ determination in chicken breast ranged from 0.1 to 0.7 kGy for E. coli and from 0.25 to 2.0 kGy for S. typhi. Samples were analysed immediately after irradiation to determine the microbial count.

Microbiological Analysis

Samples were homogenised for 2 min in sterile peptone water (0.1%) using a Lab-blender 400 stomacher (Laboratory Equipment, London, UK). From this mixture, serial dilutions were prepared and appropriate ones were pour-plated in tryptic soy agar (TSA) (Difco, Laboratories, Detroit, Mich., USA) and incubated at 35° C., 24 hours for the numeration of E. coli and S. typhi.

Statistical Analyses

D₁₀ deteriiination: The kinetics of bacteria destruction by irradiation with or without the active compounds and under different packaging conditions was evaluated by linear regression. Bacterial counts (log CFU/ml) were plotted against irradiation doses or compound concentrations and the D₁₀ values were calculated using SigmaPlot program. Statistical analysis was done using SPSS program. The Duncan test was used with a probability of 0.05.

TBARS determination: Statistical analysis was done using SPSS program. The Duncan test was used with a probability of 0.05.

### EXAMPLE 1

### IRRADIATION SENSITIVITY OF E. coli AND S.typhi IN GROUND BEEF

Concentration of the Active Compounds

The concentration ot each active compound added to the meat samples was based on results obtained in a previous experiment. These concentrations represent the minimum inhibitory concentrations (MIC) of the active compounds required to be present in artificial culture media in order to reduce by 1 log the number of bacteria in culture. Six pathogenic and spoilage bacteria, commonly found in meat and meat products, were tested. Mean values of MIC were: 0.5% for ascorbic acid; 0.125% for carvacrol; 0.5% for rosemary; 0.2% for thyme, 0.1% for thymol; and 0.25% for trans-cinnamaldehyde. The concentration used for carnosine (1.0%) was selected from the literature (Sebranek, 1999). The concentrations of BHA (0.01%), BHT (0.01%), EDTA (100 ppm), and tetrasodium pyrophosphate (0.1%) corresponded to the concentrations recommended by the Canadian Food Inspection Agency (CFIA).

1.1 Determiniation of MIC for Active Compounds in Ground Beef

The MIC values for the active compounds were determined on the basis of their antibacterial effectiveness in meat. Concentrations retained were those to reduce by 1 log CFU the population of E. coli or S. typhi in ground beef. Ground beef samples weighing 200 g were contaminated with working cultures of E. coli or S. typhi to obtain a final concentration of 10⁵ CFU/g. The ground beef samples containing micro-organisms was mixed during 3 minutes at medium speed in a 4L-conmmercial blender (Waring Products, New Hartford, Col., USA) and different concentrations of the active compounds were incorporated, followed by another 3 minutes period mixing. Sterile petri plates (60×15 mm) were filled with ground beef samples containing micro-organisms and different concentrations of active compounds in portion of 25 g each and stored at 4° C. for 24 hours.

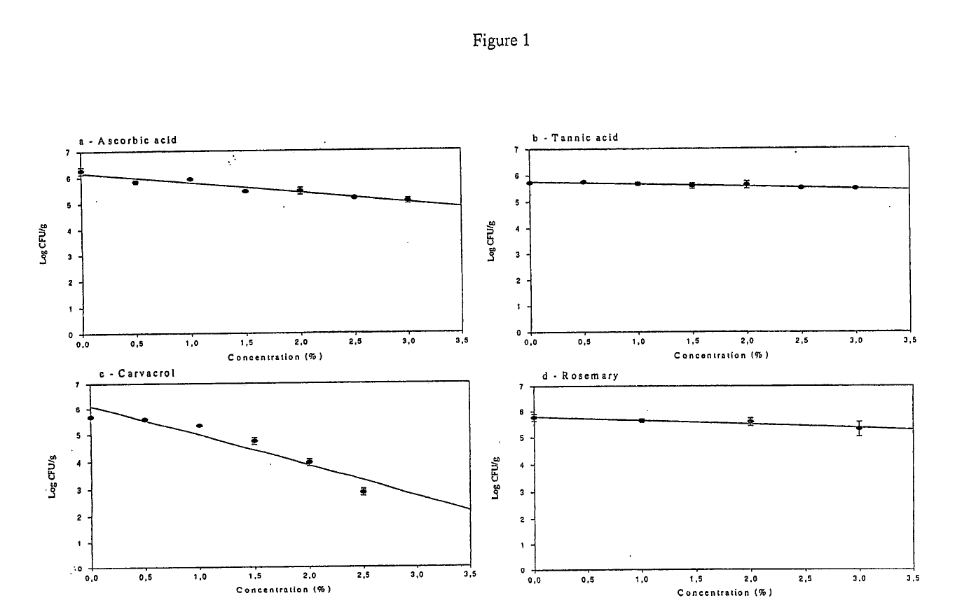

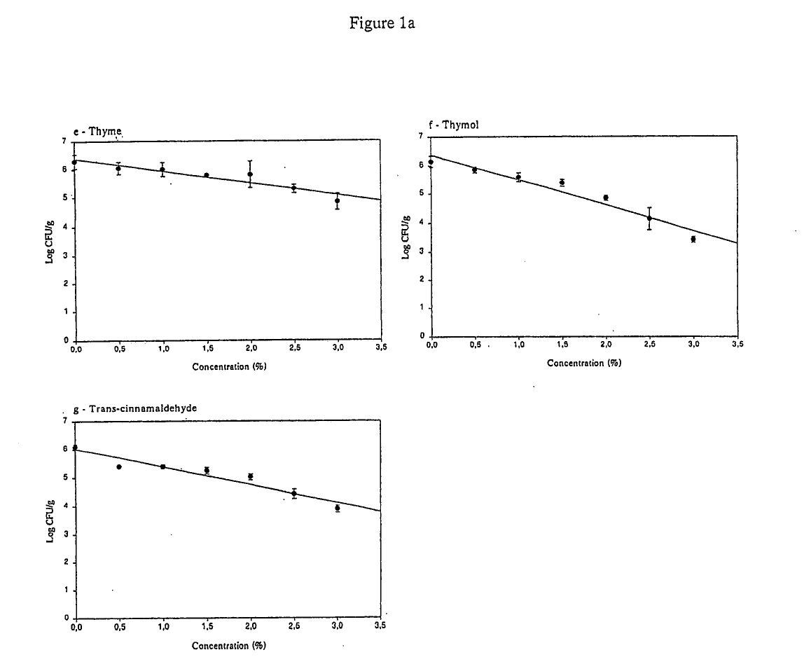

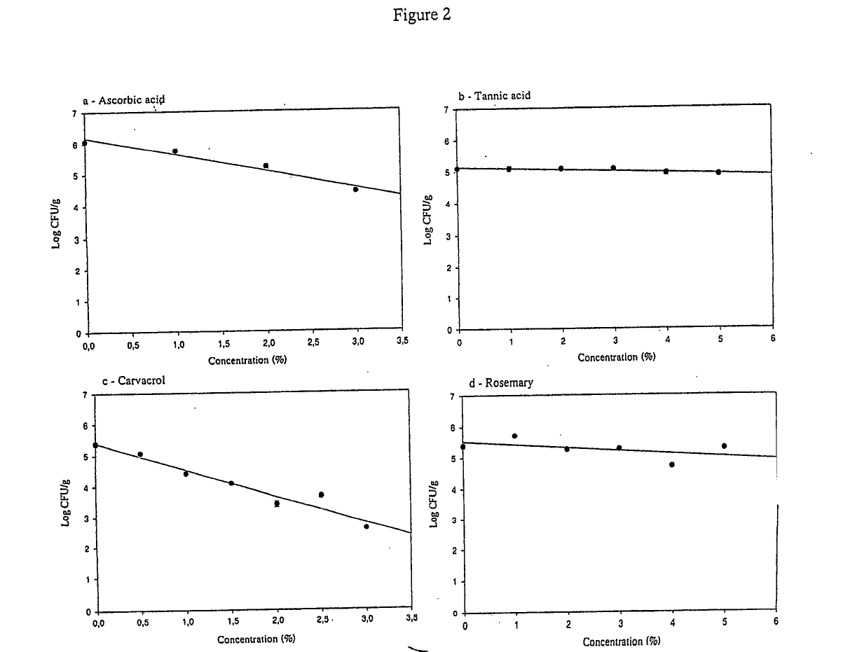

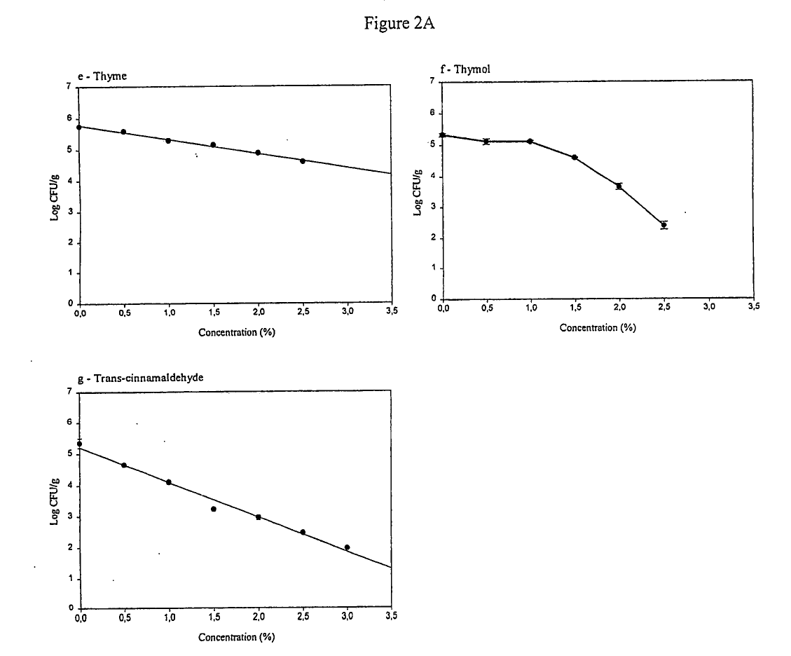

Table 1 and FIGS. 1 and 2 show the relative sensitivity of E. coli and S. typhi to the active compounds under study. Results are expressed in term of D₁₀ (%) or active compound concentration needed to reduce the total bacterial population by 1 log. The active compounds with the highest inhibitory effect on E. coli were carvacrol, thymol, trans-cinnamaldehyde and thyme, with MIC values of 0.88%, 1.14%, 1.57% and 2.33% respectively. These active compounds were followed by ascorbic acid, with a concentration of 2.71%. The inhibitory effect of ascorbic acid was not significantly different (p>0.05) from trans-cinnamaldehyde and thyme. The addition of rosemary and tannic acid had the least inhibitory effect on E. coli, with MIC values of 10.37% and 11.15% respectively.

Results obtained with S. typhi were slightly different then those obtained with E. coli. With S. typhi, the active compounds with the highest inhibitory effect were trans-cinnamaldehyde, carvacrol, thymol and ascorbic acid, with MIC values of 0.89%, 1.15%, 1.60% and 1.83% respectively. Thyme followed with a MIC value of 2.75%. No significant difference (p>0.05) was observed between thymol, ascorbic acid and thyme. The addition of tannic acid and rosemary had the least inhibitory effect on S. typhi. For those active compounds, the MIC values were 13.56% and 21.18%.

From these results, carvacrol, thyme, thymol and trans-cinnamaldehyde were selected for further testing in conjunction with irradiation to determine their effect on the sensitivity of E. coli and S. typhi in ground beef.

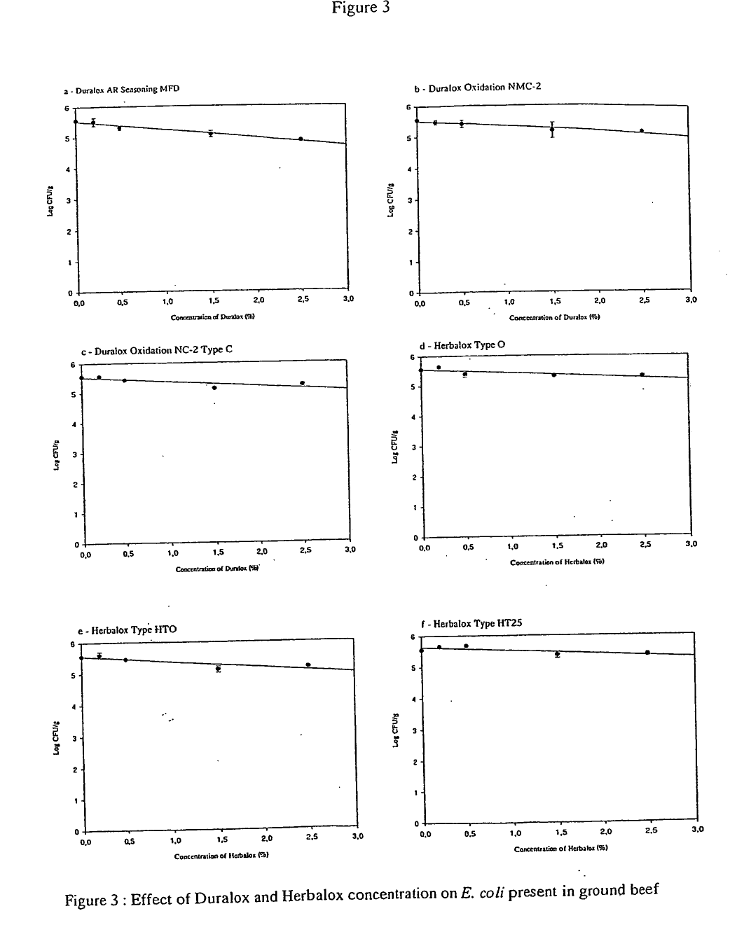

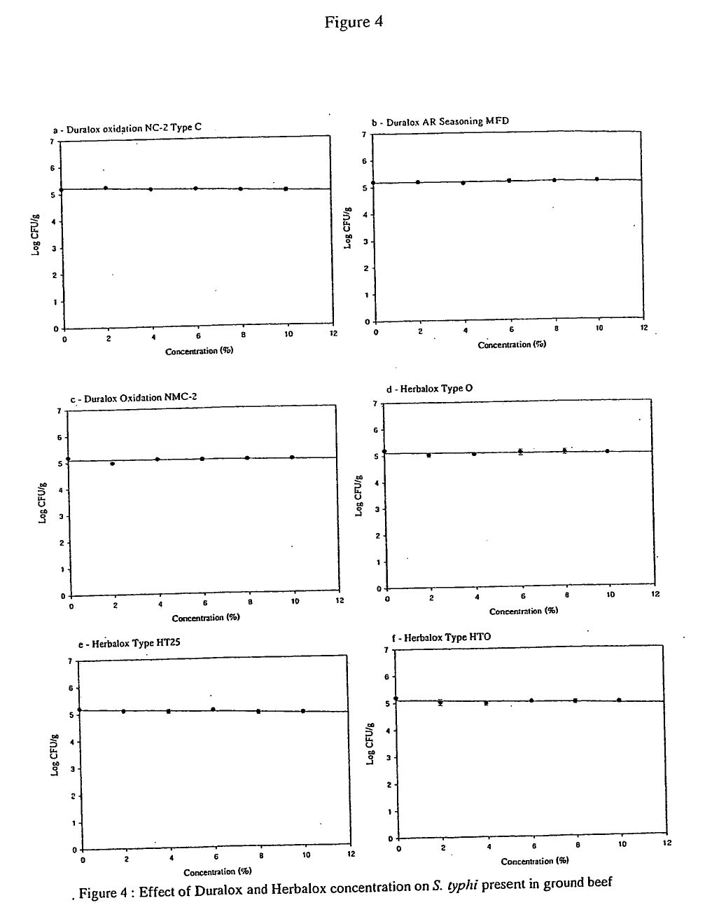

In addition to the above compounds, minimal concentrations of different types of commercial Herbalox® and Duralox® required to reduce by 1 log the bacterial population of E. coli in ground beef were evaluated. Results are summarised in Table 2 and FIGS. 3 and 4. As shown in FIGS. 3 and 4, the concentration used to determine the minimal concentration were not enough to produce 1 log reduction. However, an estimation of the minimal concentration was calculated using the slope of the curve.

As shown in Table 2, of the six products tested, the best result was obtained for Duralox® AR Seasoning MFD which showed an antimicrobial effect on E. coli at a minimal concentration of 3.06%. Herbalox® Type O and Herbalox® Type HT25 had the lowest antimicrobial effect, with the minimal concentration needed to reduce by 1 log the population of E. coli being 8.21% and 8.70%, respectively. These results demonstrate that the rosemary extract used for the above experiment, with a MIC value of 10.37%, is less efficient in reducing E. coli in ground beef than the commercial version of rosemary, Duralox® and Herbalox®.

As shown in Table 2, both Duralox® and Herbalox® have a poor antimicrobial effect on S. typhi. Previous experiments with a rosemary extract showed an MIC of 13.56% indicating that the extract was more efficient than the present commercial version of the product.

The above data regarding Duralox® and Herbalox® indicate that addition of the commercial products to ground beef is less efficient than the other active compounds, such as carvacrol, thymol, trans-cinnamaldehyde, thyme and ascorbic acid in reducing E. coli and S. typhi populations.

1.2 Irradiation Sensitivity of E. coli and S. typhi in the Presence of Various Active Compounds

Ground beef samples weighing 450 g were contaminated with working cultures of E. coli or S. typhi to obtain a final concentration of 10⁵ CFU/g. The ground beef samples containing micro-organisms was mixed during 3 min at medium speed in a 4L-commercial blender (Waring Products, New Hartford, Col., USA) and the appropriate concentration of each active compound were incorporated, followed by another 3 min period mixing. Ground beef samples containing micro-organisms and active compounds was filled in sterile petri plates (60×15 mm) in portion of 25 g each and stored at 4° C. until irradiation treatment (approximately 15 h).

Escherichia coli

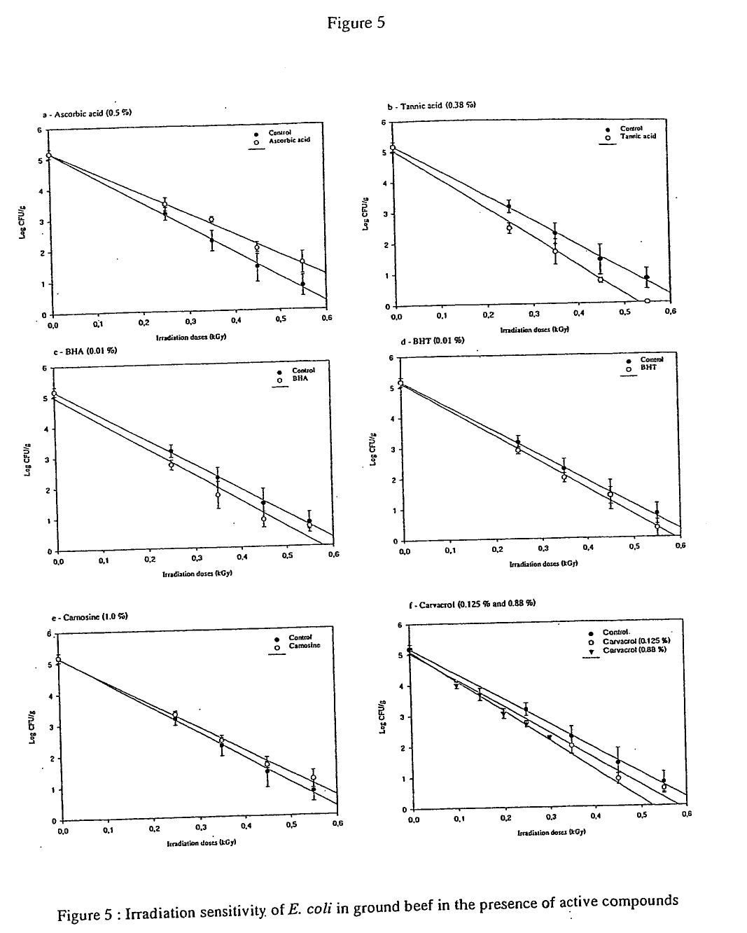

Table 3 and FIG. 5 show the irradiation sensitivity of E. coli in ground beef in the presence of various active compounds. As shown in Table 3, the irradiation sensitivity of E. coli in the absence of any added compounds was 0.126 kGy. The results show that the addition of most active compounds had an effect on the irradiation sensitivity of E. coli. The most effective active compounds were those with the concentration corresponding to the MIC in the ground beef. The addition of trans-cinnamaldehyde (1.5%) significantly reduced (p≦0.05) the D₁₀, from 0.126 kGy to 0.037 kGy, indicating a substantial increase in irradiation sensitivity of E. coli (i.e. 70.6%). This was followed by thymol (1.15%), thyme (2.33%) and carvacrol (0.88%) with D₁₀ values of 0.087 kGy, 0.090 kGy and 0.103 kGy, respectively. The increased sensitivity to irradiation in the presence of these active compounds was 40.0%, 28.6% and 18.2%, respectively.

Even at lower concentration, some of the active compounds also significantly increased p≦0.05) the irradiation sensitivity of E. coli. These active compounds were thymol (0.1%); tannic acid; rosemary; BHT; trans-cinnamaldehyde (0.025%); carvacrol (0.125%); thyme (0.2%); BHLA; nisin and nisin +EDTA. D₁₀ values ranged from 0.103 kGy to 0.121 kGy. Addition of these active compounds increased the sensitivity of E. coli to irradiation between 18.2% and 4.0% (Table 3). The addition of EDTA, tetrasodium pyrophosphate and camosine had no significant effect (p>0.05) on the irradiation sensitivity of E. coli. The D₁₀ values were 0.127 kGy, 0.131 kGy and 0.133 kGy respectively. Only one active compound significantly. decreased (p≦0.05) the irradiation sensitivity. The addition of ascorbic acid had a protective effect of 11.9%, with a D₁₀ of 0.141 kGy.

The above results indicate that addition of most of the active compounds tested decreased the irradiation dose necessary to eliminate completely E. coli from ground beef compared to irradiation alone. Addition of the nine of the active compounds (trans-cinnamaldehyde, thymol, carvacrol, thyme, tannic acid, rosemary, BHT, BHA, nisin and nisin+EDTA) to ground beef reduced the irradiation dose necessary to completely eliminate E. coli by a factor of 3.5 to 1.2. Of these, trans-cinnamaldehyde (1.5%) was the most effective, which increased the irradiation sensitivity by 70.6%. Three active compounds tested (EDTA, tetrasodium pyrophosphate and camosine) had no effect on E. coli. Only ascorbic acid resulted in an increase in the irradiation resistance of E. coli.

Salmonella typhi

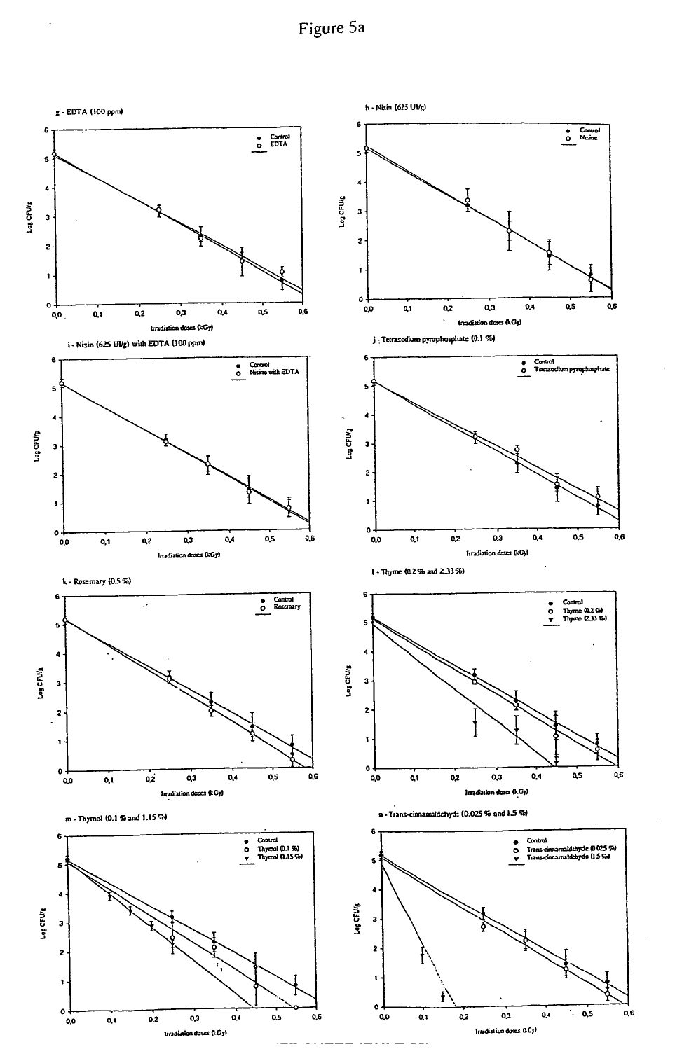

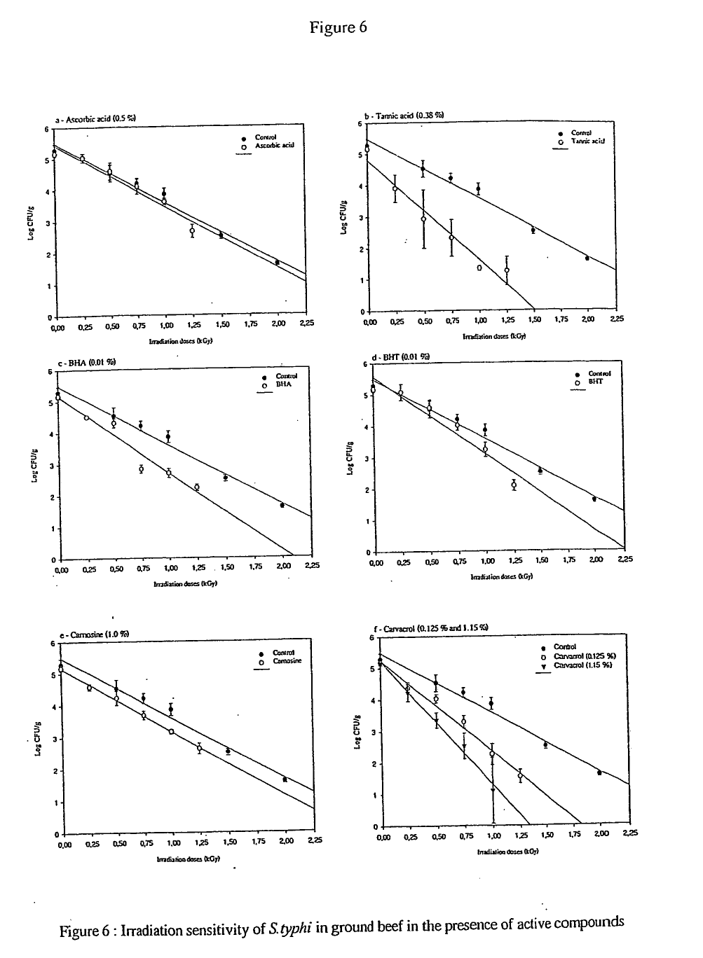

Table 4 and FIG. 6 show the irradiation sensitivity of S. typhi in ground beef in the presence of various active compounds. The D₁₀ value of the control was 0.526 kGy. Except for ascorbic acid, all the active compounds tested increased the irradiation sensitivity of S. typhi, with D₁₀ values varying from 0.139 to 0.494 kGy. The most effective active compounds were those with the concentration corresponding to the MIC in ground beef. The addition of trans-cinnamaldehyde (0.89%), carvacrol (1.15%), thymol (1.6%) and thyme (2.75%) to ground beef significantly increased (p≦0.05) the irradiation sensitivity, with D₁₀ value of 0.139 kGy, 0.208 kGy, 0.210 kGy and 0.260 kGy respectively. Treatment with these active compounds increased the irradiation sensitivity of S. typhi by 73.6%, 60.4%, 60.1% and 50.6%, respectively.

The D₁₀ value for tannic acid was evaluated at 0.302 kGy, which represents an increase in sensitivity of 42.6%. The addition of the mixture of nisin and EDTA, carvacrol (0.125%), tetrasodium pyrophosphate and trans-cinnamaldehyde also significantly increased (p≦0.05) the irradiation sensitivity of S. typhi with D₁₀ values of 0.340 kGy, 0.343 kGy, 0.356 kGy and 0.356 kGy, respectively. These values represent an increase in irradiation sensitivity ranging from 35.4% to 32.3%. For BHT, BHA, EDTA and nisin, the D₁₀ values were evaluated at 0.405 kGy, 0.407 kGy, 0.419 kGy and 0.420 kGy, respectively, representing an increase in sensitivity in the presence of these active compounds from 23.0% to 20.2%. The addition of rosemary was just as efficient as EDTA and nisin. The D₁₀ value was 0.436 kGy, representing an increase in sensitivity of 17.1%. Finally, the addition of carnosine helped to increase the irradiation sensitivity by only 6.1%, with a D₁₀ value of 0.494 kGy.

Lower concentrations of some of the compounds were also effective. Thymol, at a lower concentration of 0.1%, was just as efficient as tetrasodium pyrophosphate and trans-cinnamaldehyde (0.025%). The D₁₀ was 0.362 kGy, representing an increase in sensitivity of 31.2%. At a lower concentration of 0.2%, the addition of thyme also increased the irradiation sensitivity of the bacteria by 26.6% with a D₁₀ value of 0.386 kGy.

Combinations of the active compounds were also effective. When combining nisin (625 UI/g) with EDTA (100 ppm), the D₁₀ value was reduced to 0.34 kGy, representing an increase in irradiation sensitivity of 35.4% compared to 20.3% for EDTA (100 ppm) alone and 20.2% for nisin (625 UI/g) alone. The D₁₀ value was 0.436 kGy, representing an increase in sensitivity of 17.1%. Only one active compound had no significant effect (p>0.05) on the irradiation sensitivity of S. typhi. The addition of ascorbic acid (0.5%) to the ground beef did not affect the D₁₀ value, which was 0.521 kGy.

The addition of most of the active compounds to the ground beef reduced the irradiation dose necessary to completely eliminate S. typhi. In the absence of active compounds, a dose of 2.9 kGy was necessary to completely eliminate S. typhi present in ground beef. In the presence of trans-cinnamaldehyde, carvacrol, thymol and thyme, at concentrations of 0.89%, 1.15%, 1.6% and 2.75% respectively, the bacteria were completely eliminated at doses ranging from 0.75 kGy to 1.55 kGy. For the other active compounds tested, the irradiation doses necessary to completely eliminate S. typhi from the ground beef ranged from 1.5 kGy to 2.6 kGy.

Thus, addition of these active compounds to ground beef reduced the irradiation dose necessary to completely eliminate S. typhi by a factor of between 3.9 and 1.1. Among the active compounds tested, trans-cinnamaldehyde (1.5%) was the most effective, resulting in an increase in irradiation sensitivity of 73.6%. Only ascorbic acid had no effect on S. typhi.

Comparison of the results obtained with E. coli and S. typhi indicates that, in general, S. typhi is more resistant to irradiation. The D₁₀ values for E. coli and S. typhi were 0.126 kGy and 0.526 kGy respectively in the absence of active compounds. The addition of the various active compounds tested affected the sensitivity of both bacteria to irradiation. The addition of carvacrol, thyme, thymol and trans-cinnamaldehyde at the respective MIC in ground beef was more efficient in increasing the irradiation sensitivity of E. coli and S. typhi than at the MIC in broth, indicating that the concentration of the active compounds was proportional to the increase in sensitivity. However, the increase in sensitivity was greater with S. typhi than with E. coli.

1.3 Determination of the Effect of Various Concentrations of Carvacrol on E. coli and S. typhi

The effect of various concentrations of carvacrol in irradiated ground beef was evaluated in order to determine if lower concentrations of carvacrol could also increase the irradiation sensitivity of E. coli and S. typhi in ground beef. For these experiments, sterile ground beef was contaminated with either E. coli or S. typhi to a final concentration of 10⁵ CFU/g. Various concentrations of carvacrol ranging from 0 to 2.0% were added to the ground beef samples and transferred in portions of 25 g each to sterile petri plates (60×15 nmu) then stored at 4° C. until irradiation treatment (approximately 15 h).

Escherichia coli

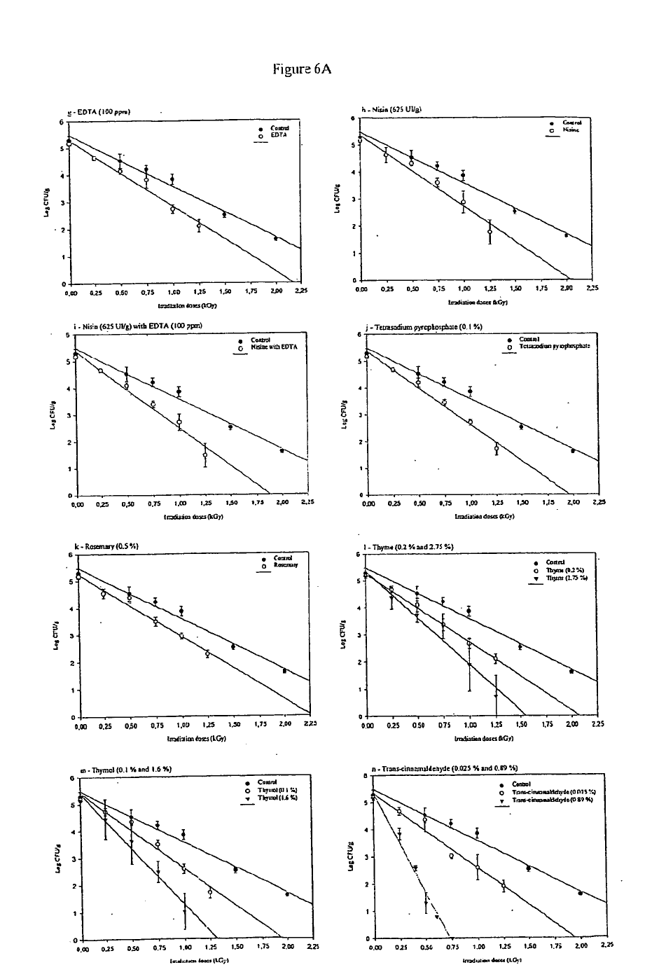

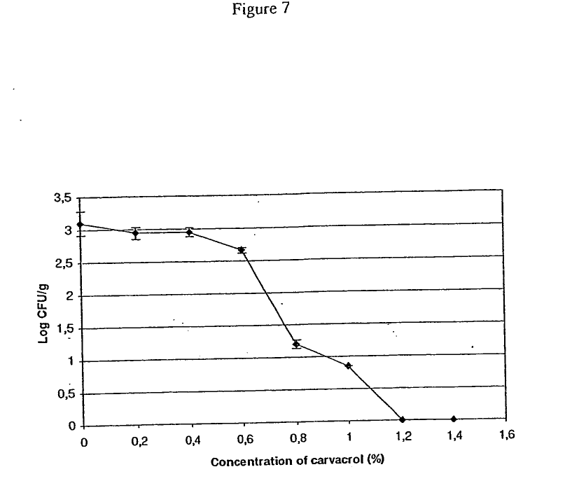

Table 5 and FIG. 7 show the influence of various concentrations of carvacrol (0 to 1.4%) on the survival level of E. coli after irradiation at 0.25 kGy. The addition of 0.2% of carvacrol significantly reduced (p≦0.05) the bacterial population from 3.098 CFU/g to 2.948 CFU/g. Results also showed that the bacterial population of E. coli was significantly reduced (p≦0.05) as the concentration of carvacrol was increased. However, no significant difference (p>0.05) between concentrations of 0.2% and 0.4% of carvacrol was observed, with a bacterial population of 2.948 CFU/g for both concentrations. The increase in sensitivity to irradiation observed for both concentrations was 4.8%. As shown in FIG. 7, a significant decrease (p≦0.05) in the bacterial population (about 1.5 log reduction) was observed when the concentration of carvacrol increased from 0.6% to 0.8%. The concentration of E. coli in ground beef went from 2.660 CFU/g to 1.198 CFU/g. The sensitivity to irradiation increased from 14.1% at 0.6% of carvacrol to 61.3% at 0.8% of carvacrol. At a carvacrol concentration of 1.2%, E. coli was completely eliminated after irradiation at 0.25 kGy (an irradiation sensitivity of 100%).

Salmonella typhi

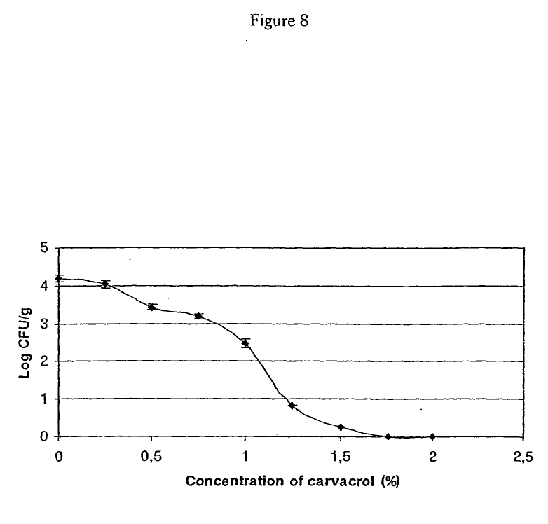

Table 6 and FIG. 8 show the effect of various concentrations of carvacrol (0 to 2.0%) on the survival level of S. typhi after irradiation at 0.5 kGy. In the absence of carvacrol, the concentration of S. typhi was 4.170 CFU/g after irradiation. The addition of 0.25% of carvacrol to ground beef had no significant effect (p>0.05) on the irradiation sensitivity of S. typhi, with a bacterial population of 4.106 CFU/g. At this concentration, the sensitivity of S. typhi to irradiation was increased by only 1.5%. However, a significant effect (p≦0.05) was observed when carvacrol was added at concentrations higher than 0.5%. After treatment with 0.5% carvacrol, the concentration of S. typhi in ground beef was 3.526 CFU/g. The concentration of S. typhi continued to decrease significantly (p≦0.05) with the addition of 0.75%, 1.0%, 1.25% and 1.5% carvacrol, resulting in bacterial counts of 3.192 CFU/g, 2.545 CFU/g, 0.831 CFU/g and 0.264 CFU/g respectively. The sensitivity to irradiation increased from 15.4 to 93.7% when the concentration of carvacrol increased from 0.5% to 1.5%. The largest increase in sensitivity was observed when the concentration of carvacrol passed from 0.75% (sensitivity 39.0%) to 1.25% (sensitivity 79.9%). At a carvacrol concentration of 1.75%, S. typhi was completely eliminated from the irradiated (0.5 kGy) ground beef (sensitivity of 100%).

1.4 Deteimination of the Best Combination of Active Compounds to Increase the Irradiation Sensitivity of E. coli and S. typhi

Using the results obtained in the previous section, the active compounds selected to determine the best combination for treatment of ground beef were carvacrol (1.0%), ascorbic acid (0.5%) and tetrasodium pyrophosphate (0.1%). Carvacrol was selected for its ability to increase irradiation sensitivity of E. coli and S. typhi, ascorbic acid for its ability to maintain the colour of the ground beef during irradiation and tetrasodiun pyrophosphate for its ability to maintain the taste of the ground beef during irradiation. The, combinations tested were: i) carvacrol, ii) carvacrol and ascorbic acid, iii) carvacrol and tetrasodium pyrophosphate and iv) carvacrol, ascorbic acid and tetrasodium pyrophosphate. Since the concentration of carvacrol used was different for both bacteria, one concentration of 1.0% was selected for use in these experiments.

Samples of ground beef were prepared with the different combination of active compounds as described in the previous sections.

Escherichia coli

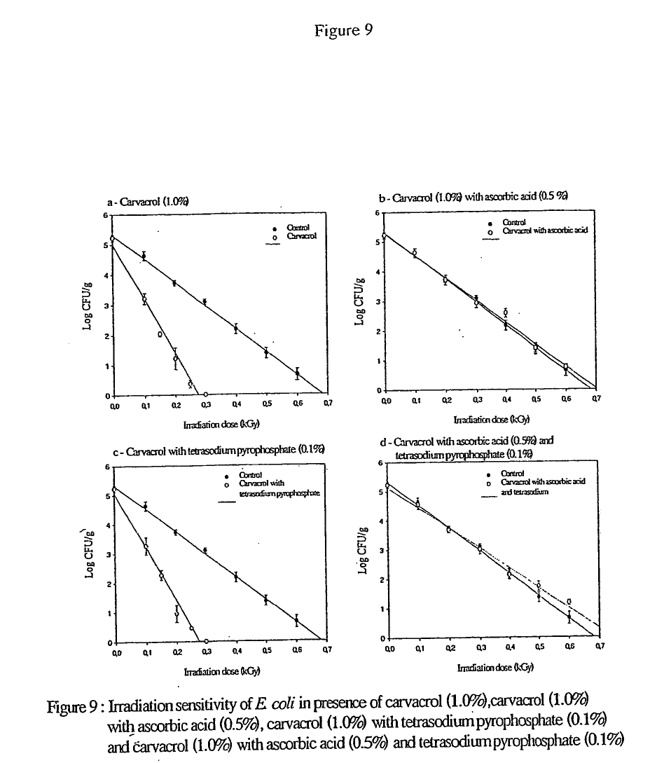

Table 7 and FIG. 9 show the irradiation sensitivity of E. coli in ground beef in the presence of various combinations of active compounds. The irradiation sensitivity of E. coli was 0.126 kGy in the absence of any active compounds. Of the combinations tested, carvacrol and the mixture of carvacrol and tetrasodium pyrophosphate were the most efficient, both significantly reduced (p≦0.05) the D₁₀ value from 0.126 kGy to 0.057 kGy, representing an increase in the irradiation sensitivity of 55.5%. In contrast, addition of the mixture of carvacrol and ascorbic acid had no significant effect (p>0.05) on the irradiation sensitivity of E. coli (D₁₀ value of 0.133 kGy), and the mixture of carvacrol, ascorbic acid and tetrasodium pyrophosphate significantly increased (p≦0.05) the D₁₀ value to 0.142 kGy, indication that this combination of active compounds exerted a protective effect of 10.9% on E. coli.

As shown in FIG. 9, an irradiation dose of 0.7 kGy was necessary to completely eliminate E. coli in the absence of active compounds. In the presence of the mixture of carvacrol and ascorbic acid, a dose of 0.7 kGy was also necessary to completely eliminate E. coli from ground beef. When carvacrol and the mixture of carvacrol and tetrasodium pyrophosphate were added to the ground beef, the irradiation dose necessary to eliminate completely E. coli was reduced to 0.3 kGy. The dose, however, increased to 0.75 kGy, when the mixture of carvacrol, ascorbic acid and tetrasodium pyrophosphate was added to the ground beef.

These results demonstrate that addition of carvacrol and the mixture of carvacrol and tetrasodium pyrophosphate to ground beef were the most efficient in decreasing the D₁₀ value. The irradiation sensitivity of E. coli was increased by 55.5% and the irradiation dose necessary to completely eliminate E. coli in the presence of these active compounds was 2.3 times lower than in the absence of active compounds.

Salmonella typhi

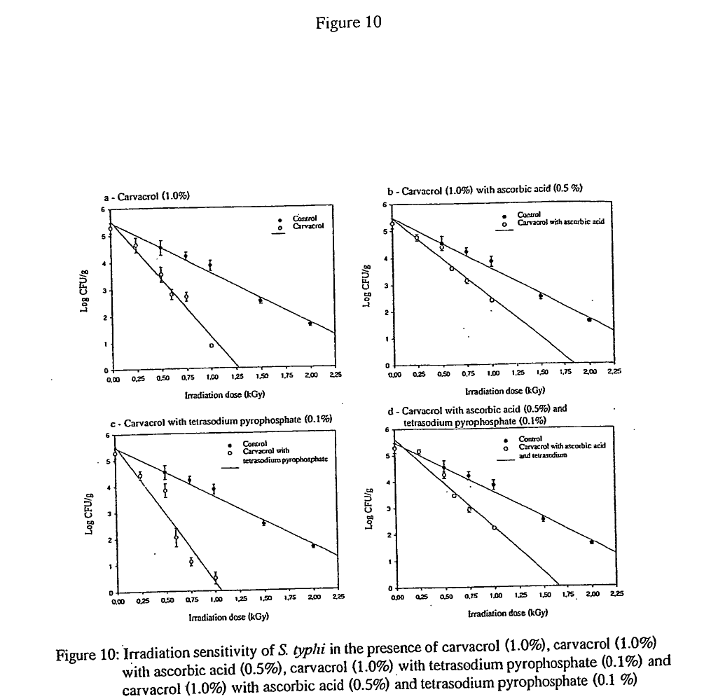

Table 8 and FIG. 10 show the irradiation sensitivity of S. typhi in ground beef in the presence of various combinations of active compounds. The irradiation sensitivity of S. typhi was 0.526 kGy in the absence of active compounds. All of the combinations tested significantly increased (p≦0.05) the irradiation sensitivity of S. typhi. The most efficient were carvacrol alone and the mixture of carvacrol and tetrasodium pyrophosphate, with D₁₀ values of 0.235 kGy and 0.254 kGy, respectively. The mixture of carvacrol, ascorbic acid and tetrasodium pyrophosphate was the third most effective combination, with a D₁₀ value of 0.313 kGy, followed by the mixture of carvacrol and ascorbic acid, with a D₁₀ of 0.344 kGy. The increase in irradiation sensitivity observed upon treatment with these combinations ranged from 54.7% to 33.7%.

As shown in FIG. 10, 10^{1.2} CFU/g of S. typhi were observed when samples without active compounds were treated with an irradiation dose of 2.25 kGy. When carvacrol and the mixture of carvacrol and tetrasodium pyrophosphate were added to the ground beef, a complete elimination of S. typhi was observed at doses of 1.25 kGy and 1.0 kGy, respectively. With the addition of the mixture of carvacrol and ascorbic acid and the mixture of carvacrol, ascorbic acid and tetrasodium pyrophosphate, the irradiation dose required to eliminate S. typhi from ground beef was 1.5 kGy and 1.7 kGy, respectively. These results indicate that addition of the mixture of carvacrol and tetrasodium pyrophosphate to ground beef reduced the irradiation dose necessary to eliminate S. typhi by a factor of 2.5.

1.5 Influence of Atmosphere On the Irradiation Sensitivity of E. coli and S. typhi

The combination of carvacrol and tetrasodium pyrophosphate was used to determine the irradiation sensitivity of E. coli and S. typhi under various atmospheres. Samples of ground beef were prepared with the combination of active compounds as described in the previous section. One modification was made in the packaging of the meat. Ground beef samples containing micro-organisms and active compounds were packed in portion of 25 g each in 0.5 mil metalized polyester/2 mil EVA copolymer bag (205 mm×355 mm, WINPACK, St-Léonard, Québec). The bags were sealed: i) under vacuum, ii) under air: 78.1% N₂-20.9% O₂-0.036% CO₂, iii) under 100% CO₂, or iv) under modified atmosphere packaging (MAP) conditions: 60% O₂-30% CO₂-10% N₂. The bags were stored at 4° C. until irradiation treatment (approximately 15 h).

Eschericia coli

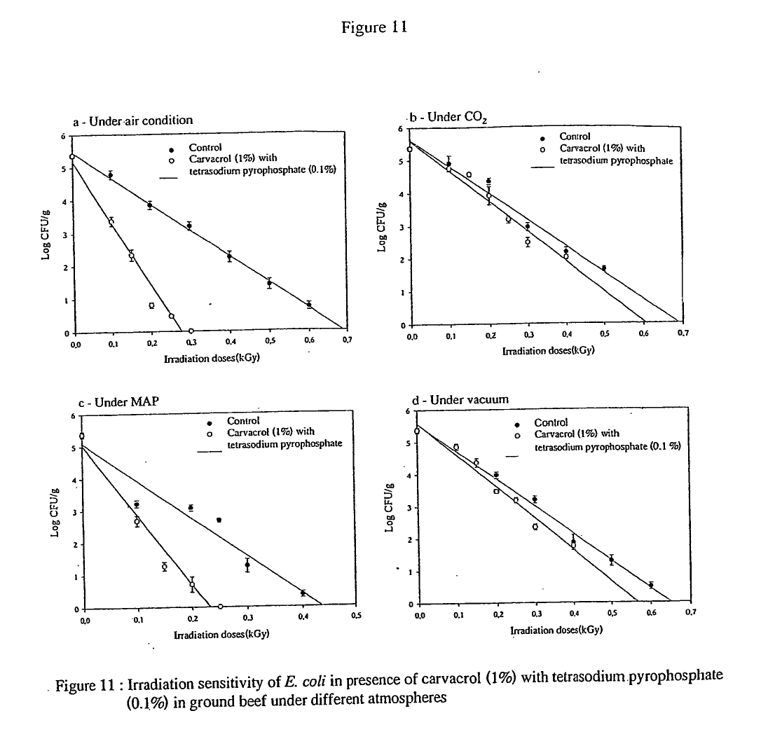

Tables 9 and 10 and FIG. 11 show the irradiation sensitivity (D₁₀) of E. coli in ground beef under various atmospheres (air, CO₂ and MAP and vacuum packaging). In general, the addition of the active compounds to the samples increased the irradiation sensitivity of E. coli, regardless of atmosphere. The results indicate that MAP conditions had the greatest inhibitory effect on E. coli with a D₁₀ of 0.086 kGy, which was significantly different from all other atmospheres tested (p≦0.05). MAP conditions increased the irradiation sensitivity of E. coli by 37.7%. When carvacrol and tetrasodium pyrophosphate were added to the ground beef packed under MAP conditions, the D₁₀ value was 0.046 kGy, which represents an increase in sensitivity of 46.5%. In this case, the irradiation sensitivity was 16.4% greater than for samples packed under air in the presence of active compounds (D₁₀ of 0.055 kGy).

When ground beef was packed under a CO₂ atmosphere, the D₁₀ observed was 0.123 kGy. No significant difference (p>0.05) was observed in irradiation sensitivity of the ground beef packed under CO₂, under air or under vacuum, where the D₁₀ values were evaluated at 0.123 kGy, 0.126 kGy and 0.118 kGy respectively. In this case, the influence of the atmosphere was only 2.4%. When carvacrol and tetrasodium pyrophosphate were added to samples treated under CO₂, there was a decrease in the irradiation sensitivity. The D₁₀ value decreased from 0.123 kGy to 0.106 kGy, representing an increase in sensitivity to irradiation of 13.8%.

When samples were packed under air, the D₁₀ value for E. coli was 0.126 kGy. However, when carvacrol and tetrasodium pyrophosphate were present in the ground beef, a significant increase in the irradiation sensitivity (p≦0.05) of E. coli was observed (56.3%), with a D₁₀ of 0.055 kGy.

Under vacuum conditions, the D₁₀ value of E. coli was 0.118 kGy. A significant increase in irradiation sensitivity (p≦0.05) was observed compared to air packed ground beef, where the D₁₀ value was 0.126 kGy, representing an increase in sensitivity to irradiation of 6.3%. The D₁₀ value was significantly lower (p≦0.05) with the addition of carvacrol and tetrasodium pyrophosphate (0.101 key), representing an increase in irradiation sensitivity of 14.4%. In presence of the active compounds, E. coli was more resistant under vacuum than under air condition, with a decrease in irradiation sensitivity of 83.6%.

Thus, the combination of active compounds and packaging atmosphere can be seen to affect the irradiation dose necessaiy to eliminate E. coli in ground beef. Under air, the required dose was 0.7 kGy in the absence of active compounds and 0.3 kGy in the presence of active compounds. When ground beef was packed under MAP conditions, the required dose was reduced to 0.45 kGy in the absence of active compounds and to 0.25 kGy in the presence of active compounds. These values represent a reduction in dose by a factor of 1.5 and 1.2 respectively compared to the values under air. Under vacuum, the reduction was not as great as that observed using MAP conditions in the absence of active compounds, and when active compounds were added, there was an increase in the dose necessary to eliminate E. coli. Finally, under CO₂, the irradiation dose needed to eliminate E. coli was identical to that under air (0.7 kGy). When active compounds were added, the required irradiation dose doubled compared to under air, from 0.3 kGy to 0.6 kGy.

In the absence of active compounds, therefore, the most effective treatment was the use of MAP conditions (increase in irradiation sensitivity of 37.7%), followed by vacuum conditions (increase in sensitivity of 6.3%) and CO₂ (increase in sensitivity of 2.4%), compared to packaging under normal air conditions. In the presence of the active compounds, the most effective treatment was also the use of MAP conditions (increase in sensitivity of 16.4%). In contrast, a protective effect was observed under vacuum and under CO₂ (protective effects of 83.6% and 92.7%, respectively.

Salmonella typhi

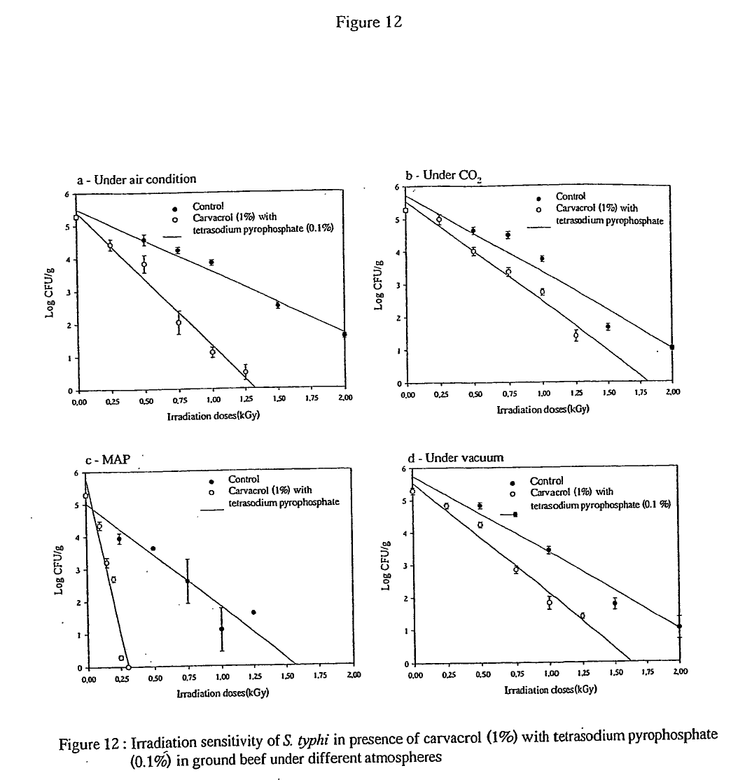

Tables 11 and 12 and FIG. 12 show the irradiation sensitivity (D₁₀) of S. typhi in ground beef under various atmospheres (air, CO₂, MAP and vacuum packaging). The most significant inhibitory effect during irradiation was observed under MAP conditions with a D₁₀ value of 0.221 kGy, which was significantly lower (p≦0.05) than that for ground beef packed under air (0.526 kGy), under CO₂ (0.420 kGy) and under vacuum (0.429 kGy). MAP conditions increased the irradiation sensitivity of S. typhi by 58.0% compared to the air packed ground beef. In the presence of carvacrol and tetrasodium pyrophosphate, ground beef packed under MAP conditions showed a reduction in the D₁₀ value for S. typhi to 0.053 kGy (i.e. an increase in sensitivity to irradiation of 76.0%). The combination of the active compounds with the MAP conditions increased the irradiation sensitivity by 79.1%.

When packed under air conditions, the D₁₀ value was 0.526 kGy and this value was significantly higher (p≦0.05) than all the other atmospheres tested for S. typhi. When carvacrol and tetrasodium pyrophosphate were added to the ground beef, the sensitivity of S. typhi increased showing a D₁₀ of 0.254 kGy, which represents an increase in sensitivity of 51.7%.

When ground beef was packed under CO₂ atmosphere, the D₁₀ value observed for S. typhi was 0.420 kGy. This value was similar to the value obtained using vacuum packaging. As compared to air conditions, the CO₂ atmosphere resulted in an increase of irradiation sensitivity of 18.4% (0.526 kGy vs. 0.420 kGy). When carvacrol and tetrasodium pyrophosphate were added under 100% CO₂, an increase of the irradiation sensitivity was observed, with a D₁₀ value of 0.336 kGy. Compared with the ground beef packed under air and in presence of active compounds, there was a decrease of 32.3% in irradiation sensitivity indicating that the CO₂ atmosphere protects S. typhi in the presence of carvacrol and tetrasodium pyrophosphate. Even with this protective effect, however, the addition of the active compounds affected the irradiation sensitivity of S. typhi with an increase in sensitivity of 20.0% when compared to CO₂ alone.

Under vacuum, the D₁₀ value observed for S. typhi was 0.429 kGy, cornpared to 0.526 kGy under air conditions, representing an increase the irradiation sensitivity of S. typhi of 18.4%. The D₁₀ value for S. typhi in ground beef treated with carvacrol and tetrasodium pyrophosphate and packed under vacuum was 0.308 kGy, which was significantly lower (p≦0.05) than the D₁₀ value for S. typhi under the same conditions in the absence of active compounds. This treatment increased the sensitivity of S. typhi to irradiation by 28.2%. In the presence of carvacrol and tetrasodium pyrophosphate, S. typhi was 21.2% more resistant to irradiation under vacuum than under air in the presence of the same active compounds. The D₁₀ values were 0.308 kGy and 0.254 kGy respectively. Vacuum packaging, therefore, appears to protect S. typhi during irradiation.

The results obtained from this experiment indicate that the best irradiation sensitivity of S. typhi was achieved under MAP conditions, with a D₁₀ value of 0.221 kGy compared to 0.526 kGy under air, representing an increase in irradiation sensitivity of 58.0%. This was followed by CO₂ atmosphere (0.420 kGy), with an increase in sensitivity of 20.2%, vacuum (0.429 kGy), with an increase in sensitivity of 18.4% and air packed samples (0.526 kGy).

The combination of active compounds and packaging atmosphere affected the irradiation dose required to eliminate S. typhi in ground beef Under air, at an irradiation dose of 2.0 kGy, 1.5 log of bacteria remained in the ground beef. With the addition of active compounds, a dose of 1.3 kGy was needed to eliminate the bacteria. When ground beef was packed under MAP conditions, the dose was 1.55 kGy without active compounds and 0.25 kGy with active compounds. This value represents a reduction in dose by a factor of 5.2 compared to under air with active compounds. Under CO₂ and under vacuum, the reduction in required dose was not as great as under MAP conditions with or without active compounds. Without active compounds, a concentration of 1 log of bacteria was still present in the ground beef after an irradiation treatment of 2 kGy. When the active compounds were added, the irradiation dose went from 1.3 kGy under air to 1.8 kGy under CO₂ and to 1.6 kGy under vacuum. These doses represent an increase by a factor of 1.4 and 1.2 respectively.

In the presence of the active compounds, the most effective treatment was under MAP conditions with a D₁₀ value of 0.053 kGy, compared to under air (D₁₀ of 0.254 kGy), representing an increase in sensitivity of 79.1%. Ground beef in the presence of active compounds under air demonstrated a D₁₀ value of 0.254 kGy, whereas treatment under vacuum or under CO₂ showed a protective effect on S. typhi of 83.6% and 92.7% respectively (D₁₀ values of 0.308 kGy and 0.336 kGy).

Table 13 shows the results of the variance analysis on the significance of simple and combined effect of the addition of the mixture of active compounds (carvacrol with tetrasodium pyrophosphate) with packaging conditions on the irradiation sensitivity of E. coli and S. typhi. The results demonstrate that the addition of active compounds and the packaging atmosphere had a significant effect (p≦0.001) on the irradiation sensitivity of E. coli and S. typhi.

1.6 Influence of Temperature on the Irradiation Sensitivity of E. coli and S. typhi

The combination of carvacrol and tetrasodium pyrophosphate was used to determine the irradiation sensitivity of E. coli and S. typhi under frozen conditions. Irradiation treatment was conducted at pasteurisation temperature (4° C.) and sterilisation temperature (−80° C.). Samples of ground beef were prepared with the combination of active compounds as described in the previous section, except samples were stored at 4° C. or at −80° C. until irradiation treatment (approximately 15 h).

Escherichia coli

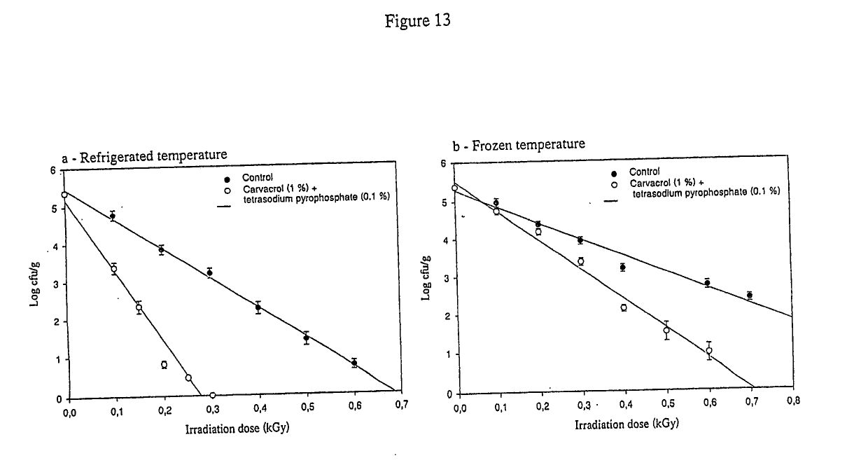

Table 14 and FIG. 13 show the irradiation sensitivity (D₁₀) of E. coli in ground beef treated with a mixture of carvacrol and tetrasodium pyrophosphate, packed under air and stored under refrigerated or frozen conditions. The D₁₀ value for E. coli under frozen conditions was 0.227 kGy, which was significantly higher (p <0.05) than under refrigerated conditions (D₁₀ value of 0.126 kGy). When the ground beef was treated with carvacrol and tetrasodium pyrophosphate, the irradiation sensitivity was also significantly higher (p≦0.05) under frozen conditions compared to refrigerated conditions, D₁₀ values of 0.128 kGy and 0.05 kGy respectively. However, the results suggest that the addition of the active compounds to the frozen samples helped to counteract the protective effect against irradiation treatment that the low temperature conditions demonstrated.

As shown in FIG. 13, 0.3 and 0.7 kGy were required to completely eliminate E. coli in the presence of active compounds at 4° C. and −80° C. respectively. Without active compounds, a complete elimination of E. coli was observed only at 0.7 kGy when samples were stored at 4° C. At −80° C., a presence of 10^{2.5} CFU/g was observed when samples were treated at 0.8 kGy. These result suggest that the addition of active compounds in ground beef was able to reduce the irradiation dose necessary to eliminate E. coli at 4° C. by a factor of 2.5.

Salmonella typhi

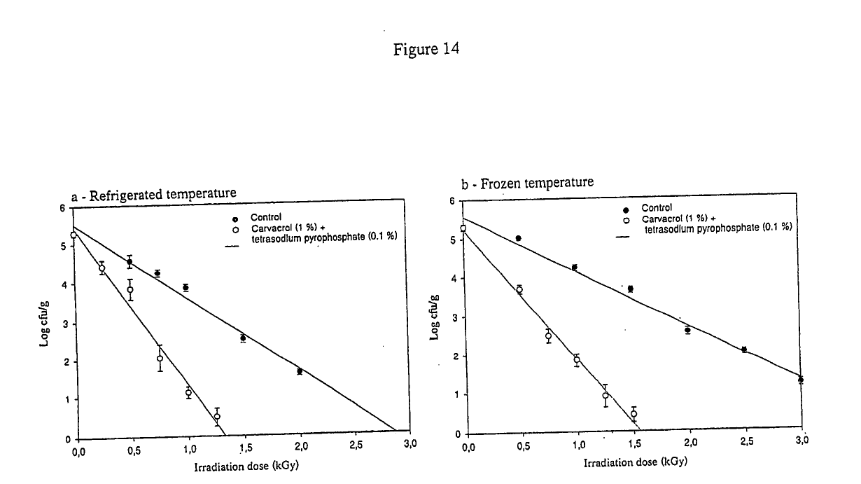

Table 14 and FIG. 14 show the irradiation sensitivity (D₁₀) of S. typhi in ground beef containing a mixture of carvacrol and tetrasodium pyrophosphate, packed under air and stored under refrigerated or frozen conditions. Treatment with the active compounds reduced the irradiation dose required to eliminate S. typhi from the meat. The D₁₀ values were reduced from 0.526 to 0.254 kGy at 4° C. and from 0.701 kGy to 0.297 kGy at −80° C. These results indicate that addition of active compounds increased the sensitivity of S. typhi by 51.7% at 4° C. and by 57.6% at −80° C. As shown in FIG. 14, complete elimination of S. typhi in the presence of active compounds was observed at around 1.3 kGy at 4° C. and at 1.5 kGy at −80° C. compared to around 2.8 kGy at 4° C. without active compounds. Without active compounds, 3 kGy was not sufficient to eliminate S. typhi in frozen ground beef.

1.7 Deterimination of Lipid Oxidation

Non-sterile ground beef was mixed under air conditions with carvacrol (1.0%), ascorbic acid (0.5%), tetrasodium pyrophosphate (0.1%), a mixture of carvacrol (1.0%) and ascorbic acid (0.5%), a mixture of carvacrol (1.0%) and tetrasodium pyrophosphate (0.1%) or with a mixture of carvacrol (1.0%), ascorbic acid (0.5%) and tetrasodium pyrophosphate (0.1%). The best combination in term of D₁₀ values (carvacrol (1.0%) and tetrasodium pyrophosphate (0.1%)) was also evaluated for TBARS content under various atmosphere (air (78.1% N₂-20.9% O₂-0.036% CO₂); 100% CO₂; MAP (60% O₂-30% CO₂-10% N₂) and under vacuum) at 4° C. and under frozen under air atmosphere (−80° C.). For each atmosphere and temperature combination, samples without active compounds were analysed as a control for each atmosphere. The ground beef was separated into two grounds. The first ground was for non-irradiated samples and the second ground was for irradiated samples (1 kGy). For each ground, three samples (25 g) of each combination were placed in small petri dishes for the samples under air and frozen condition or in 0.5 mil metalized polyester/2 mil EVA copolymer bag (205 mm×355 mm, WINPACK, St-Léonard, Québec) for samples under CO₂, MAP and vacuum condition.

Lipid oxidation was evaluated at day 1 of storage, just after irradiation treatment, by determining the TBARS (μM/g) content in the ground beef using a method basedon that described by Giroux (2000). First, 10 g of ground beef with 50 ml of H₂O treated by inverse osmosis was mixed for 2 minutes in a Stomacher (Lab Blender 400, Seward Medical UAC House, London, England. The mixture was combined with 10 ml TCA (10%), centrifuged for 10 minutes (3200 g) and filtered through Whatrnan #1 filter paper. The filtrate (8 ml) was incubated with 2 ml thiobarbituric acid (TBA-0.67%) in a water bath (80° C.) for 90 minutes.

The optical density was read at 532 nmn. TBARS was determined by reporting optical density of the samples on a standard curve. The standard curve was constructed as described by Lawlor et al. (2000) by determining the optical density (532 nm) of various concentrations (0 to 10 μM) of 1,1,3,3-tetraethoxypropane (TEP) with thiobarbituric acid (TBA). It is important to note that the percentage of recuperation of TBARS is 89.8%. This percentage was taken into consideration when the standard curve was established.

Table 15 shows the effect on the TBARS content of the addition of various active compounds to non-irradiated and irradiated ground beef. The results showed that when carvacrol, ascorbic acid or tetrasodium pyrophosphate were added to the ground beef, the TBARS value was significantly reduced. In non-irradiated samples, the best results were obtained for samples treated with ascorbic acid (TBARS values of 1.102 μM/g compared to 1.915 μM/g for the control). TBARS values of 1.411 and 1.583 μM/g were obtained for samples treated with carvacrol and tetrasodium pyrophosphate. When carvacrol was mixed with ascorbic acid and tetrasodium pyrophosphate or with tetrasodium pyrophosphate, the TBARS values was reduced to 1.623 μM/g and 1.641 μM/g respectively, but no significant difference (p>0.05) was observed for both mixtures. Results also showed that when carvacrol was mixed with ascorbic acid, the TBARS vallue was increased significantly (p≦0.05) to 2.837 μM/g compared to 1.915 μM/g for the control.

When samples were irradiated, data showed that ascorbic acid, carvacrol and tetrasodium pyrophosphate had a protective effect against TBARS production. The best values were obtained for samples containing tetrasodium pyrophosphate (1.425 μM/g), ascorbic acid (1.501 μM/g), the mixture of carvacrol and tetrasodium pyrophosphate (1.509 μM/g) and the mixture of carvacrol, ascorbic acid and tetrasodium pyrophosphate (1.641 μM/g) compared to 2.469 μM/g for irradiated samples without active compounds. A value of 1.770 μM/g was observed for samples containing carvacrol alone. No significant difference (p>0.05) was observed between samples containing carvacrol and samples containing the mixture of all three active compounds. There was also no significant different (p>0.05) between samples containing the mixture of carvacrol and ascorbic acid (2.542 μM/g) and the control (2.469 μM/g).

Table 16 shows the combined effect of the addition of a mixture of carvacrol and tetrasodium pyrophosphate and packaging conditions on the TBARS content of irradiated ground beef at a dose of 1 kGy.

In non-irradiated samples without active compounds, the lowest value was obtained for samples packed under vacuum, with TBARS value of 0.977 μM/g compared to 1.915 μM/g for the control samples packed under air. When samples were packed under CO₂ or MAP conditions, TBARS values were significantly higher (p≦0.05), with values of 1.488 μM/g and 2.961 μM/g respectively. These results suggest that air or MAP conditions affected the TBARS value significantly (p≦0.05). Packing samples under vacuum, under CO₂ or air at −30° C. protected against the TBARS production during irradiation, with TBARS values of 0.977 μM/g, 1.4883 μM/g and 1.727 μM/g respectively.

The irradiated samples showed that irradiation decreased the TBARS values slightly but significantly (p≦0.05) from 2.668 μM/g to 2.237 μM/g. The use of MAP or CO₂ conditions had no effect (p>0.5) on the TBARS values (3.026 μM/g and 1.458 μM/g respectively). Vacuum condition significantly increased (p≦0.05) the TBARS value from 0.977 μM/g to 1.373 μM/g. Also, samples treated under air, at −80° C. and 4° C. had a similar values of 2.395 μM/g and 2.237 μM/g, respectively. These results suggest that conducting irradiation under vacuum or under CO₂ protected against TBARS production. TBARS values were 1.373 μM/g and 1.458 μM/g respectively in these samples.

When active compounds were added to the samples, the lowest TBARS values were obtained for samples packed under MAP or vacuum conditions (0.808 μM/g and 0.915 μM/g respectively, compared to 1.641 μM/g for samples packed under air at 4° C.). A value of 1.251 μM/g was obtained for samples packed under CO₂ conditions and 1.415 μM/g for samples packed under air at −80° C. These values were significantly lower than 1.641 μM/g obtained for samples stored under air at 4° C. These results suggest that packaging under MAP, CO₂, vacuum and air conditions at −80° C. in presence of active compounds had a significant protective effect (p≦0.05) against TBARS production. In non-irradiated samples, MAP and vacuum conditions were the most effective treatments.

When samples containing active compounds were irradiated, the best results Were obtained for samples packed under MAP conditions (1.1338 μM/g) and under CO₂ conditions (1.285 μM/g). There was no significant difference (p>0.05) between air at 4° C., air at −80° C., and COD. The TBARS values were respectively 1.509 μM/g, 1.484 μM/g and 1.285 μM/g. No significant difference (p>0.05) was also observed between vacuum, air at 4° C. and air at −80° C., with TBARS values of 1.681 μM/g, 1.509 μM/g and 1.484 μM/g respectively. These results showed that the most effective packaging conditions in presence of active compounds were MAP and CO₂.

Table 17 shows the results of the variance analysis on the significance of simple and combined effects of the addition of the mixture of carvacrol and tetrasodium pyrophosphate, the packaging atmosphere and irradiation on the TBARS content of ground beef. The results indicate that, the addition of active compounds, the packaging atmosphere or the irradiation treatment had a significant effect (p≦0.001) on the TBARS content.

### EXAMPLE 2

### IRRADIATION SENSITIVITY OF E. coli AND S. typhi IN CHICKEN BREAST

2.1 Irradiation Sensitivity in the Presence of Various Active Compounds

Solutions used for the determination of the irradiation sensitivity in chicken breast correspond to 1/30 of the minimal inhibitory concentration (MIC) previously determined for ground beef. For E. coli the concentrations of the stock solutions were 0.88% for carvacrol, 1.15% for thymol, 1.5% for trans-cinnamaldehyde and 0.1% for tetrasodium pyrophosphate. For S. typhi, the concentrations of the stock solutions were 1.15% for carvacrol, 1.6% for thymol, 0.89% for trans-cinnamaldehyde and 0.1% for tetrasodium pyrophosphate. Solutions of each concentration of each active compound were prepared by solubilizing the active compound in 100 ml of a 1% solution of Tween 20 (Sigma-Aldrich, St-Louis, Mo). For example, for the solution of carvacrol (0.88%), 0.88 ml of carvacrol were diluted in Tween 20 (1%) to a final volume of 100 ml.

Chicken breast weighing around 150 g was dipped in a 3000 ml bath of working cultures of E. coli or S. typhi (5×10⁷ CFU/ml) for 5 minutes. The bacterial bath was made by adding to a 24 hours culture of E. coli or S. typhi in TSB, 2700 ml of sterile peptone water (0.1%). Each breast was placed in a 0.5 mil metalized polyester/2 mil EVA copolymer bag (205×355 mm, WINPACK, St-Léonard, Québec). Six bags were put aside for the control. For samples tested with active compounds, 5 ml of each solution of active compound was added before the bags were sealed (six bags for each active compound). The active compounds solution was then rubbed on to the chicken breast. Thus, for E. coli, the final concentration of each active compound present on the chicken breast were 0.029% for carvacrol, 0.038% for thymol, 0.050% for trans-cinnamaldehyde and 0.003% for tetrasodium pyrophosphate. For S. typhi, the final concentration was 0.038% for carvacrol, 0.053% for thymol, 0.030% for trans-cinnamaldehyde and 0.003% for tetrasodium pyrophosphate. The chicken breasts were stored at 4° C. until irradiation treatment (approximately 15 h).

Escherichia coli

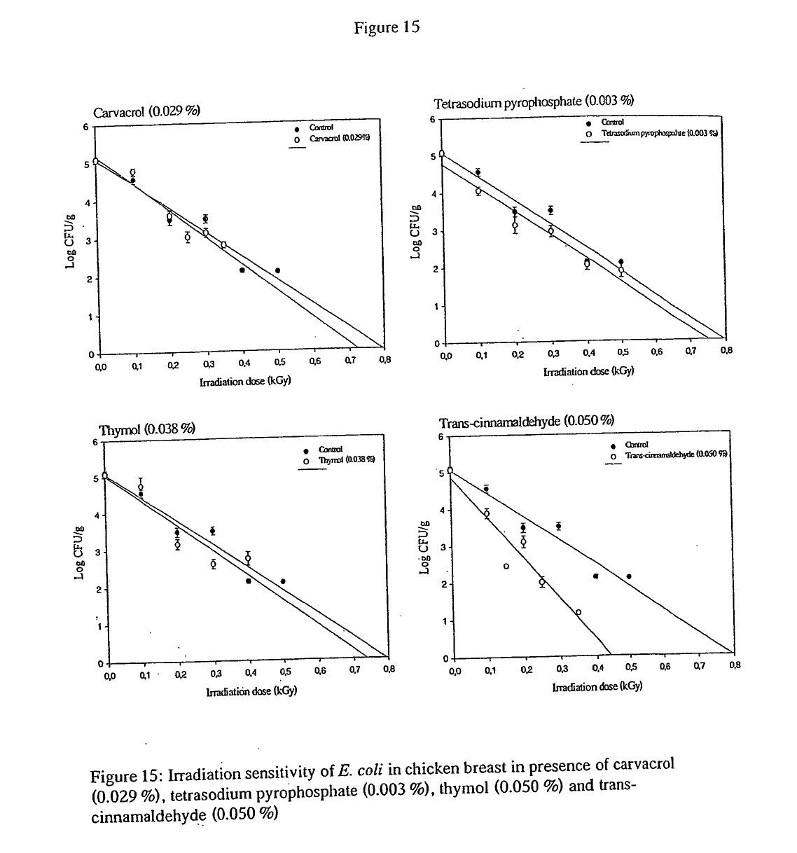

Table 18 and FIG. 15 show the irradiation sensitivity of E. coli in chicken breast in the presence of various active compounds. The D₁₀ value for the control was 0.145 kGy. Addition of trans-cinnamaldehyde (0.050%) significantly increased (p≦0.05) the irradiation sensitivity, with a D₁₀ value of 0.098 kGy (i.e. an increase in irradiation sensitivity of 32.4%). The irradiation dose necessary to completely eliminate E. coli from the chicken breast was also reduced from 0.8 kGy for the control to 0.75 kGy for the samples treated with trans-cinnamaldelhyde (0.050%).

Addition of thymol (0.038%) resulted in a D₁₀ value of 0.131 kGy, which represents an increase in irradiation sensitivity of 9.7%. The irradiation dose necessary to completely eliminate E. coli from chicken breast treated with thymol was also around 0.75 kGy.

Addition of tetrasodium pyrophosphate (0.003%) resulted in a D₁₀ value of 0.141 kGy. There was no significant difference (p>0.05) between the addition of tetrasodium pyrophosphate (0.003%) and the control. Addition of carvacrol (0.029%) resulted in a D₁₀ value of 0.145 kGy. No significant difference was observed between the D₁₀ of the control, the D₁₀ in presence of calvacrol (0.029%) and the D₁₀ in presence of tetrasodium pyrophosphate (0.003%). However, the addition of each of these two active compounds reduced the irradiation dose necessary to completely eliminate E. coli from the chicken breast from 0.8 kGy for the control to 0.72 kGy with carvacrol (0.029%) and to 0.75 kGy for tetrasodium pyrophosphate (0.003%).

The irradiation sensitivity of E. coli in ground beef treated with the same active compounds at higher concentration is shown in Table 3. In the absence of active compounds, the D₁₀ for E. coli was 0.145 kGy in chicken breast compared to 0.126 kGy in ground beef, representing an increase in resistance to irradiation of 13.1% for the bacteria in chicken breast. Addition of active compounds to the ground beef resulted in D₁₀ values of 0.037 kGy, 0.087 kGy, 0.103 kGy and 0.131 kGy for trans-cinnamaldehyde (1.5%), thymol (1.15%), carvacrol (0.88%) and tetrasodium pyrophosphate (0.1%) respectively. These D₁₀ values represent increases in sensitivity to irradiation of 70.6%, 40.0%, 18.2% and −4.0% respectively (see Example 1).

The ability of transcinnamaldehyde to increase the irradiation sensitivity of E. coli was reduced from 70.6% to 32.4% in chicken breast when the concentration used was 1/30 of the concentration used in ground beef. For thymol, the effect was reduced from 40.0% to 9.7% using a concentration corresponding to 1/30 of the MIC value in ground beef. No difference in effect was observed when the concentration of tetrasodium pyrophosphate was reduced. For carvacrol, use of a concentration corresponding to 1/30 of the MIC value in ground beef had no effect in chicken breast.

Salmonella typhi

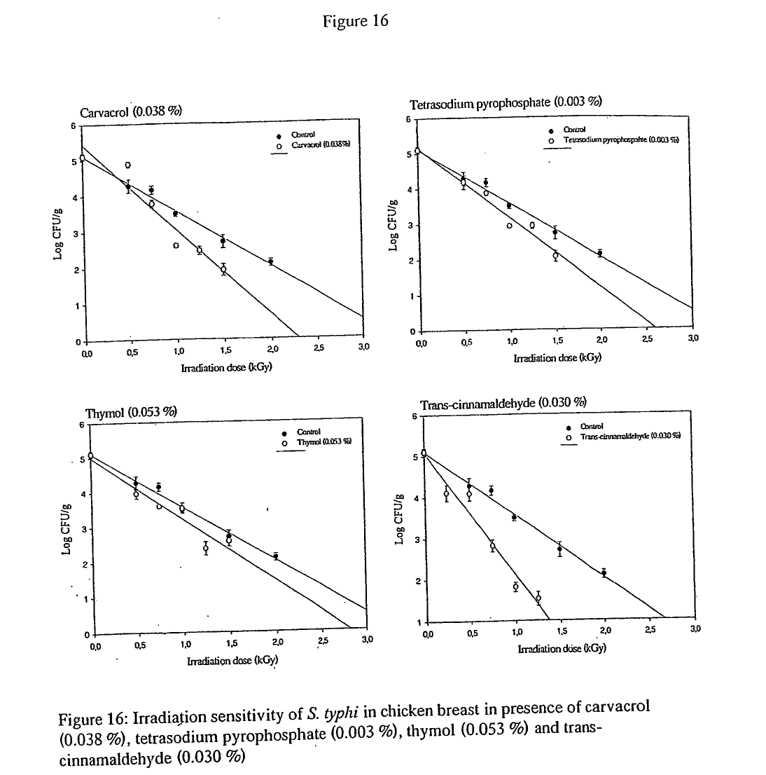

Table 19 and FIG. 16 show the irradiation sensitivity of S. typhi in chicken breast in the presence of various active compounds. The D₁₀ value for the control was 0.643 kGy. Addition of trans-cinnamaldehyde (0.030%) to the chicken breast significantly increased (p≦0.05) the irradiation sensitivity, with a D₁₀ value of 0.341 kGy (i.e. an increase in irradiation sensitivity of 47.0%). The irradiation dose necessary to completely eliminate S. typhi from the chicken breast was also reduced from 3.5 kGy for the control to 1.4 kGy for the samples treated with trans-ciiuiamaldehyde (0.030%).

The D₁₀ values for S. typhi in the presence of tetrasodium pyrophosphate (0.003%), carvacrol (0.038%) or thymol (0.053%) were 0.520 kGy, 0.532 kGy and 0.570 kGy respectively. These D₁₀ values represent an increase in irradiation sensitivity of 19.1%, 17.3% and 11.4% respectively. With the addition of these active compounds, the irradiation dose necessary to completely eliminate S. typhi from the chicken breast were also reduced to 2.6 kGy for tetrasodium pyrophosphate (0.003%), 2.3 kGy for carvacrol (0.038%) and 2.8 kGy for thymol (0.053%), compared to 3.5 kGy for the control.

The irradiation sensitivity of S. typhi in ground beef treated with the same active compounds at higher concentration is shown in Table 4. In the absence of active compounds, the D₁₀ for S. typhi in ground beef was 0.526 kGy compared to 0.643 kGy in chicken breast, representing an increase in irradiation resistance of 18.2% for the bacteria in chicken breast. In ground beef using concentrations corresponding to the MIC values in ground beef, the D₁₀ values ranged from 0.139 kGy to 0.356 kGy. In the chicken breast, the D₁₀ values ranged from 0.341 kGy to 0.570 kGy using concentrations corresponding to 1/30 of the MIC value in ground beef.

The effect of trans-cinnamaldehyde and tetrasodium pyrophosphate was reduced by a factor of 1.5 in the chicken breast using a concentration of 1/30 of the MIC value in ground beef. For carvacrol, the effect was reduced by a factor of 4 using a concentration corresponding to 1/30 of the MIC value in ground beef. For thymol, the effect was reduced by a factor of 5 using a concentration corresponding to 1/30 of the MIC value in ground beef.

2.2 Irradiation Sensitivity under Modified Atmosphere Packaging (MAP) Conditions

Based on the above results, trans-cinnamaldehyde was selected to study the effect of modified atmosphere packaging (MAP) in combination with tetrasodium pyrophosphate (0.003%). The concentration of the solution of trans-cinnamaldehyde used was 0.4%, corresponding to a concentration on the chicken breast of 0.013% At this concentration, the smell and the taste of the active compounds were acceptable. Tetrasodium pyrophosplhate (0.003%) was selected for its water retention abilities, which increase the tenderness of the meat.

Escherichia coli

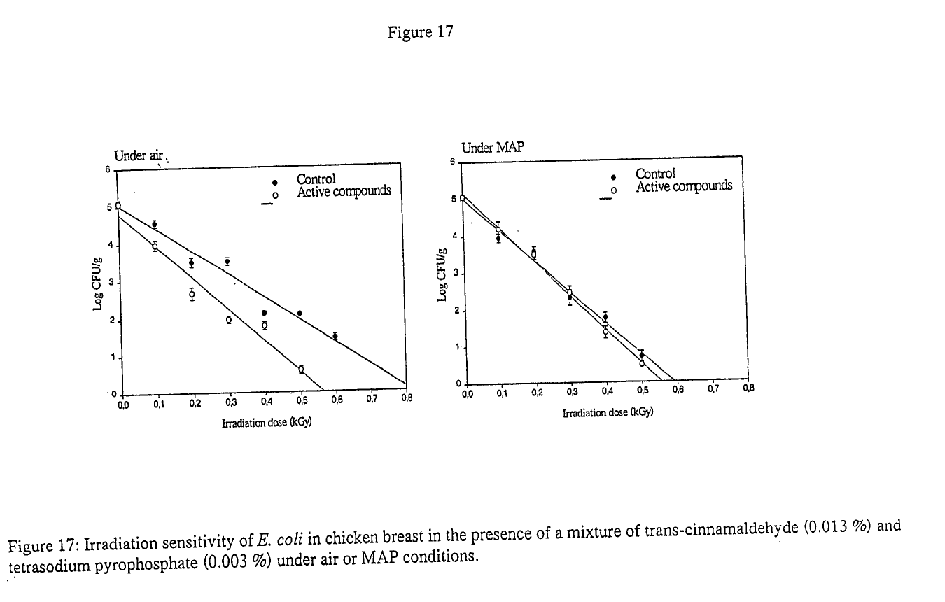

Table 20 and FIG. 17 show the irradiation sensitivity of E. coli in chicken breast under MAP conditions in the presence of the mixture of trans-cinnamaldehyde (0.013%) and tetrasodium pyrophosphate (0.003%). The irradiation sensitivity was significantly higher (p≦0.05) under MAP conditions both in the presence and absence of the mixture of active compounds. In the absence of the active compounds, the D₁₀ value was reduced from 0.145 kGy under air to 0.118 kGy under MAP conditions, representing an increase in irradiation sensitivity of 18.6%. The irradiation dose necessary to eliminate E. coli from the chicken breast was also reduced from 0.8 kGy under air to 0.6 kGy under MAP.

Addition of the mixture of active compounds increased the irradiation sensitivity of E. coli under both atmospheres tested. Under air, the irradiation sensitivity was increased by 18.6% by the addition of the active compounds, with a D₁₀ value of 0.118 kGy. Under MAP conditions, the irradiation sensitivity was increased by 8.5% by the addition of the active compounds, with a D₁₀ value of 0.108 kGy. The increase in sensitivity due the modified irradiation atmosphere was 8.5% (i.e. the D₁₀ values decreased from 0.118 kGy to 0.108 kGy). Under both atmospheres tested, the irradiation dose necessary to completely eliminate E. coli from the chicken breast was around 0.55 kGy.

Salmonella typhi

Table 21 and FIG. 18 show the irradiation sensitivity of S. typhi in chicken breast under MAP conditions in the presence of the mixture of trans-cinnamaldehyde (0.013%) and tetrasodium pyrophosphate (0.003%). The irradiation sensitivity was significantly higher (p≦0.05) under MAP conditions both in the presence and absence of the active compounds. In the absence of active compounds, the D₁₀ values were 0.643 kGy under air and 0.535 kGy under MAP conditions, representing an increase in irradiation sensitivity of 16.8%. The irradiation dose necessary to eliminate S. typhi from the chicken breast was also reduced from 3.25 kGy under air to 2.75 kGy under MAP conditions.

Addition of the mixture of active compounds increased the irradiation sensitivity of S. typhi under both atmospheres tested. Under air, the D₁₀ value was 0.535 kGy, representing an increase in sensitivity of 28.3%. Under MAP conditions, the D₁₀ value was 0.430.kGy, representing an increase in sensitivity of 19.6%. The increase in sensitivity due the modified irradiation atmosphere was 6.7% (i.e. the D₁₀ value from 0.461 kGy to 0.430 kGy). The use of MAP conditions reduced the irradiation dose necessary to completely eliminate S. typhi from the chicken breast from 2.5 kGy to 2.25 kGy.

### EXAMPLE3

### IRRADIATION SENSITIVITY OF E. coli AND S. typhi IN GROUND BEEF IN THE PRESENCE OF TRANS-CINNAMALDEHYDE UNDER MODIFIED ATMOSPHERE PACKAGING CONDITIONS

The concentration of trans-cinnamaldehyde used in this Example was 0.025% (final concentration), which represents the minimum inhibitory concentration (MIC) of trans-cinnamaldehyde required to reduce by 1 log the number of bacteria in artificial culture media. This value was detennined by testing six pathogenic and spoilage bacteria, commonly found in meat and meat products. Preliminary experiments also demonstrated that this concentration did not affect the organoleptic qualities of ground beef.

Ground beef samples weighing 450 g were contaminated with working cultures of E. coli or S. typhi in TSB to obtain a final concentration of 10⁵ CFU/g (7 ml of the culture). The ground beef samples containing micro-organisms were mixed for 3 min in a 4L-commercial blender at medium speed (Waring Products, New Hartford, Col., USA). Trans-cinnamaldehyde was added to a final concentration of 0.025%, followed by mixing for a further 3 min. Ground beef samples containing micro-organisms and active compounds were packed in portions of 25 g each in 0.5 mil metalized polyester/2 mil EVA copolymer bag (205 mm×355 mm, WINPACK, St-Léonard, Québec). The bags were sealed under air (78.1% N₂-20.9% O₂-0.036% CO₂) or under MAP conditions (10% N₂-60% O₂-30% CO₂) before sealing. The bags were stored at 4° C. until irradiation treatment (approximately 15 h).

Escherichia coli

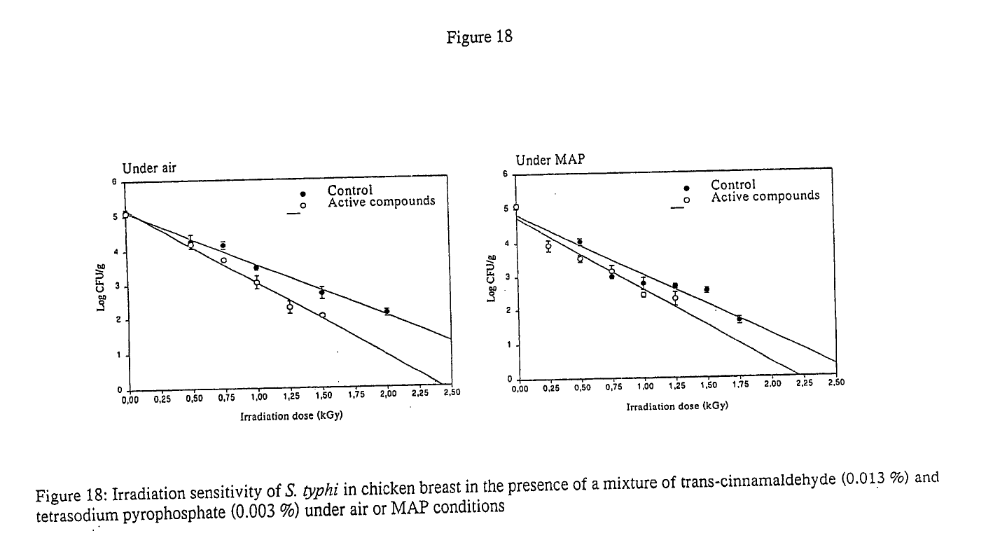

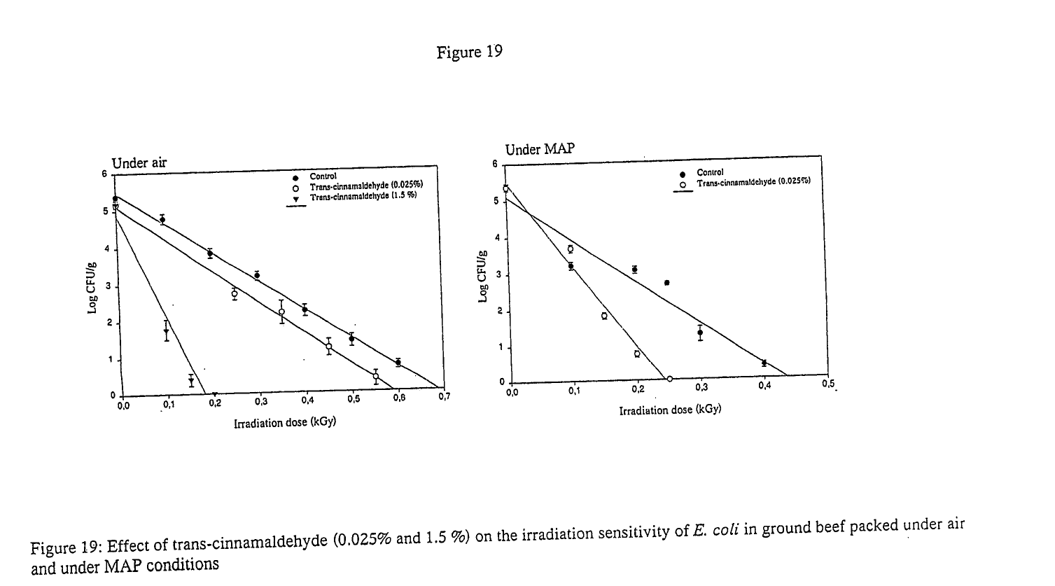

Table 22 and FIG. 19 show the irradiation sensitivity of E. coli in ground beef under MAP conditions in the presence of trans-cinnamaldehyde (0.025%). E. coli was significantly (p≦0.05) more sensitive to irradiation when packed under MAP conditions both in the absence and presence of trans-cinnamaldehyde. In the absence of active compounds, the D₁₀ values were 0.126 kGy under air and 0.086 kGy under MAP conditions, representing an increase in sensitivity under MAP conditions of 31.7%. The irradiation dose needed to completely eliminate E. coli from the ground beef was also decreased from 0.7 kGy under air to 0.45 kGy under MAP conditions.

When trans-cinnainaldehyde (0.025%) was added to the ground beef, E. coli was significantly more sensitive (p≦0.05) to irradiation compared to the appropriate control. Under air, the addition of trans-cinnamaldehyde (0.025%) resulted in a decrease in the D₁₀ value from 0.126 kGy to 0.115 kGy, representing an increase in sensitivity of 8.7%. Under MAP conditions, the addition of trans-cinnamaldehyde (0.025%) resulted in a decrease in the D₁₀ value from 0.086 kGy to 0.046 kGy, representing an increase in sensitivity of 46.5%. Modification of the packaging atmosphere in the presence of trans-cinnamaldehyde also increased the irradiation sensitivity of E. coli by 60% (i.e. the D₁₀ value decreased from 0.115 kGy to 0.046 kGy) and resulted in a reduction in the irradiation dose needed to completely eliminate E. coli from the ground beef from 0.6 kGy under air to 0.25 kGy under MAP conditions.

FIG. 19 shows the irradiation sensitivity of E. coli in ground beef in the presence of trans-cinnamaldehyde under air. Using trans-cinnamaldehyde at 0.025% and 1.5%, the D₁₀ values were 0.115 kGy and 0.037 kGy, respectively. The irradiation dose to completely eliminate E. coli from ground beef was reduced from 0.6 kGy for trans-cinnamaldehyde at 0.025% to 0.2 kGy for trans-cinnamaldeliyde to 1.5%. When the ground beef was packed under MAP conditions in the presence of trans-cinnamaldehyde at 0.025%, the D₁₀ value was 0.046 kGy and the irradiation dose needed to eliminate the bacteria was 0.25 kGy. Thus, the irradiation dose required to eliminate E. coli using 1.5% trans-cinnamaldehyde under air was similar to that using 0.025% trans-cinnamaldehyde under MAP conditions, indicating that the combination of trans-cinnamaldehyde (0.025%) and MAP conditions is as efficient as trans-cinnamaldehyde (1.5%) under air.

Salmonella typhi

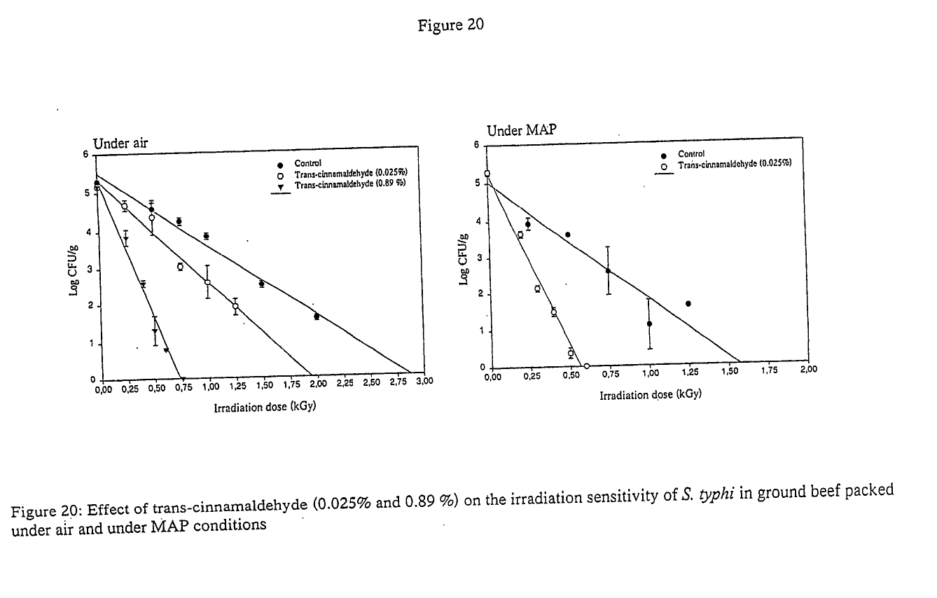

Table 23 and FIG. 20 show the irradiation sensitivity of S. typhi in ground beef in the presence of trans-cinnamaldehyde (0.025% and 0.89%) under air or MAP conditions. S. typhi was significantly (p≦0.05) more sensitive to irradiation under MAP conditions both in the presence and absence of trans-cinnamaldehyde. In the absence of trans-cinnamaldehyde, the D₁₀ values were 0.526 kGy under air and 0.221 kGy under MAP conditions, representing an increase in sensitivity under MAP conditions of 58.0%. The irradiation dose required to completely eliminate S. typhi from the ground beef was reduced from 2.8 kGy under air to 1.5 kGy under MAP conditions.

When trans-cinnamaldehyde (0.025%) was added to the ground beef, S. typhi was significantly more sensitive (p≦0.05) to irradiation compared to the appropriate control. Under air, the D₁₀ was 0.356 kGy in the presence of trans-cinnamaldehyde and 0.526 kGy for the control. Under MAP conditions, the D₁₀ value was 0.110 kGy in the presence of trans-cinnamaldehyde and 0.221 kGy for the control. These reductions in D₁₀ values represent an increase in sensitivity in the presence of trans-cinnamaldehyde of 32.3% under air and 50.2% under MAP conditions. Modification of the packaging atiosphere also increased the irradiation sensitivity by 69.1% (i.e. the D₁₀ values decreased from 0.356 kGy to 0.110 kGy) and resulted in a reduction in the irradiation dose required to completely eliminate S. typhi from the ground beef from around 2 kGy under air to 0.6 kGy under MAP conditions.

FIG. 20 also shows the irradiation sensitivity of S. typhi in ground beef in the presence of trans-cinnamaldehyde under air. Using trans-cinnamaldehyde at 0.025% and 0.89%, the D₁₀ values were 0.356kGy and 0.139 kGy respectively. The irradiation dose required to completely eliminate S. typhi from ground beef was reduced from 2.0 kGy for 0.025% trans-cinnamaldelhyde to 0.75 kGy for 0.89% trans-cinnamaldehyde. When the ground beef was packed under MAP conditions in the presence of 0.025% trans-cinnamaldehyde, the D₁₀ value was 0.110 kGy and the irradiation dose required to eliminate the bacteria was 0.6 kGy. Thus, the irradiation dose needed to eliminate S. typhi using 0.025% trans-cinnamaldehyde under MAP conditions was smaller than that using 0.89% trans-cinnamaldehyde under air (0.6 kGy vs 0.75 kGy) indicating that the combination of trans-cinnamaldehyde (0.025%) and MAP conditions is more efficient than trans-cinnamaldehyde (0.89%) under air.

### EXAMPLE 4

### EFFECT OF VARIOUS ACTIIE COAPOUNDS ON SHELF LIFE OF GROUND BEEF

Irradiation treatments of ground beef samples for D₁₀ and shelf life determination were performed using UC-15B irradiator (MDS-Nordion International Inc., Kanata, ON, Canada) equipped with a ⁶⁰ Co source at a dose rate of 14.42 kGy/h). Irradiation doses used for D₁₀ determination were ranged from 0.25 to 0.55 kGy for E. coli, from 0.50 to 2.0 kGy for S. typhi, and from 0.5 to 2.5 kGy for the mixture of indigenous microorganisms of ground beef. The shelf life study was performed on samples irradiated at 0.30, 0.85, and 1.75 kGy for E. coli, S. typhi, and the mixture of indigenous microorganisms of ground beef, respectively. For each active compound concentration tested, a group of non-irradiated samples sened as a control. For D₁₀ determination, samples were analysed immediately after irradiation. For shelf life studies, samples were stored at 4° C. and analysed periodically.

Microbial analysis was performed by homogenising the samples for 2 mn in sterile peptone water (0.1%) using a Lab-blender 400 stomacher (Laboratory Equipment, London, UK). From this mixture, serial dilutions were prepared and appropriate ones were pour-plated in tryptic soy agar (TSA) (Difco, Laboratories, Detroit, Mich., USA) and incubated at 35° C., 24 hours for the numeration of E. coli and S. typhi. For the ground beef broth, the incubation was performed on Plate Count Agar (PCA; Difco) at 35° C. for 48 h for the numeration mesophilic bacteria, and at 7° C. for 10 days for the numeration of psychrotrophic bacteria. Enterobacteriaceae were numerated on Violet Red Bile Glucose Agar (VRBGA; Difco) 35° C. for 48 hours.

The kinetics of bacteria destruction by irradiation with or without the food additives was evaluated by linear regression. Bacterial counts (log CFU/ml) were plotted against irradiation doses or active compounds concentration and D₁₀ values were calculated using the PROC REG procedure of SAS (SAS Institute, Cary, N.C., USA).

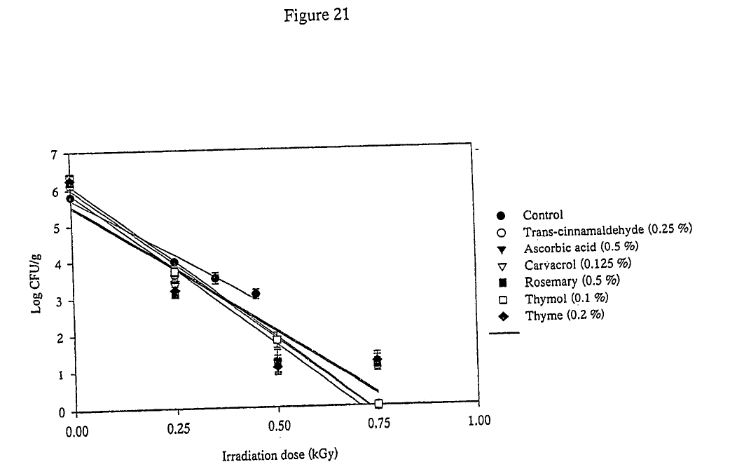

The results obtained for the irradiation sensitivity of E. coli and the kinetics of destruction are summarised in Table 24 and FIG. 21, respectively. Linear regression equation calculated and the D₁₀ values are displayed for the control samples (without irradiation) and samples containing selected active compounds. All the active compounds under study slightly increased the radiation sensitivity of E. coli when incorporated in ground beef prior to irradiation. The D₁₀ value of the control sample was 0.162 kGy. When trans-cinnamaldehyde, thymol and ascorbic acid were added to the ground beef prior to irradiation, D₁₀ values were reduced to ˜0.120 in all samples.

Lowest reductions of D₁₀ values of ˜0.143 kGy were obtained in presence of carvacrol, rosemary, and thyme extracts. High correlation coefficients were obtained for control samples (0.984), samples containing ascorbic acid (0.979), thymol (0.991), and trans-cinnamaldehyde (0.978). The data suggest that the kinetics of destruction of E. coli by gamma irradiation in presence of these active compounds are well described by a linear model. However, a lower correlation coefficient were obtained for rosemary and thyme (0.866 and 0.851, respectively). This is probably due to the fact that rosemary and thyme contained other antimicrobial molecules with different mechanisms of inhibition.

Due to the greater resistance of S. typhi and the mixture of indigenous microorganisms, the most effective antimicrobial compounds were used in this study. Trans-cinnamaldehyde, caivacrol, and thymol were selected on the basis of their antimicrobial effectiveness in meat systems and concentrations selected correspond to those producing 1 log reduction of bacterial in non-irradiated ground beef samples.

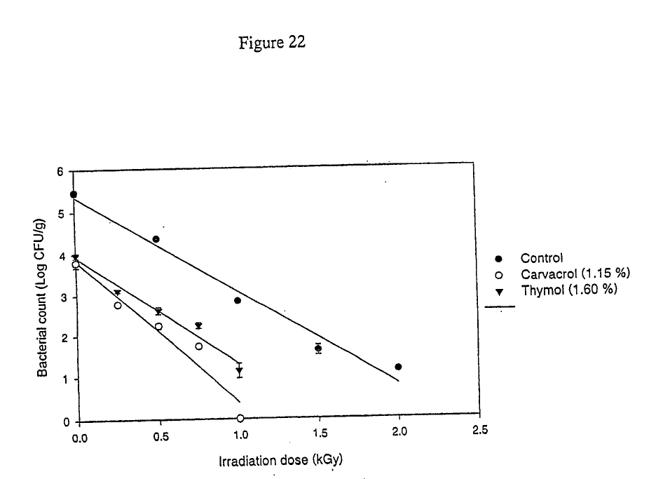

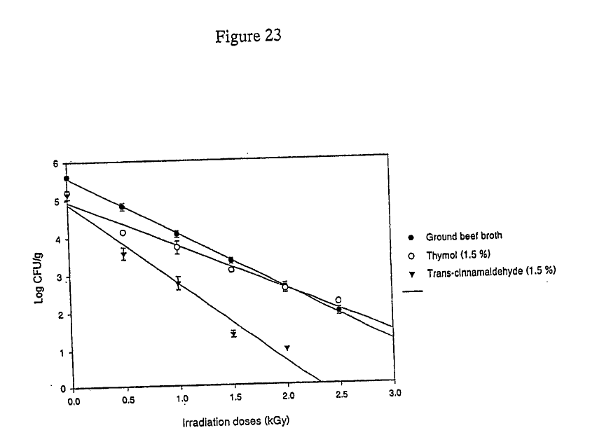

The irradiation sensitivity of S. typhi is presented in Table 25 and FIG. 22. The D₁₀ of S. typhi in control samples (without active compound) was 0.410 kGy. In the presence of carvacrol or thymol, the D₁₀ of S. typhi was reduced to 0.316 kGy or 0.382 kGy, respectively. Carvacrol seems to be slightly more efficient than thymol. Results, relative to the mixture of indigenous microorganisms of ground beef are presented in Table 25 and FIG. 23. The greatest resistance to irradiation treatment was observed with the mixture of indigenous microorganisms of ground beef compared to S. typhi and E. coli. The value for D₁₀ in the control sample for the mixture of indigenous microorganisms of ground beef was 0.705 kGy compared to 0.410 kGy for S. typhi and 0.267 kGy for E. coli. This particular behaviour can be explained by the presence of some more resistant bacteria, such as gram positive bacteria, in the mixture. Thymol had no effect on the radiation sensitivity while trans-cinnamaldehyde reduced the D₁₀ value from 0.705 kGy to 0.494 kGy. Thymol is an antioxidant compound and may act by scavenging free radicals produced during irradiation and preventing them from accumulating at the surface of target organisms. Therefore, a protective effect can be observed in some cases. These results are consistent with those reported by Stechinni et al. [J. Food Sci., 63:147-150 (1998)], where carnosine increased the radiation resistance of Aeromonas hydrophila.

A shelf life study was undertaken to evaluate the radiation sensitivity during refrigerated storage conditions. Ground beef samples contaminated with E. coli, S. typhi, or a mixture of indigenous micro-organisms were irradiated in presence or absence of selected active compounds. Due to the differences in sensitivity between the micro-organisms under study, the following irradiation doses were used: 0.30 kGy for E. coli, 0.85 kGy for S. typhi, and 1.75 kGy for the mixture of indigenous bacteria. The irradiation doses selected corresponded to the irradiation dose needed to produce 3 log CFU reduction in bacterial population in the control sample (without active compounds).

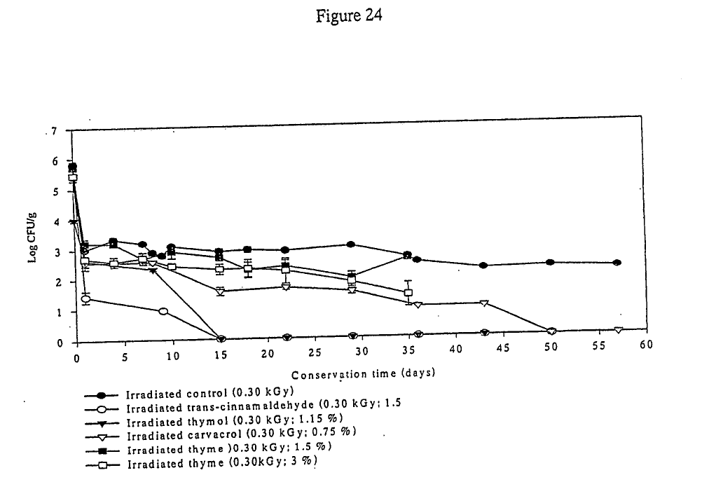

Growth curves for E. coli during storage of the treated samples are presented in FIG. 24. Results showed that irradiation treatment produced an immediate 3 log CFU reduction of bacterial population in control samples. In samples containing active compounds, an additional 0.5 to 1.5 log CFU reduction was observed. During storage, bacterial counts in control samples remained stable at approximately 3 log CFU/g for 57 days. In contrast, bacterial growth decreased progressively in the presence of thyme (3%). The greatest inhibitory effects were observed with trans-cinnamaldehyde and thymol. Complete inhibition was observed after 15 days in the presence of trans-cinnamaldehyde (1.5%) and thymol (1.15%), and after 50 days of storage in the presence of carvacrol (0.75%).

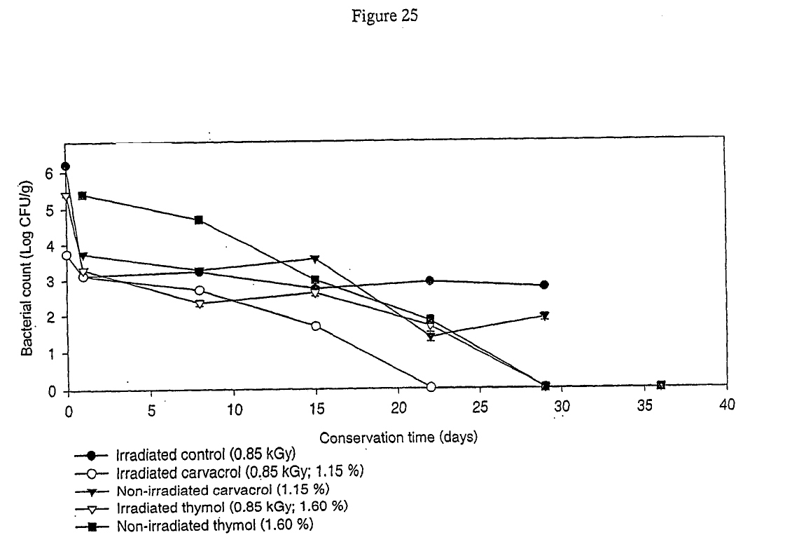

Similar patterns of bacterial inhibition were observed with S. typhi after irradiation at 0.85 kGy (FIG. 25). However, due to the greater resistance of S. typhi to irradiation, complete inhibition occurred only after 22 days of storage. Irradiation of ground beef in presence of carvacrol (1.15%) and thymol (1.6%) produced a complete inhibition after 22 and 28 days, respectively. After 15 days of storage, bacterial counts in irradiated samples containing carvacrol (1.15%) were 2 to 3 log CFU lower than those in the irradiated control. In the case of thymol, an effect was observed only during the 7 first days of storage. At days 7, a 3 log CFU difference was observed between samples irradiated in presence and absence of thymol. However, after 15 days, the bacterial counts were sinilar in both cases.

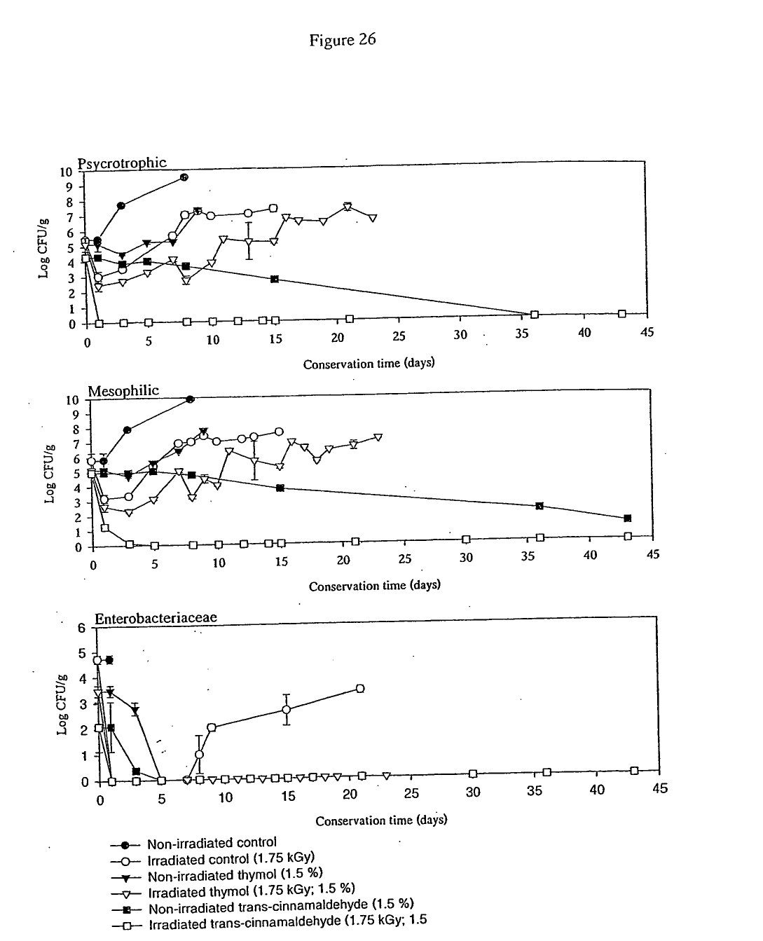

The shelf life study in ground beef contaminated with the mixture of indigenous microorganisms of ground beef was conducted by evaluating mesophilic, psychrotrophic and total Enterobacteriaceae in the samples. Growth curves for mesophilic and psychrotrophic bacteria were comparable (FIG. 26). In both cases, bacterial counts in non-irradiated samples without active compounds increased significantly to greater than 10⁹ CFU/g during the first 7 days. Irradiation reduced the bacterial counts by various degrees depending on the type of active compound used: 3 log CFU reduction for control (without active compounds), 3.5 and more than 5 log CFU reduction for samples containing thymol and trans-cinnamaldehyde, respectively. Combination of trans-cinnamaldehyde and irradiation resulted in complete inhibition of bacterial growth after 1 day for psyclirotrophic and after 3 days for mesophilic bacteria. Bacterial counts in both sarnples remained below detectable levels even after 44 days. Without irradiation, treatment with trans-cinnamaldehyde also resulted in a progressive reduction of bacterial populations during storage to reach to 1 log CFU for mesophilic bacteria and undetectable levels for psychrotrophic bacteria after 36 days of storage. A similar effect was also observed during storage for irradiated samples containing thymol as compared to samples without thymol. Between day 5 and day 15, a difference of 2 to 3 log CFU was observed between the two groups of samples. However, no complete inhibition was observed. A level of 10⁷ log CFU/g was observed for irradiated samples without thymol and a level of 10⁴ CFU/g was observed for irradiated samples with thymol.

For mesophilic bacteria, the shelf life period for non-irradiated samples was 2 days for control samples (without active compounds) and 8 days for samples containing thymol (1.5%). The shelf life period for irradiated samples was 8 days for control samples and 23 days for samples containing thymol (1.5%). For psychiotrophic bacteria, the shelf life period for non-irradiated samples was 2 days for control samples and 9 days for samples containing thymol (1.5%). In the presence of trans-cinnamaldehyde, both the mesophilic and the psychrotrophic bacteria were completely inhibited by irradiation immediately after the treatment, and the samples remained sterile during the total storage period (44 days). Trans-cinnamaldehyde alone produced a progressive reduction of bacterial growth, with complete inhibition occurring at days 36 for psychrotrophic bacteria. For mesophilic bacteria, trans-cinnamaldehyde alone reduced the bacteria counts to the level of ˜1 log CFU/g at day 44.

Enterobacteriaceae were more inhibited than mesophilic and psychrotrophic bacteria, confirming the greater sensitivity of grain negative bacteria to gamma irradiation. Treatment of the samples with active compounds alone (trans-cinnamaldehyde or thymol) produced a progressive reduction in bacterial population, with a complete inhibition by day 5 of storage. Treatment with irradiation alone resulted in complete inhibition immediately after treatment and the bacterial population was maintained below detectable levels for the first 7 days of storage. After day 7, bacterial growth was initiated and increased progressively to reach 3 log CFU/g at day 21. Combination of active compounds with irradiation also produced an immediate complete inhibition, in this case the inhibition was maintained for more than 43 days.

The results of this experiment show that the active compounds can progressively reduce the growth of micro-organisms and act with low doses of irradiation to produce complete inhibition of mesophilic, psychrotrophic, and total Enterobacteriaceae in ground beef. Trans-cinnamaldehyde combined with irradiation resulted in complete inhibition of bacterial growth immediately after the irradiation treatment with the bacterial growth remaining undetectable for 44 days. A significant effect was also observed for irradiation in combination with thymol. Bacterial counts in samples irradiated in presence of thymol were 2 to 3 log CFU lower than in sample irradiated without thymol. However, no complete inhibition occulTed in the case of thymol.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

TABLE 1
Minimal concentrations of active compound required to reduce E. coli
and S. typhi population by 1 log in ground beef

D₁₀ (%)³

| Active compounds | E. coli | S. typhi |
|---|---|---|
| Carvacrol² | 0.88 ± 0.12^{a} | 1.15 ± 0.02^{a} |
| Thymol¹ | 1.14 ± 0.05^{a} | 1.60 ± 0.00^{ab} |
| Trans-cinnamaldehyde² | 1.57 ± 0.10^{b} | 0.89 ± 0.03^{a} |
| Thyme² | 2.33 ± 0.32^{ab} | 2.75 ± 0.17^{b} |
| Ascorbic acid¹ | 2.71 ± 0.26^{b} | 1.83 ± 0.06^{ab} |
| Rosemary² | 10.37 ± 1.14^{c} | 13.56 ± 1.28^{c} |
| Tannic acid¹ | 11.15 ± 2.04^{c} | 21.18 ± 2.07^{d} |

¹Percentage (w/w)
²Percentage (v/w)
³Duncan-^{a,b,c,d}Values in same columns with different letters are significantly different (p ≦ 0.05)

TABLE 2
Estimated minimal concentrations for three types of
Duralox ® and Herbalox ® required to reduce
E. coli and S. typhi population by 1 log in ground beef.

| | D₁₀ (%)² | |
|---|---|---|
| Products¹ | E. coli | S. typhi |
| Duralox AR Seasoning MFD | 3.06 ± 0.38^{a} | 72.87 ± 5.01^{b} |
| Herbalox Type HTO | 3.45 ± 0.74^{a} | 42.92 ± 11.10^{a} |
| Duralox Oxidation NMC-2 | 4.21 ± 0.89^{a} | 64.33 ± 6.27^{b} |
| Duralox Oxidation NC-2 Type C | 6.30 ± 0.94^{b} | 62.00 ± 8.02^{b} |
| Herbalox Type O | 8.21 ± 1.42^{c} | 66.29 ± 2.64^{b} |
| Herbalox Type HT25 | 8.70 ± 0.12^{c} | 39.87 ± 7.06^{a} |

¹Percentage (v/w)
²Duncan-^{a,b,c,}Values in same columns with different letters are significantly different (p ≦ 0.05)

TABLE 3
Irradiation sensitivity of E. coli in ground beef
in presence of active compounds

| | | | Increase in |
|---|---|---|---|
| Active compounds | Properties¹ | D₁₀(kGy)² | Sensitivity³ |
| Control | | 0.126 ± 0.0036^{h} | |
| Trans-cinnamaldehyde | A | 0.037 ± 0.0012^{a} | 70.6% |
| (1.5%) | | | |
| Thymol (1.15%) | A | 0.087 ± 0.0036^{b} | 40.0% |
| Thyme (2.33%) | A | 0.090 ± 0.0036^{b} | 28.6% |
| Carvacrol (0.88%) | A | 0.103 ± 0.0027^{c} | 18.2% |
| Thymol (0.1%) | A | 0.103 ± 0.0094^{c} | 18.2% |
| Tannic acid (0.38%) | AB | 0.106 ± 0.0012^{cd} | 15.9% |
| Rosemary (0.5%) | B | 0.111 ± 0.0035^{de} | 11.9% |
| BHT (0.01%) | B | 0.115 ± 0.0020^{ef} | 8.7% |
| Trans-cinnamaldehyde | A | 0.115 ± 0.0041^{ef} | 8.7% |
| (0.025%) | | | |
| Carvacrol (0.125%) | A | 0.115 ± 0.0036^{ef} | 8.7% |
| Thyme (0.2%) | A | 0.117 ± 0.0147^{ef} | 7.1% |
| BHA (0.01%) | B | 0.117 ± 0.0026^{ef} | 7.1% |
| Nisin (625 UI/g) | A | 0.120 ± 0.0089^{efg} | 4.8% |
| Nisin (625 UI/g) + | A + ABC | 0.121 ± 0.0066^{fg} | 4.0% |
| EDTA (100 ppm) | | | |
| EDTA (100 ppm) | ABC | 0.127 ± 0.0033^{gh} | −0.8% |
| Tetrasodium pyrophos- | D | 0.131 ± 0.0079^{h} | −4.0% |
| phate (0.1%) | | | |
| Carnosine (1.0%) | BE | 0.133 ± 0.0075^{h} | −5.6% |
| Ascorbic acid (0.5%) | BE | 0.141 ± 0.0068ⁱ | −11.9% |

¹A: antimicrobial properties; B: antioxidant properties; C: chelator; D: moisture retention properties; E: colour stabiliser
²Duncan-^{a,b,c,d,e,f,g,h,i,j}Values in same columns with different letters are significantly different (p ≦ 0.05)
³Determined by: 100 − [D₁₀(sample) / D₁₀(control) × 100]. The values with a “−” have a protective effect on the bacteria compared to the control

TABLE 4
Irradiation sensitivity of S. typhi in ground beef
in presence of active compounds

| | | | Increase in |
|---|---|---|---|
| Active compounds | Properties¹ | D₁₀(kGy)² | Sensitivity³ |
| Control | | 0.526 ± 0.0161^{k} | |
| Trans-cinnamaldehyde | A | 0.139 ± 0.0025^{a} | 73.6% |
| (0.89%) | | | |
| Carvacrol (1.15%) | A | 0.208 ± 0.0062^{b} | 60.4% |
| Thymol (1.6%) | A | 0.210 ± 0.0086^{b} | 60.1% |
| Thyme (2.75%) | A | 0.260 ± 0.0078^{c} | 50.6% |
| Tannic acid (0.38%) | AB | 0.302 ± 0.0080^{d} | 42.6% |
| Nisin (625 UI/g) + | A + ABC | 0.340 ± 0.0118^{e} | 35.4% |
| EDTA (100 ppm) | | | |
| Carvacrol (0.125%) | A | 0.343 ± 0.0089^{e} | 34.8% |
| Tetrasodium pyrophos- | D | 0.356 ± 0.0126^{ef} | 32.3% |
| phate (0.1%) | | | |
| Trans-cinnamaldehyde | A | 0.356 ± 0.0047^{ef} | 32.3% |
| (0.025%) | | | |
| Thymol (0.1%) | A | 0.362 ± 0.0125^{f} | 31.2% |
| Thyme (0.2%) | A | 0.386 ± 0.0093^{g} | 26.6% |
| BHT (0.01%) | B | 0.405 ± 0.0074^{h} | 23.0% |
| BHA (0.01%) | B | 0.407 ± 0.0123^{h} | 22.6% |
| EDTA (100 ppm) | ABC | 0.419 ± 0.0198^{hi} | 20.3% |
| Nisin (625 UI/g) | A | 0.420 ± 0.0040^{hi} | 20.2% |
| Rosemary (0.5%) | B | 0.436 ± 0.0083ⁱ | 17.1% |
| Carnosine (1.0%) | BE | 0.494 ± 0.0246^{j} | 6.1% |
| Ascorbic acid (0.5%) | BE | 0.521 ± 0.0167^{k} | 1.0% |

¹A: antimicrobial properties; B: antioxidant properties; C: chelator; D: moisture retention properties; E: colour stabiliser
²Duncan-^{a,b,c,d,e,f,g,h,i,j,k,l}Values in same columns with different letters are significantly different (p ≦ 0.05)
³Determined by: 100 − [D₁₀(sample) / D₁₀(control) × 100].

TABLE 5
Effect of various concentrations of carvacrol on
E. coli in ground beef irradiated at 0.25 kGy

| Concentration of | | Increase in |
|---|---|---|
| carvacrol (%) | Log CFU/g¹ | Sensitivity² |
| 0 | 3.098 ± 0.117^{a} | |
| 0.2 | 2.948 ± 0.088^{b} | 4.8% |
| 0.4 | 2.948 ± 0.068^{b} | 4.8% |
| 0.6 | 2.660 ± 0.037^{c} | 14.1% |
| 0.8 | 1.198 ± 0.065^{d} | 61.3% |
| 1.0 | 0.843 ± 0.000^{e} | 72.8% |
| 1.2 | 0.000 ± 0.000^{f} | 100% |
| 1.4 | 0.000 ± 0.000^{f} | 100% |

¹Duncan-^{a,b,c,d,e,f}Values in same columns with different letters are significantly different (p ≦ 0.05)
²Determined by: 100 − [D₁₀(sample) / D₁₀(control) × 100].

TABLE 6
Effect of various concentrations of carvacrol on
S. typhi in ground beef irradiated at 0.50 kGy

| Concentration of | | Increase in |
|---|---|---|
| carvacrol (%) | Log CFU/g¹ | Sensitivity² |
| 0 | 4.170 ± 0.084^{a} | |
| 0.25 | 4.106 ± 0.091^{a} | 1.5% |
| 0.50 | 3.526 ± 0.061^{b} | 15.4% |
| 0.75 | 3.192 ± 0.058^{c} | 23.4% |
| 1.00 | 2.545 ± 0.112^{d} | 39.0% |
| 1.25 | 0.837 ± 0.000^{e} | 79.9% |
| 1.50 | 0.264 ± 0.000^{f} | 93.7% |
| 1.75 | 0.000 ± 0.000^{g} | 100% |
| 2.00 | 0.000 ± 0.000^{g} | 100% |

¹Duncan-^{a,b,c,d,e,f,g}Values in same columns with different letters are significantly different (p ≦ 0.05)
²Determined by: 100 − [D₁₀(sample) / D₁₀(control) × 100].

TABLE 7
Irradiation sensitivity (D₁₀) of E. coli in presence
of carvacrol (1.0%) alone, or in combination with ascorbic acid (0.5%)
and tetrasodium pyrophosphate (0.1%)

| | | Increase in |
|---|---|---|
| Active compounds | D₁₀(kGy)¹ | Sensitivity² |
| Control | 0.126 ± 0.0039^{b} | |
| carvacrol (1.0%) | 0.057 ± 0.0015^{a} | 55.5% |
| carvacrol with tetrasodium | 0.057 ± 0.0010^{a} | 55.5% |
| pyrophosphate (0.1%) | | |
| carvacrol (1.0%) with ascorbic | 0.133 ± 0.0043^{b} | −3.9% |
| acid (0.5%) | | |
| carvacrol with ascorbic acid | 0.142 ± 0.0051^{c} | −10.9% |
| (0.5%) and tetrasodium | | |
| pyrophosphate (0.1%) | | |

¹Duncan-^{abc}Values in same columns with different letters are significantly different (p ≦ 0.05)
²Determined by: 100 − [D₁₀(sample) / D₁₀(control) × 100]. A “−” sign before a number represent a protective effect on E. coli

TABLE 8
Irradiation sensitivity (D₁₀) of S. typhi in presence
of carvacrol (1.0%) alone, or in combination with ascorbic acid (0.5%)
and tetrasodium pyrophosphate (0.1%)

| | | Increase in |
|---|---|---|
| Active compounds | D₁₀(kGy)¹ | Sensitivity² |
| Control | 0.519 ± 0.0308^{d} | |
| carvacrol (1.0%) | 0.235 ± 0.0158^{a} | 54.7% |
| carvacrol with tetrasodium | 0.254 ± 0.0102^{a} | 51.0% |
| pyrophosphate (0.1%) | | |
| carvacrol with ascorbic acid | 0.313 ± 0.0085^{b} | 39.7% |
| (0.5%) and tetrasodium | | |
| pyrophosphate (0.1%) | | |
| carvacrol (1.0%) with ascorbic | 0.344 ± 0.0086^{c} | 33.7% |
| acid (0.5%) | | |

¹LSD and Duncan-^{abc}Values in same columns with different letters are significantly different (p ≦ 0.05)
²Determined by: 100 − [D₁₀(sample) / D₁₀(control) × 100].

TABLE 9
Irradiation sensitivity of E. coli in ground beef
treated with a mixture of carvacrol (1%) and tetrasodium
pyrophosphate (0.1%) under various atmospheres

| | D₁₀(kGy)^{1,2} | | |
|---|---|---|---|
| | | Carvacrol (1%) | |
| Packaging | | and tetrasodium | Increase in |
| atmosphere | Control | pyrophosphate (0.1%) | Sensitivity⁴ |
| MAP³ | 0.086 ± 0.0030^{a} | 0.046 ± 0.0008^{a}* | 46.5% |
| Vacuum | 0.118 ± 0.0054^{b} | 0.101 ± 0.0036^{c}* | 14.4% |
| 100% CO₂ | 0.123 ± 0.0068^{bc} | 0.106 ± 0.0048^{d}* | 13.8% |
| Air | 0.126 ± 0.0036^{c} | 0.055 ± 0.0014^{b}* | 56.3% |

¹Duncan-^{abcd}Values in same columns with different letters are significantly different (p ≦ 0.05)
²T-Test-Values in same rows with a “*” are significantly different (p ≦ 0.05)
³60% O₂-30% CO₂-10% N₂
⁴Determined by: 100 − [D₁₀(sample) / D₁₀(control) × 100].

TABLE 10
Effect of different modified atmospheres for packaging on the
irradiation sensitivity of E. coli when compared to air packaging

Increase in Irradiation Sensitivity²

| | | Carvacrol (1%) |
|---|---|---|
| Packaging | | and tetrasodium |
| atmosphere | Control | pyrophosphate (0.1%) |
| MAP¹ | 37.7% | 16.4% |
| Vacuum | 6.3% | −83.6% |
| 100% CO₂ | 2.4% | −92.7% |

¹60% O₂-30% CO₂-10% N₂
²Determined by: 100 − [D₁₀(sample) / D₁₀(control) × 100]. A negative value represents a protective effect on the bacteria

TABLE 11
Irradiation sensitivity of S. typhi in ground beef
treated with a mixture of carvacrol (1%) and
tetrasodium pyrophosphate (0.1%) under various atmospheres

| | D₁₀(kGy)¹² | | |
|---|---|---|---|
| | | Carvacrol (1%) | |
| Packaging | | with tetrasodium | Increase in |
| atmosphere | Control | pyrophosphate (0.1%) | Sensitivity⁴ |
| MAP³ | 0.221 ± 0.0189^{a} | 0.053 ± 0.0012^{a}* | 76.0% |
| 100% CO₂ | 0.420 ± 0.0046^{b} | 0.336 ± 0.0280^{d}* | 20.0% |
| Vacuum | 0.429 ± 0.0089^{b} | 0.308 ± 0.0132^{c}* | 28.2% |
| Air | 0.526 ± 0.0161^{c} | 0.254 ± 0.0102^{b}* | 51.7% |

¹Duncan-^{abcd}Values in same columns with different letters are significantly different (p ≦ 0.05)
²T-Test-Values in same rows with a “*” are significantly different (p ≦ 0.05)
³60% O₂-30% CO₂-10% N₂
⁴Determined by: 100 − [D₁₀(sample) / D₁₀(control) × 100].

TABLE 12
Effect of different modified atmospheres for packaging on the
irradiation sensitivity of S. typhi when compared to air packaging

Increase in Sensitivity²

| | | Carvacrol (1%) |
|---|---|---|
| Packaging | | with tetrasodium |
| atmosphere | Control | pyrophosphate (0.1%) |
| MAP¹ | 58.0% | 79.1% |
| 100% CO₂ | 20.2% | −32.3% |
| Vacuum | 18.4% | −21.2% |

¹60% O₂-30% CO₂-10% N₂
²Determined by: 100 − [D₁₀(sample) / D₁₀(control) × 100]. A negative value represent a protective effect on the bacteria

TABLE 13
Results of variance analysis showing the significance of simple and
combined effects of addition of the mixture of carvacrol and
tetrasodium pyrophosphate and the packaging atmosphere on the
irradiation sensitivity of E. coli and S. typhi in ground beef

P (F > Fcal)¹

| Factors | DF | E. coli | S. typhi |
|---|---|---|---|
| Active compounds | 1 | <0.001 | <0.001 |
| Atmosphere | 3 | <0.001 | <0.001 |
| Active compounds * | 3 | <0.001 | <0.001 |
| atmosphere | | | |

¹Simple and combined effects are considered significant when p ≦ 0.001.

TABLE 14
Irradiation sensitivity of E. coli and S. typhi in ground beef treated with
carvacrol (1.0%) and tetrasodium pyrophosphate (0.1%), packed under air
and stored under refrigerated (4° C.) or frozen (−80° C.) conditions

| | Irradiation sensitivity D₁₀(kGy)^{1,2} | | | |
|---|---|---|---|---|
| | E. Coli | | S. typhi | |
| | | Carvacrol (1%) + | | Carvacrol (1%) + |
| Irradiation | | tetrasodium | | tetrasodium |
| temperature | Control | pyrophosphate (0.1%) | Control | pyrophosphate (0.1%) |
| 4° C. | 0.126 ± 0.0036^{a} | 0.055 ± 0.0014^{a}* | 0.526 ± 0.0161^{a} | 0.254 ± 0.0102^{a}* |
| −80° C. | 0.227 ± 0.0092^{b} | 0.128 ± 0.0052^{b}* | 0.701 ± 0.0100^{b} | 0.297 ± 0.0164^{b}* |

¹Duncan-^{abcde}Values in same column with different letters are significantly different (p ≦ 0.05)
²For each treatment group (control or Carvacrol + tetrasodium pyrophosphate), means of irradiated samples with asterisks (*) are significantly different (p ≦ 0.05) from samples without active compounds.

TABLE 15
Effect of various active compounds on non-irradiated and irradiated
ground beef packed under air

| | TBARS (μM/g)^{1,2} | |
|---|---|---|
| Active compounds | Non-irradiated | Irradiated (1 kGy) |
| Control | 1.915 ± 0.193^{d} | 2.469 ± 0.172^{c}* |
| Ascorbic acid (0.5%) | 1.102 ± 0.107^{a} | 1.501 ± 0.104^{a}* |
| Carvacrol (1.0%) | 1.411 ± 0.221^{b} | 1.770 ± 0.189^{b}* |
| Tetrasodium pyrophosphate (0.1%) | 1.583 ± 0.246^{bc} | 1.425 ± 0.070^{a} |
| Carvacrol (1.0%) + | 1.623 ± 0.206^{c} | 1.641 ± 0.257^{ab} |
| ascorbic acid (0.5%) + | | |
| tetrasodium pyrophosphate (0.1%) | | |
| Carvacrol (1.0%) + | 1.641 ± 0.218^{c} | 1.509 ± 0.262^{a} |
| tetrasodium pyrophosphate (0.1%) | | |
| Carvacrol (1.0%) + | 2.837 ± 0.202^{e} | 2.542 ± 0.304^{c} |
| ascorbic acid (0.5%) | | |

¹Duncan-^{abcde}Values in same column with different letters are significantly different (p ≦ 0.05)
²For each treatment group (control or Carvacrol + tetrasodium pyrophosphate), means of irradiated samples with asterisks (*) are significantly different (p ≦ 0.05) from corresponding non-irradiated samples.

TABLE 16
Effect of various active compounds on non-irradiated and irradiated
ground beef packed under various atmospheres (CO₂, MAP and vacuum)

| | TBARS (μM/g)^{1,2} | | | |
|---|---|---|---|---|
| | | | Carvacrol (1%) + tetrasodium | |
| | Control | | pyrophosphate (0.1%) | |
| Atmosphere | Non-irradiated | Irradiated | Non-irradiated | Irradiated |
| Vacuum | 0.977 ± 0.107^{a} | 1.373 ± 0.209^{a}* | 0.915 ± 0.141^{a} | 1.681 ± 0.306^{c} [symbol] |
| CO₂ | 1.488 ± 0.099^{b} | 1.458 ± 0.096^{a} | 1.251 ± 0.221^{b} | 1.285 ± 0.215^{a} [symbol] |
| Air −80° C. | 1.727 ± 0.210^{c} | 2.395 ± 0.175^{b}* | 1.415 ± 0.172^{b} | 1.484 ± 0.264^{b} [symbol] |
| Air 4° C. (control) | 1.915 ± 0.193^{d} | 2.469 ± 0.172^{b}* | 1.641 ± 0.218^{c} | 1.509 ± 0.262^{b} [symbol] |
| MAP³ | 2.961 ± 0.188^{e} | 3.026 ± 0.126^{c} | 0.808 ± 0.053^{a} | 1.138 ± 0.246^{a} [symbol] |

^{1abcde}Values in same column with different letters are significantly different (p ≦ 0.05)
²For each treatment group (control or Carvacrol + tetrasodium pyrophosphate), means of irradiated samples with asterisks (*) are significantly different (p ≦ 0.05) from corresponding non-irradiated samples.
MAP: 60% O₂-30% CO₂-10% N₂

TABLE 17
Results of variance analysis showing the significance of simple and
combined effects of the addition of active compounds (carvacrol with
tetrasodium pyrophosphate), the packaging atmosphere and irradiation
on the TBARS content of ground beef

| | | P (F > Fcal)¹ |
|---|---|---|
| Factors | DF | TBARS |
| Active compounds | 1 | <0.001** |
| Atmosphere | 4 | <0.001** |
| Irradiation | 1 | <0.001** |
| Active compounds * atmosphere | 4 | <0.001** |
| Active compounds * irradiation | 1 | 0.012* |
| Atmosphere * Irradiation | 4 | <0.001** |
| Active compounds * atmosphere * | 4 | 0.643 |
| irradiation | | |

¹*Simple and combined effects are considered significant when p ≦ 0.05.
**Simple and combined effects are considered significant when p ≦ 0.001.

TABLE 18
Irradiation sensitivity of E. coli in chicken breast in the presence of
carvacrol (0.029%), tetrasodium pyrophosphate (0.003%), thymol
(0.038%) or trans-cinnamaldehyde (0.050%)

| | | | Increase in |
|---|---|---|---|
| Active compounds | Properties¹ | D₁₀(kGy)² | Sensitivity³ |
| Control | | 0.145 ± 0.014^{c} | |
| Trans-cinnamaldehyde | A | 0.098 ± 0.006^{a} | 32.4% |
| (0.050%) | | | |
| Thymol (0.038%) | A | 0.131 ± 0.007^{b} | 9.7% |
| Tetrasodium pyrophos- | B | 0.141 ± 0.012^{bc} | 2.7% |
| phate (0.003%) | | | |
| Carvacrol (0.029%) | A | 0.145 ± 0.003^{c} | 0% |

¹A: antimicrobial properties; B: moisture retention properties
²Duncan-^{a,b,c,d,e,f,g,h,i,j}Values in same columns with different letters are significantly different (p ≦ 0.05)
³Determined by: 100 − [D₁₀(sample) / D₁₀(control) × 100].

TABLE 19
Irradiation sensitivity of S. typhi in chicken breast in the presence of
carvacrol (0.038%), tetrasodium pyrophosphate (0.003%), thymol
(0.053%) or trans-cinnamaldehyde (0.030%)

| | | | Increase in |
|---|---|---|---|
| Active compounds | Properties¹ | D₁₀(kGy)² | Sensitivity³ |
| Control | | 0.643 ± 0.050^{c} | |
| Trans-cinnamaldehyde | A | 0.341 ± 0.018^{a} | 47.0% |
| (0.030%) | | | |
| Tetrasodium pyrophos- | B | 0.520 ± 0.030^{b} | 19.1% |
| phate (0.003%) | | | |
| Carvacrol (0.038%) | A | 0.532 ± 0.071^{b} | 17.3% |
| Thymol (0.053%) | A | 0.570 ± 0.065^{b} | 11.4% |

¹A: antimicrobial properties; B: moisture retention properties;
²Duncan-^{a,b,c,d,}Values in same columns with different letters are significantly different (p ≦ 0.05)
³Determined by: 100 − [D₁₀(sample) / D₁₀(control) × 100].

TABLE 20
Irradiation sensitivity of E. coli in chicken breast in the presence of a
mixture of trans-cinnamaldehyde (0.013%) and tetrasodium
pyrophosphate (0.003%) under air or MAP conditions

| | D₁₀(kGy)^{1,2} | | |
|---|---|---|---|
| | | Trans-cinnamaldehyde | |
| Packaging | | (0.013%) and tetrasodium | Increase in |
| atmosphere | Control | pyrophosphate (0.003%) | Sensitivity⁴ |
| Air | 0.145 ± 0.014^{a} | 0.118 ± 0.007^{a}* | 18.6% |
| MAP³ | 0.118 ± 0.006^{b} | 0.108 ± 0.002^{b}* | 8.5% |

¹t-Test-Values in same columns with different letters are significantly different (p ≦ 0.05)
²t-Test-Values in same rows with a “*” are significantly different (p ≦ 0.05)
³60% O₂-30% CO₂-10% N₂
⁴Due to active compounds under the same atmosphere. Determined by: 100 − [D₁₀(sample) / D₁₀(control) × 100].

TABLE 21
Irradiation sensitivity of S. typhi in chicken breast
in the presence of a mixture of trans-cinnamaldehyde (0.013%)
and tetrasodium pyrophosphate (0.003%) under air or MAP conditions

| | D₁₀(kGy)^{1,2} | | |
|---|---|---|---|
| | | Trans-cinnamaldehyde | |
| Packaging | | (0.013%) and tetrasodium | Increase in |
| atmosphere | Control | pyrophosphate (0.003%) | Sensitivity⁴ |
| Air | 0.643 ± 0.050^{a} | 0.461 ± 0.025^{a}* | 28.3% |
| MAP³ | 0.535 ± 0.046^{b} | 0.430 ± 0.025^{b}* | 19.6% |

¹t-Test-Values in same columns with different letters are significantly different (p ≦ 0.05)
²t-Test-Values in same rows with a “*” are significantly different (p ≦ 0.05)
³60% O₂-30% CO₂-10% N₂
⁴Due to active compounds under the same atmosphere. Determined by: 100 − [D₁₀(sample) / D₁₀(control) × 100].

TABLE 22
Effect of trans-cinnamaldehyde (0.025%) under air and MAP
conditions on the irradiation sensitivity of E. coli in ground beef

| | D₁₀(kGy)^{1,2} | | |
|---|---|---|---|
| Packaging | | Trans-cinnamaldehyde | Increase in |
| atmosphere | Control | (0.025%) | Sensitivity⁴ |
| Air | 0.126 ± 0.004^{a} | 0.115 ± 0.004^{a}* | 8.7% |
| MAP³ | 0.086 ± 0.003^{b} | 0.046 ± 0.001^{b}* | 46.5% |

¹t-Test-Values in same columns with different letters are significantly different (p ≦ 0.05)
²t-Test-Values in same rows with a “*” are significantly different (p ≦ 0.05)
³60% O₂-30% CO₂-10% N₂
⁴Due to active compounds under the same atmosphere. Determined by: 100 − [D₁₀(sample) / D₁₀(control) × 100].

TABLE 23
Effect of trans-cinnamaldehyde (0.025%) under air and MAP
conditions on the irradiation sensitivity of S. typhi in ground beef

| | D₁₀(kGy)^{1,2} | | |
|---|---|---|---|
| Packaging | | Trans-cinnamaldehyde | Increase in |
| atmosphere | Control | (0.025%) | Sensitivity⁴ |
| Air | 0.526 ± 0.016^{a} | 0.356 ± 0.005^{a}* | 32.3% |
| MAP³ | 0.221 ± 0.019^{b} | 0.110 ± 0.002^{b}* | 50.2% |

¹t-Test-Values in same columns with different letters are significantly different (p ≦ 0.05)
²t-Test-Values in same rows with a “*” are significantly different (p ≦ 0.05)
³60% O₂-30% CO₂-10% N₂
⁴Due to active compounds under the same atmosphere. Determined by: 100 − [D₁₀(sample) / D₁₀(control) × 100].

TABLE 24
Irradiation sensitivity of E. coli in the presence of various
active compounds in ground beef.

| Active compounds | Equation^{a} | D₁₀ (%) | R² |
|---|---|---|---|
| Control | y = −6.182x + 5.715 | 0.162 | 0.984 |
| Ascorbic acid (0.5%) | y = −8.257x + 5.993 | 0.121 | 0.979 |
| Carvacrol (0.125%) | y = −6.918x + 5.554 | 0.144 | 0.880 |
| Rosemary (0.5%) | y = −6.912x + 5.495 | 0.145 | 0.866 |
| Thyme (0.2%) | y = −6.978x + 5.526 | 0.143 | 0.851 |
| Thymol (0.1%) | y = −8.357x + 6.094 | 0.120 | 0.991 |
| Trans-cinnamaldehyde | y = −8.326x + 5.865 | 0.120 | 0.978 |
| (0.25%) | | | |

^{a}y: Bacterial count (log CFU/g)
x: Irradiation doses (kGy)

TABLE 25
Irradiation sensitivity of S. typhi and ground beef broth in the
presence of various active compounds in ground beef.

| Active compounds | Equation^{a} | D₁₀ (kGy) | R² |
|---|---|---|---|
| Salmonella typhi | | | |
| Control | y = −2.439x + 5.398 | 0.410 | 0.962 |
| Carvacrol (1.15%) | y = −3.169x + 3.710 | 0.316 | 0.882 |
| Thymol (1.60%) | y = −2.615x + 3.924 | 0.382 | 0.951 |
| Mixture of | | | |
| indigenous bacteria | | | |
| Control | y = −1.418x + 5.526 | 0.705 | 0.984 |
| Thymol (1.5%) | y = −1.283x + 5.038 | 0.779 | 0.969 |
| Trans-cinnamaldehyde | y = −2.023x + 4.797 | 0.494 | 0.970 |
| (1.5%) | | | |

^{a}y: Bacterial count (log CFU/g)
x: Irradiation doses (kGy)

1: A formulation comprising one or more compounds derived from natural sources and substantially purified, wherein application of said formulation to a food product and irradiation of said food product at less than 3 kGy results in a decrease in the number of micro-organisms in said food product when compared to an irradiated control.

2: The formulation according to claim 1, wherein said irradiation takes place under modified atmospheric packaging (MAP) conditions.

3: The formulation according to claim 1, wherein said decrease is at least one log order.

4: The formulation according to claim 3, wherein said decrease is at least two log orders.

5: The formulation according to claim 4, wherein said decrease is at least 3 log orders.

6: The formulation according to claim 4, wherein said decrease is at least 4 log orders.

7: The formulation according to claim 1, wherein said one or more compounds present in the formulation provide a final concentration of between about 0.001% and 10.0% of each compound to the food product.

8: The formulation according to claim 7, wherein said concentration is between about 0.005% to 5.0%.

9: The formulation according to claim 8, wherein said concentration is between about 0.01% and 2.5%.

10: The formulation according to claim 1, wherein one or more of said compounds are GRAS food additives.

11: The formulation according to claim 1, wherein one or more of said compounds are anti-oxidants.

12: The formulation according to claim 1, wherein one or more of said compounds are anti-microbial agents.

13: The formulation according to claim 1, wherein one of said compounds is thymol.

14: The formulation according to claim 1, wherein one of said compounds is trans-cinnamaldehyde.

15: The formulation according to claim 1, wherein one of said compounds is carvacrol.

16: The formulation according to claim 1, wherein one of said compounds is tannic acid.

17: The formulation according to claim 1, wherein one of said compounds is nisin.

18: The formulation according to claim 1 further comprising a carrier.

19: The formulation according to claim 1 further comprising one or more additives selected from the group of: chelating agents, surfactants, herbs, spices, essential oils, thickeners, anti-oxidants, emulsifiers, sequestering agents, colourings, flavourings, vitamins, minerals, and enzymes.

20: The formulation according to claim 19, wherein said additive is a sequestering agent.

21: The formulation according to claim 20, wherein said sequestering agent is tetrasodium pyrophosphate.

22: The formulation according to claim 21, wherein the amount of tetrasodium pyrophosphate in said formulation provides a final concentration of between about 0.003% and 0.1%.

23: A method of inhibiting the growth of a population of micro-organisms in a food product, comprising combining the food product with one or more compounds and exposing to a radiation dose of less than 3 kGy, wherein said compounds are derived from natural sources and are substantially purified.

24: The method according to claim 23, wherein said radiation dose is applied under modified atmosphere packaging (MAP) conditions.

25: The method according to claim 23, wherein said one or more compounds present in the formulation provide a final concentration of between about 0.001% and 10.0% of each compound to the food product.

26: The method according to claim 25, wherein said concentration is between about 0.005% and 5.0%.

27: The method according to claim 26, wherein said concentration is between about 0.01% and 2.5%.

28: The method according to claim 23, wherein one or more of said compounds are GRAS food additives.

29: The method according to claim 23, wherein one or more of said compounds are anti-oxidants.

30: The method according to claim 23, wherein one or more of said compounds are anti-microbial agents.

31: The method according to claim 23, wherein one of said compounds is thymol.

32: The method according to claim 23, wherein one of said compounds is trans-cinnamaldehyde.

33: The method according to claim 23, wherein one of said compounds is carvacrol.

34: The method according to claim 23, wherein one of said compounds is tannic acid.

35: The method according to claim 23, wherein one of said compounds is nisin.

36: The method according to claim 23, wherein said formulation further comprises a carrier.

37: The method according to claim 23, wherein said formulation further comprises one or more additives selected from the group of: chelating agents, surfactants, herbs, spices, essential oils, thickeners, anti-oxidants, emulsifiers, sequestering agents, colourings, flavourings, vitamins, minerals, and enzymes.

38: The method according to claim 37, wherein said additive is a sequestering agent.

39: The method according to claim 38, wherein said sequestering agent is tetrasodium pyrophosphate.

40: The method according to claim 39, wherein the amount of tetrasodium pyrophosphate in said formulation provides a final concentration of between about 0.003% and 0.1%.

41: The method according to claim 23, wherein said formulation is applied to said food product in liquid form.

42: The method according to 41, wherein said liquid formulation is applied to the food product by injection, vacuum tumbling, spraying, painting or dipping.

43: The method according to claim 23, wherein said formulation is applied to said food product in the form of a marinade, a breading, a seasoning rub, a glaze, or a colourant mixture.

44: The method according to claim 23, wherein said radiation dose is between about 0.005 kGY and 2.75 kGy.

45: The method according to claim 44, wherein said radiation dose is between about 0.05 kGy and 2.0 kGy.

46: The method according to claim 45, wherein said radiation dose is between about 0.1 kGy and 0.7 kGy.

47: A method of food preservation comprising the steps of:
a) contacting a food product with a formulation comprising one or more compounds, wherein said compounds are derived from natural sources and are substantially purified, and
b) exposing said food product to a radiation dose of less than 3 kGy.

48: A method of decreasing the radiation dose required to inhibit the growth of a population of micro-organisms in a food product by at lease one log order comprising contacting said food product with a formulation comprising one or more compounds prior to irradiation with a dose of less than 3 kGy, wherein said compounds are derived from natural sources and are substantially purified.

49: A method of increasing the shelf life of a food product comprising the steps of:
a) contacting the food product with a formulation comprising one or more compounds, wherein said compounds are derived from natural sources and are substantially purified, and
b) exposing said food product to a radiation dose of less than 3 kGy.

50: A method of preventing spoilage of a food product comprising the steps of:
a) contacting the food product with a formulation comprising one or more compounds, wherein said compounds are derived from natural sources and are substantially purified, and
b) exposing said food product to a radiation dose of less than 3 kGy.

51: A method of decreasing the off-flavour development associated with irradiation of a food product comprising the steps of:
a) contacting the food product with a formulation comprising one or more compounds, wherein said compounds are derived from natural sources and are substantially purified, and
b) exposing said food product to a radiation dose of less than 3 kGy.

52: The method according to any one of claims 47-51, wherein exposing said food product to said radiation takes place under modified atmosphere packaging (MAP) conditions.

53: The method according to claim 47, wherein said one or more compounds present in the formulation provide a final concentration of between about 0.001% and 10.0% of each compound to the food product.

54: The method according to claim 53, wherein said concentration is between about 0.005% and 5.0%.

55: The method according to claim 54, wherein said concentration is between about 0.01% and 2.5%.

56: The method according to claim 47, wherein one or more of said compounds are GRAS food additives.

57: The method according to claim 47, wherein one or more of said compounds are anti-oxidants.

58: The method according to claim 48, wherein one or more of said compounds are anti-microbial agents.

59: The method according to claim 47, wherein one of said compounds is thymol.

60: The method according to claim 47, wherein one of said compounds is trans-cinnamaldehyde.

61: The method according to claim 47, wherein one of said compounds is carvacrol.

62: The method according to claim 47, wherein one of said compounds is tannic acid.

63: The method according to claim 47, wherein one of said compounds is nisin.

64: The method according to claim 47, wherein said formulation further comprises a carrier.

65: The method according to claim 47, wherein said formulation further comprises one or more additives selected from the group of: chelating agents, surfactants, herbs, spices, essential oils, thickeners, anti-oxidants, emulsifiers, sequestering agents, colourings, flavourings, vitamins, minerals, and enzymes.

66: The method according to claim 65, wherein said additive is a sequestering agent.

67: The method according to claim 66, wherein said sequestering agent is tetrasodium pyrophosphate.

68: The method according to claim 67, wherein the amount of tetrasodium pyrophosphate in said formulation provides a final concentration of between about 0.003% and 0.1%.

69: The method according to claim 47, wherein said formulation is applied to said food product in liquid form.

70: The method according to claim 69, wherein said liquid formulation is applied to the food product by injection, vacuum tumbling, spraying, painting or dipping.

71: The method according to claim 47, wherein said formulation is applied to said food product in the form of a marinade, a breading, a seasoning rub, a glaze or a colourant mixture.

72: The method according to claim 47, 49, 50 or 51 wherein said radiation dose is between about 0.005 kGy and 2.75 kGy.

73: The method according to claim 72, wherein said radiation dose is between about 0.05 kGy and 2.0 kGy.

74: The method according to claim 73, wherein said radiation dose is between about 0.1 kGy and 0.7 kGy.

75: The method according to claim 48, wherein the growth of the population of micro-organisms in said food product is inhibited by at least two log orders.

76: The method according to claim 75, wherein the growth of the population of micro-organisms in said food product is inhibited by at least 3 log orders.

77: The method according to claim 76, wherein the growth of the population of micro-organisms in said food product is inhibited by at least 4 log orders.

78: An assay to identify a compound for inclusion in the formulation according to claim 1, comprising:
a) providing a food product to be treated;
b) inoculating said food product with a defined number of micro-organisms;
c) contacting said food product with one or more candidate compounds, wherein said candidate compounds are substantially purified and are derived form natural sources;
d) exposing said food product to a radiation dose of less than 3 kGy to provide a treated food product;
e) evaluating the number of organisms in said treated food product, wherein a lower number of micro-organisms in step e) than in step b) indicates that the compound is suitable for inclusion in the formulation.
